(19) United States
(12) Patent Application Publication
(10) Pub. No.: US 2015/0381756 A1
(43) Pub. Date: Dec. 31, 2015

(54) Centralized Content Enablement Service for Managed Caching in wireless network

(71) Applicant: INTERDIGITAL PATENT HOLDINGS, INC., Wilmington, DE (US)

(72) Inventors: Osama Lotfallah, San Diego, CA (US); Debashish Purkayastha, Collegville, PA (US); Alexander Reznik, Pennington, NJ (US); Sunil Suranna, KARNATAKA (IN); Chandrakanth Gowda, Bangalore (IN); John Cartmell, North Massapequa, NY (US)

(73) Assignee: InterDigital Patent Holdings, Inc., Wilmington, DE (US)

(21) Appl. No.: 14/765,096

(22) PCT Filed: Feb. 25, 2014
(86) PCT No.: PCT/US14/18247

§ 371 Date: Jul. 31, 2015

Related U.S. Application Data
(60) Provisional application No. 61/768,746, filed on Feb. 25, 2013.
(60) Provisional application No. 61/778,098, filed on Mar. 12, 2013.
(60) Provisional application No. 61/877,234, filed on Sep. 12, 2013.

(51) Int. Cl. H04L 29/08; H04L 12/26; H04L 29/06

(52) U.S. Cl. CPC H04L 67/2842; H04L 67/42; H04L 43/06; H04L 67/141

(57) ABSTRACT

Systems, methods, and instrumentalities are provided to implement content caching. An entity running an external application (EA) may establish a connection between the EA and a centralized cloud controller (CCC) to access a service on the CCC. The EA may receive credentials for access to the service. The connection between the EA and the CCC may be established over a first interface. The EA may send to the service on the CES a query for an available small cell network (SCN) storage. The EA may receive from the service on the CES reply comprising a link to an allocated SCN storage. The EA may ingest one or more contents using the link in the allocated SCN storage. A wireless transmit/receive unit (WTRU) may receive the cached content from an edge server in a small cell network.

### CROSS REFERENCE TO RELATED APPLICATIONS

This application claims the benefit of U.S. Provisional Patent Application Nos. 61/768,746 filed on Feb. 25, 2013, 61/778,098 filed on Mar. 12, 2013, and 61/887,234 filed on Sep. 12, 2013, the contents of which are hereby incorporated by reference herein.

### BACKGROUND

Over last two decades the emergence of mobile computing devices, availability of high speed mobile data networks, and availability of web contents, e.g., high speed multimedia content has resulted in an explosive growth of traffic over the internet and mobile core networks. Mobile networks are struggling to deliver high-quality consumer experience. In a mobile network, content (e.g., video content) may be provided to a wireless transmit/receive unit (WTRU) from a remote content source. The remote source may be accessed through a core network and/or the public internet.

Multiple wireless transmit/receive units (WTRUs) within a network may request the same, or similar, video content from the remote content source. Having each of the WTRUs separately request the same, or similar, video content from the remote content source and providing the same, or similar, video content in response to each request may be inefficient and may cause undue burden on mobile networks including, for example, backhaul and mobile core under tremendous pressure. For example, this may unnecessarily route the traffic into the core network and may cause latency in the network and/or increased traffic on backhaul links. Current mechanisms used to reduce demand on mobile networks (e.g., core of the mobile network) may be inadequate.

### SUMMARY

Systems, methods, and instrumentalities are provided to implement ingestion of content, and accessing such ingested content. The content may be provided by an application provider. An entity running an external application (EA) (e.g., a CDN application) may establish a connection between the EA and a centralized content controller (CCC) (e.g., a content enablement service (CES)) to access the CCC. The CCC may be part of a core mobile network or may be an entity in the public internet. The EA may establish connection using login information (e.g., username/password, a digital certificate, etc.) The connection between the EA and the CCC may be established using a secured connection. The EA may provide credentials to the CCC to gain access to the CCC. The connection between the EA and the CCC may be established over an interface (e.g., La interface). The CCC may include a centralized database. The centralized database may include information about one or more SCNs and information about the storages in the SCNs.

The EA may send, over the established connection, a query for an available small cell network (SCN) storage to the CCC. The CCC may reserve the storage in the requested SCN. The EA may receive, over the established connection, a reply comprising an indication whether the storage in the requested SCN is available and/or a link to the reserved and allocated SCN storage. The link to the allocated SCN storage may include, for example, an ingestion uniform resource indicator (URI). The EA may ingest one or more contents into the allocated SCN storage using the link to the SCN storage. The contents may be ingested via a second interface (e.g., Lc interface).

The EA may perform one or more operations on the allocated SCN storage. For example, the EA may perform one or more of an add operation, a delete operation, or an update operation on the allocated SCN storage. The EA may request a logging service from the CCC. The EA may access (e.g., access on demand) the logging service using a link provided by the CCC.

The EA may request a reporting service from the CCC. The reporting service may include one or more reports associated with one or more small cell networks. The EA may receive one or more reports from the CCC. The reports from the CCC may be received by the EA on a periodic basis or on-demand. The EA, based on the received one or more reports, may ingest and/or update one or more contents in the SCN storage.

A wireless transmit/receive unit (WTRU) may access a content. A WTRU in a small cell network (SCN) may send a request to access the content. A gateway (e.g., a content enablement gateway (CE-GW)) may intercept that request to access the content. The CE-GW may check whether the content requested by the WTRU is available locally in the SCN. If the content is available locally in the SCN, the CE-GW may provide the WTRU with the identification (e.g., an IP address) of an edge server (e.g., a virtual edge server) where the ingested content may be available. The edge server may be located in the SCN. The WTRU may retrieve the ingested content using the identification of the edge server. The WTRU may send, using the received identification, a request message to the identified SCN edge server to access the ingested content. In response from the edge server, the WTRU may receive the requested ingested content.

### BRIEF DESCRIPTION OF THE DRAWINGS

A more detailed understanding may be had from the following description, given by way of example in conjunction with the accompanying drawings.

FIG. 1A is a system diagram of an example communications system in which one or more disclosed embodiments may be implemented.

FIG. 1B is a system diagram of an example wireless transmit/receive unit (WTRU) that may be used within the communications system illustrated in FIG. 1A.

FIG. 1C is a system diagram of an example radio access network and an example core network that may be used within the communications system illustrated in FIG. 1A.

FIG. 1D is a system diagram of an example radio access network and an example core network that may be used within the communications system illustrated in FIG. 1A.

FIG. 1E is a system diagram of an example radio access network and an example core network that may be used within the communications system illustrated in FIG. 1A.

FIG. 2 illustrates an example of an interworking wireless local area network (IWALN) interworking architecture.

FIG. 3 illustrates an example of a selected IP traffic offload (SIPTO) architecture.

FIG. 4 illustrates an example of a local IP access (LIPA) architecture.

FIG. 5 illustrates an example of an IP flow mobility (IFOM) architecture.

FIG. 6 illustrates an example or a mobile content data network (CDN) architecture.

FIG. 7 illustrates an example of a managed caching architecture.

FIG. 8 illustrates an example of functional components of content enablement service (CES).

FIG. 9 illustrates an example of functional components of content enablement gateway (CE-GW).

FIG. 10 illustrates an example of storage farm with streaming and/or logging services.

FIG. 11 illustrates an example interaction between various interfaces.

FIG. 12 illustrates an example of interaction between CES and core mobile network.

FIG. 13 illustrates an example sequence diagram of ingestion of CDN content and an WTRU accessing the CDN data.

FIG. 14 illustrates an example of a small cell services architecture.

FIG. 15 illustrates an exemplary network architecture diagram, e.g., including an auto-configuration server (ACS), managed devices, etc.

FIG. 16 illustrates an exemplary transaction session between an exemplary customer premises equipment (CPE) and an exemplary ACS.

FIG. 17 illustrates a table showing example components in small cell service. architecture.

FIG. 19 illustrates a system of functional components that may be employed in connection with a CES.

FIG. 20 illustrates an example of a request to an example data store query application programming interface (API).

FIG. 21 illustrates an example response from the example data store query API.

FIG. 22 illustrates an example request to an example FemtoZone data store status query API.

FIG. 23 illustrates an example response from the example FemtoZone data store status query API.

FIG. 24 illustrates an example request to an example create virtual edge server service API.

FIG. 25 illustrates an example response from the example create virtual edge server service API.

FIG. 26 illustrates an example request to an example delete virtual edge server service API.

FIG. 27 illustrates an example response from the example delete virtual edge server service API.

FIG. 28 illustrates an example request to an example update virtual edge server service API.

FIG. 29 illustrates an example response from the example update virtual edge server service API.

FIG. 30 illustrates an example request to an example edge server status query service API.

FIG. 31 illustrates an example response from the example edge server status query service API.

FIG. 32 illustrates an example request to an example data store event service API.

FIG. 33 illustrates an example response from the example data store event service API.

FIG. 34 illustrates an example notification from the example data store event service API.

FIG. 35 illustrates an example request to an example data store event service API.

FIG. 36 illustrates an example response from the example data store event service API.

FIG. 37 illustrates a part of the table, continued to FIG. 37(a), depicting one or more example components of an application platform data model.

FIG. 37(a) illustrates part of the table, continued from FIG. 37, depicting one or more example components of an application platform data model.

FIG. 38 is a diagram illustrating an example message flow for a configuration download.

FIG. 39 is a diagram illustrating an example of a managed caching architecture.

FIG. 40 is a diagram illustrating an example of a functional architecture for the managed edge caching.

FIG. 41 is a diagram illustrating an example of one or more procedures that may be performed and/or messages that may be communicated for managed edge caching.

FIG. 42 is an example of a diagram illustrating protocol stack for a CE-GW WAN management protocol.

FIG. 43 is an example of a diagram illustrating a transaction to query for the small cell network (SCN) storage subsystem capabilities.

FIG. 44 is an example of a diagram illustrating a transaction procedure that may be performed to create a virtual edge server.

FIG. 45 is an example of a diagram illustrating a transaction procedure that may be performed to delete a virtual edge server.

FIG. 46 is an example of a diagram illustrating a transaction procedure that may be performed to update the virtual edge server.

FIG. 47 is an example of a diagram illustrating a transaction procedure that may be performed to query the status of the virtual edge server.

FIG. 48 is an example of a diagram illustrating a transaction procedure that may be performed to subscribe to DataStore events.

FIG. 49 is an example of a diagram illustrating a transaction procedure that may be performed as notification for the subscribed events.

FIG. 50 is an example of a diagram illustrating a transaction procedure that may be performed to unsubscribe to DataStore events.

FIG. 51 is an example of a diagram illustrating a CE-GW functional architecture.

FIG. 52 is an example of a diagram illustrating one or more CE-GW interfaces.

FIG. 53 is an example of a diagram illustrating an edge server farm interface (EIF).

FIG. 54 is an example of a diagram illustrating one or more messages that may be communicated for creation of a virtual edge server.

FIG. 55 is an example of a diagram illustrating one or more messages that may be communicated for modification of a virtual edge server.

FIG. 56 is an example of a diagram illustrating one or more messages that may be communicated for deletion of a virtual edge server.

FIG. 57 is an example of a diagram illustrating one or more messages that may be communicated for retrieval of ESF capability information.

FIG. 58 is an example of a diagram illustrating one or more messages that may be communicated for an event notification procedure.

FIG. 59 is an example of a diagram illustrating a message that may be communicated for device failure notification.

FIG. 60 is an example of a diagram illustrating a message that may be communicated for device entries notification.

FIG. 61 is an example of a diagram illustrating ore messages that may be communicated for performance statistics notification.

FIG. 62 is an example of a diagram illustrating one or more messages that may be communicated for virtual edge server access control.

### DETAILED DESCRIPTION

A detailed description of illustrative embodiments will now be described with reference to the various figures. Although this description provides a detailed example of possible implementations, it should be noted that the details are intended to be exemplary and in no way limit the scope of the application. In addition, the figures may illustrate flow charts and/or message sequence diagrams, which are meant to be exemplary. Other embodiments may be used. The order of the messages may be varied where appropriate. Messages may be omitted if not needed, and, additional flows may be added.

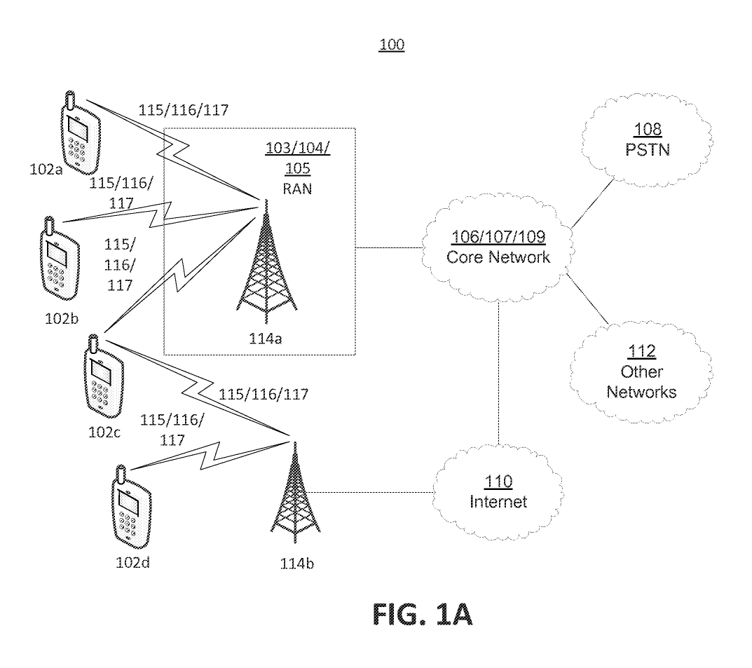

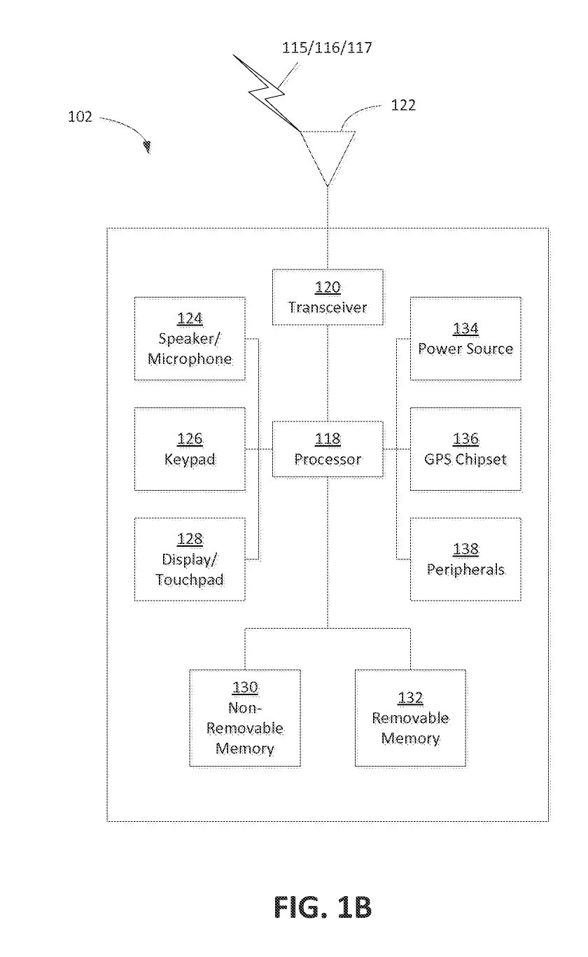

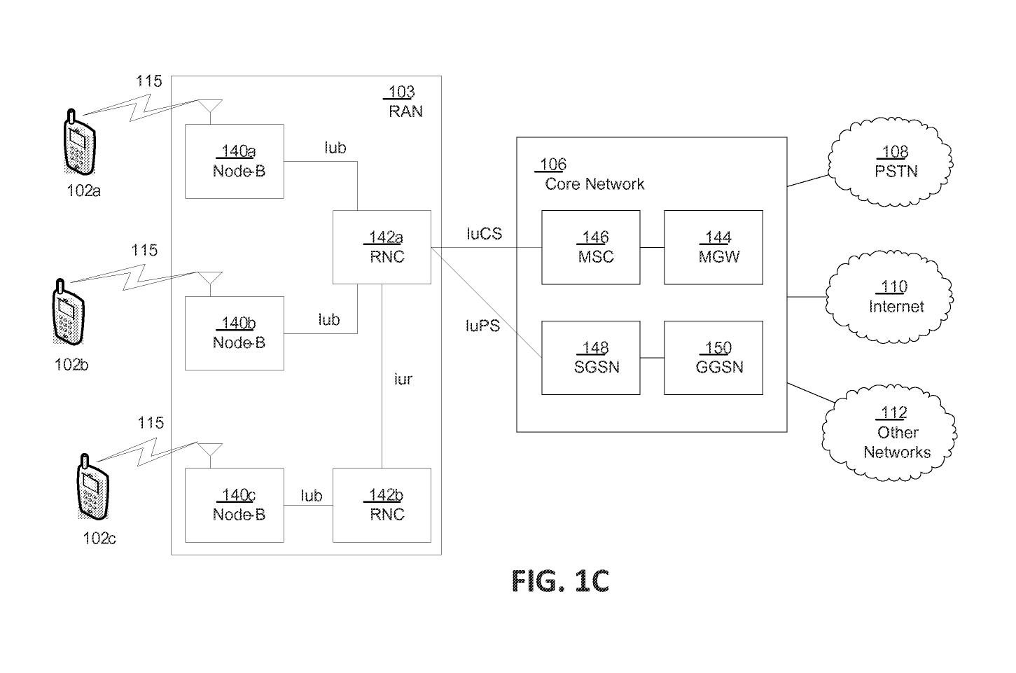

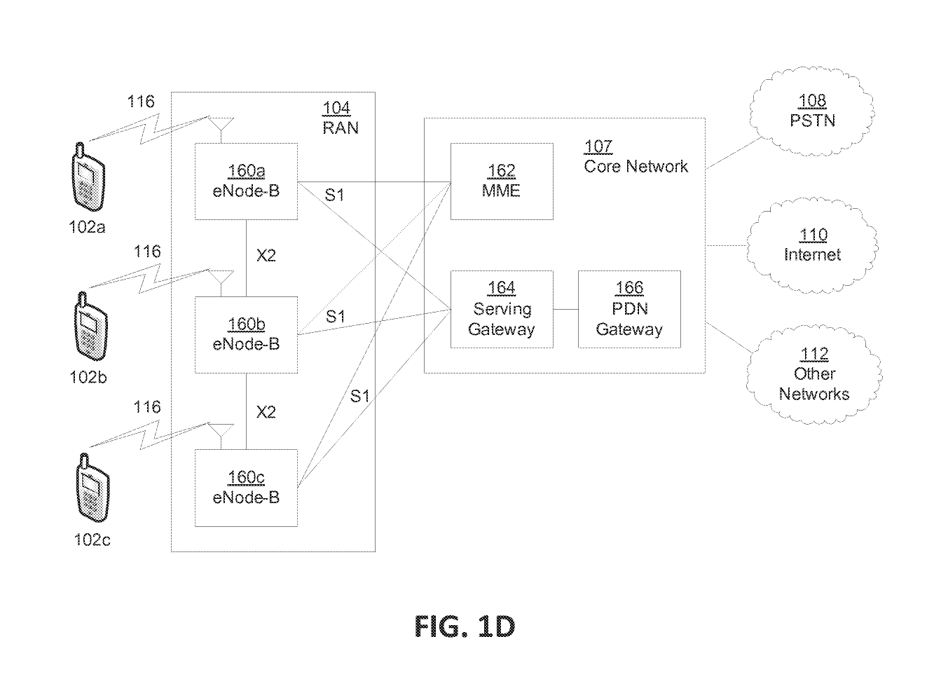

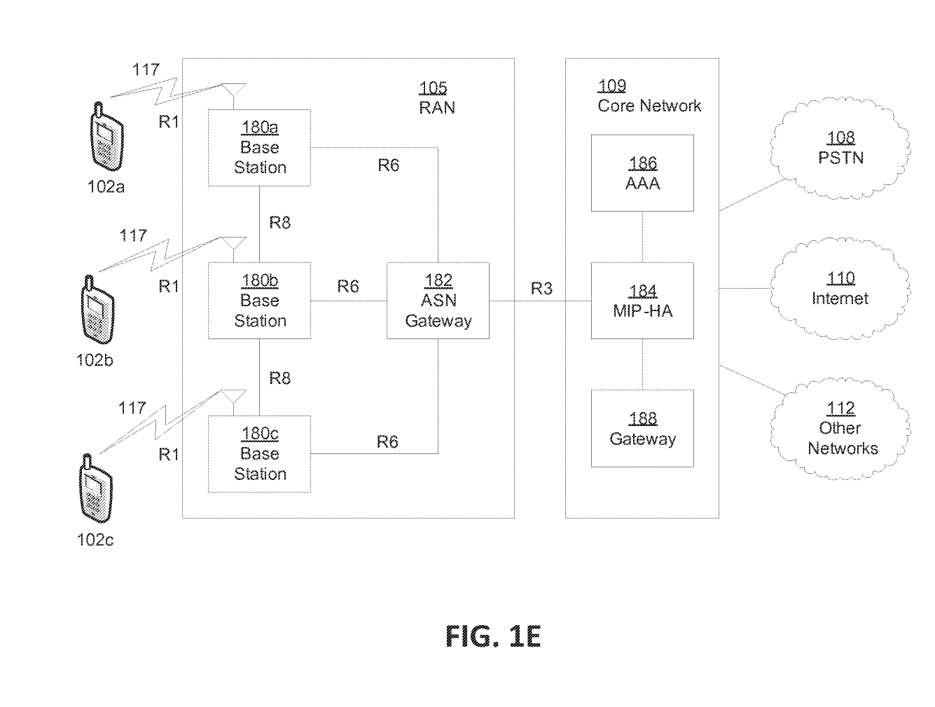

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA. (OFDMA), single-carrier FDMA (SC-FDMA), and the like.

As shown in FIG. 1A, the communications system 100 may include wireless transmit/receive units (WTRUs) 102a, 102b, 102c, and/or 102d (which generally or collectively may be referred to as WTRU 102), a radio access network (RAN) 103/104/105, a core network 106/107/109, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include wireless transmit/receive unit (WTRU), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106/107/109, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 115/116/117, which may be any suitable wireless communication link (e.g., radio frequency (RF), microwave, infrared (IR), ultraviolet (UV), visible light, etc.). The air interface 115/116/117 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 115/116/117 using Long Term Evolution (LTE) and/or LTE-Advanced (LTE-A).

In an embodiment, the base station 114a and the WTRUs 102a, 102b, 102c may implement radio technologies such as IEEE 802.16 (i.e., Worldwide Interoperability for Microwave Access (WiMAX)), CDMA2000, CDMA2000 1x, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet an embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106/107/109.

The RAN 103/104/105 may be in communication with the core network 106/107/109, which may be any type of network configured to provide voice, data, applications, and/or voice aver internet protocol (VoIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication. Although not shown in FIG. 1A, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with a RAN (not shown) employing a GSM radio technology.

The core network 106/107/109 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include a core network connected to one or more RANs, which may employ the same RAT as the RAN 103/104/105 of a different RAT.

Some of all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 1B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet an emboditnent, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, WTRU 102 may employ MIMO technology. Thus, in one embodiment, the WTRU 102 may include two or more transmit/receive elements 122 (e.g., multiple antennas) for transmitting and receiving wireless signals aver the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In an embodiment, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 103 and the core network 106 according to an embodiment. As noted above, the RAN 103 may employ a UTRA radio technology to communicate with the WTRUs 102a, 102b, 102c over the air interface 115. The RAN 103 may also be in communication with the core network 106. As shown in FIG. 1C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macro diversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 1D is a system diagram of the RAN 104 and the core network 107 according to an embodiment. As noted above, the RAN 104 may employ an E-UTRA radio technology to communicate with the WTRUs 102a, 102b, 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink and/or downlink, and the like. As shown in FIG. 1D, the eNode-Bs 160a, 160b, 160c may communicate with one another over an X2 interface.

The core network 107 shown in FIG. 1D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 1E is a system diagram of the RAN 105 and the core network 109 according to an embodiment. The RAN 105 may be an access service network (ASN) that employs IEEE 802.16 radio technology to communicate with the WTRUs 102a, 102b, 102c over the air interface 117. As will be further discussed below, the communication links between the different functional entities of the WTRUs 102a, 102b, 102c, the RAN 105, and the core network 109 may be defined as reference points.

As shown in FIG. 1E, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c may each be associated with a particular cell (not shown) in the RAN 105 and may each include one or more transceivers for communicating with the WTRUs 102a, 102b, 102c over the air interface 117. In one embodiment, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, 180c may be defined as an R8 reference point that includes protocols for facilitating WTRU handovers and the transfer of data between base stations. The communication link between the base stations 180a, 180b, 180c and the ASN gateway 182 may be defined as an R6 . The R6 reference point may include protocols for facilitating mobility management based on mobility events associated with each of the WTRUs 102a, 102b, 102c.

As shown in FIG. 1E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 1E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

Offloading techniques for mobile networks may divert a portion of data traffic in macro cellular networks over alternate networks, for example, Wi-Fi, WiMax, etc. The techniques used may relieve radio access links, the backhaul and/or the core network. Mobile network operators may place mobile CDN services, e.g., on edge servers in mobile networks. The edge servers may be placed after the serving gateways.

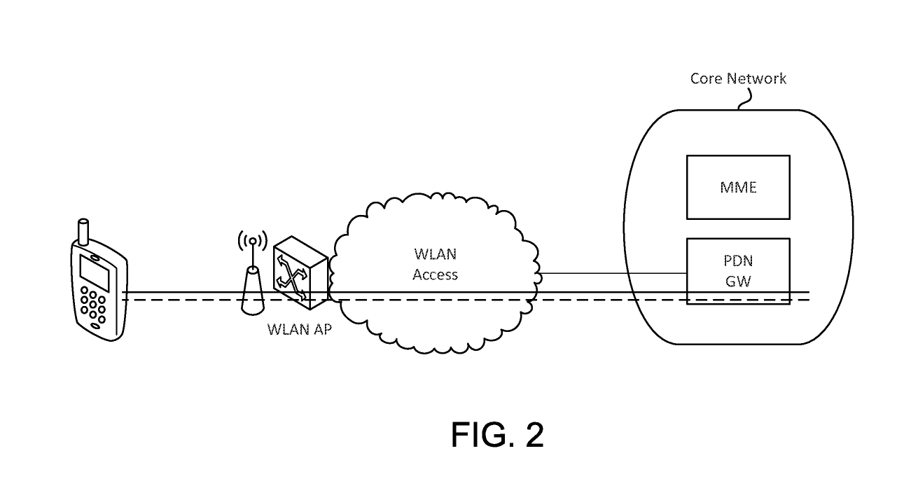

Interworking wireless local area network (IWLAN) may include a “radio interface offloading” for interworking between third generation partnership (3GPP) networks and wireless local area networks (WLANs). IWLANs may allow scalability and flexibility, e.g., by deploying secured, automatic and value added Wi-Fi access in trusted and untrusted hotspots. FIG. 2 illustrates an example of an interworking wireless local area network (IWALN) interworking architecture. As illustrated by example in FIG. 2, IWLAN may tunnel Wi-Fi traffic back to the 3GPP packet core network. In such a network, authentication may be performed transparently without user intervention. For example, the system may use the subscriber identity module (SIM) credentials of the subscriber's mobile device to perform Wi-Fi authentication. The Wi-Fi authentication may use, e.g., the extensible authentication (EAP)-SIM protocol to authenticate the subscriber.

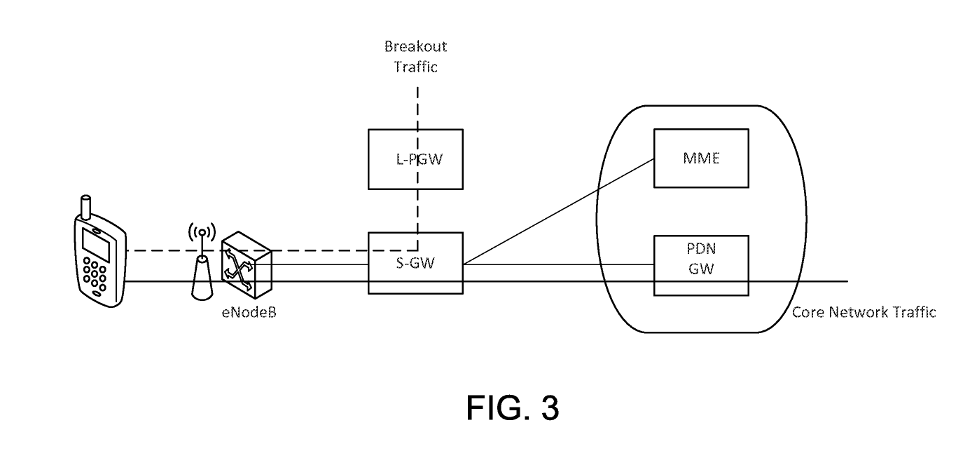

FIG. 3 illustrates an exemplary selected IP traffic offload (SIPTO) architecture. In a SIPTO-enabled mobile architecture, one or more types of traffic may be forwarded, e.g., via alternative routes to/from a user equipment (UE). The UE may be a wireless transmit/receive unit (WTRU). As illustrated in FIG. 3, SIPTO may be used to, e.g., to direct internet traffic away from the mobile core network. The SIPTO function may enable an operator to offload one or more types of traffic at a network node, e.g., close to the point of attachment to the access network. Offloading in a SIPTO-enabled network may be achieved, e.g., by selecting a set of gateways (e.g., S-GW and P-GW) that may be geographically and/or topologically close to a UE's point of attachment. Policy driven 5-tuple (e.g., source IP address, source port, destination IP address, destination port, protocol) may be used to route the traffic away from the core of the network.

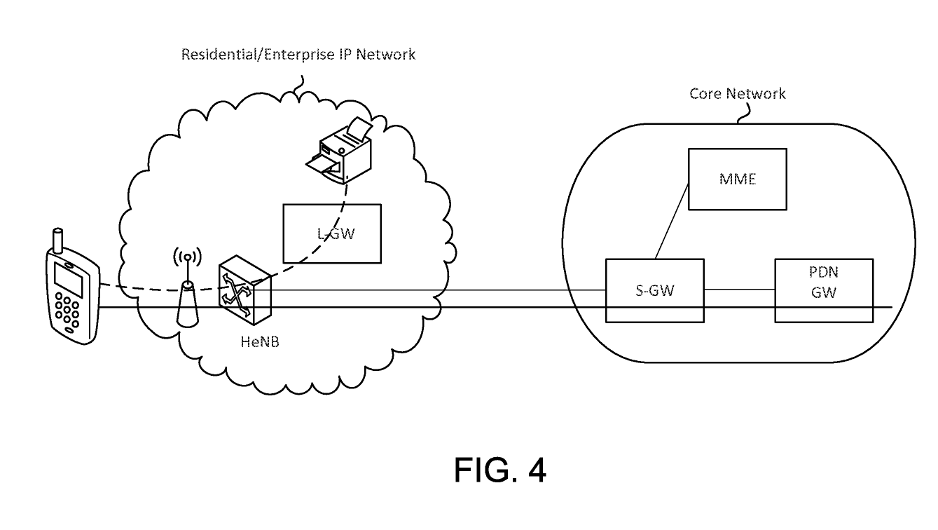

FIG. 4 illustrates an exemplary local IP access (LIPA) architecture. LIPA function may enable an IP capable UE connected, e.g., via a home eNodeB (HeNB), to access other IP capable entities in the same residential and/or enterprise IP network. As illustrated in FIG. 4, the UE may access the IP capable entities without traversing the user plane of the mobile operator's network. The local IP access may be provided using, e.g., a local GW (L-GW) that may be collocated with the HeNB. LIPA may be established by the UE requesting a packet data network (PDN) connection to an access point name (APN) for which URA may be permitted. As illustrated in FIG. 4, the network may select the L-GW associated with the HeNB and may enable a direct user plane path between the L-G W and the HeNB. Policy-driven 5-tuple based routing may be used to route traffic locally.

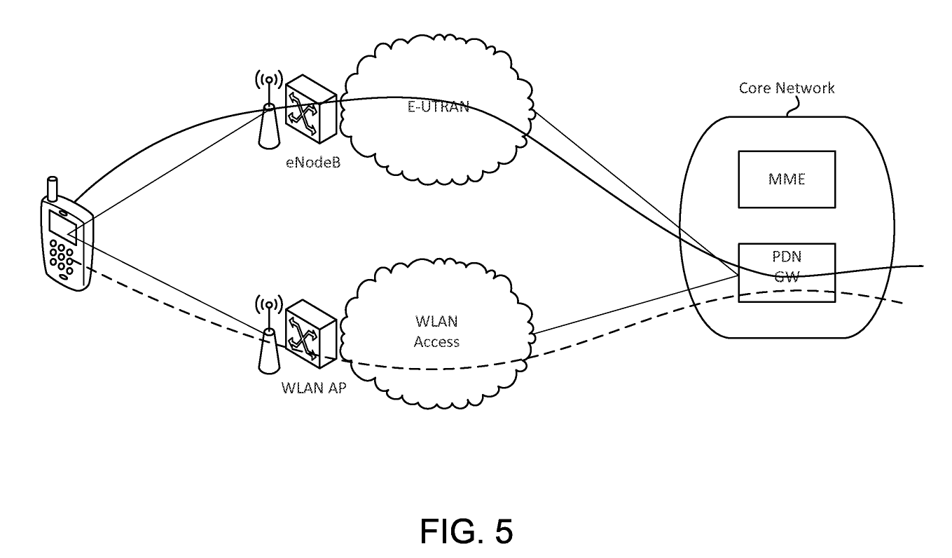

FIG. 5 illustrates an exemplary IP flow mobility (IFOM) architecture. IFOM may be used by the user devices with more than one radio interfaces at the same time. One or more flows from the user equipment to the network may traverse macro radio access network, while the other flows may traverse other access network, e.g., a WLAN access network.

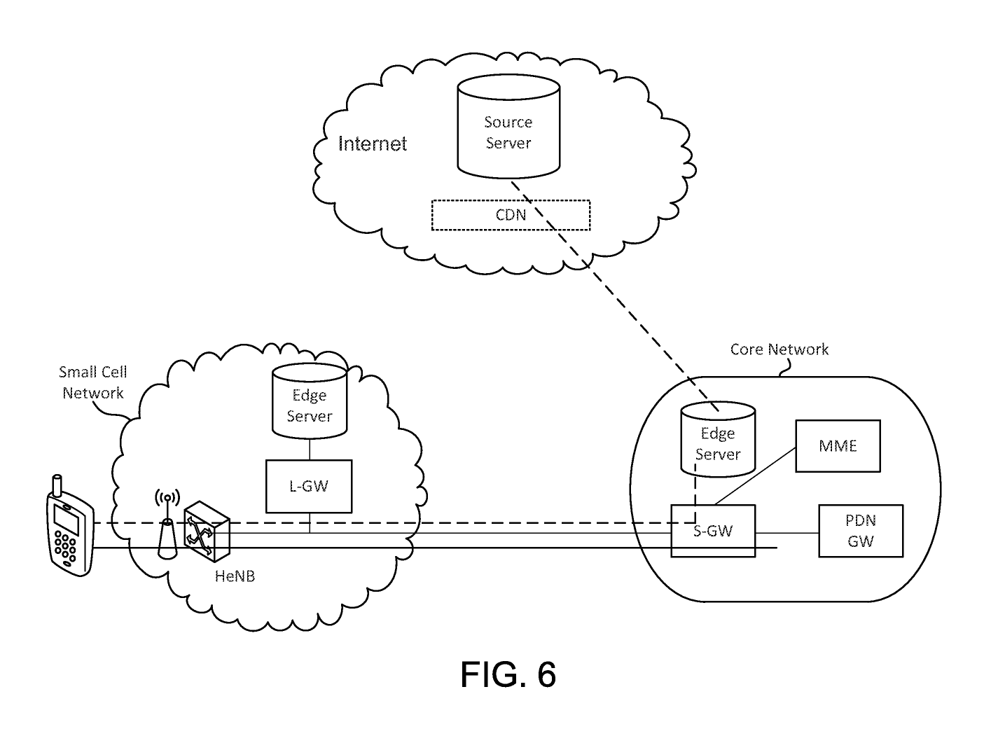

FIG. 6 illustrates an exemplary mobile content data network (CDN) architecture. As illustrated in FIG. 6, in a Mobile CDN network, nodes may be deployed, e.g., at the edge of the network at multiple locations. The multiple nodes may be connected over multiple backbone networks, e.g., directly connected and/or peered with Mobile Network Operators (MNOs). The nodes may cooperate with each other, e.g., to satisfy requests for content by end users and/or the transparently moving content optimize the delivery process. The mobile CDN network may provide reduced bandwidth usage, improved end-user performance, and/or increased global availability of content over a mobile network.

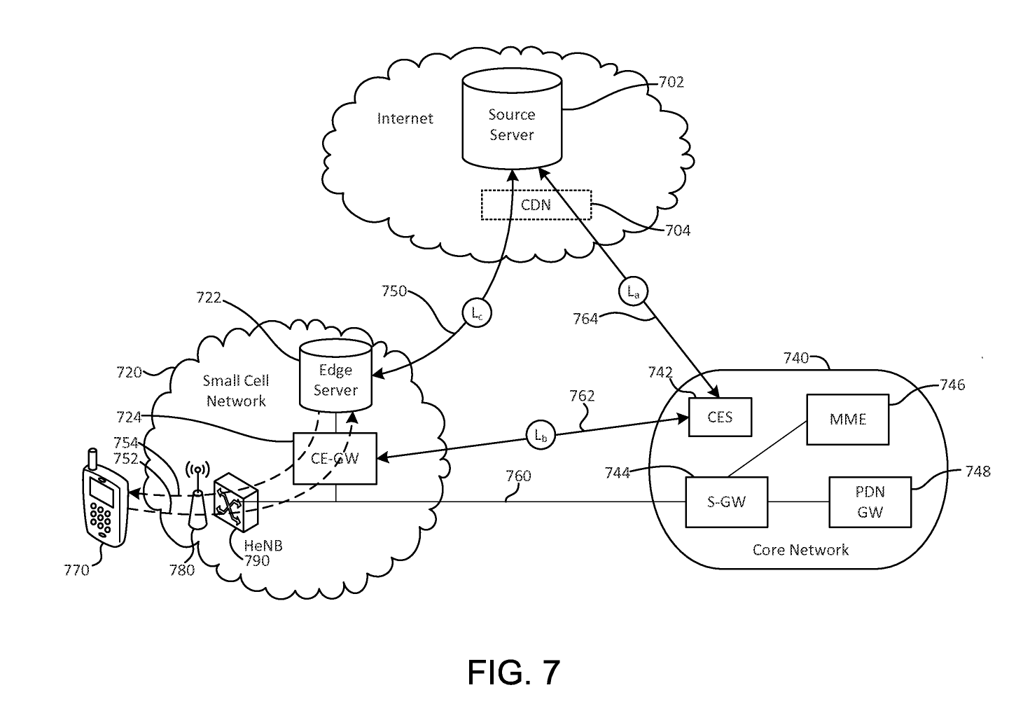

Demand for rich multimedia applications may keep core or mobile networks busy for long periods. The mobile networks may struggle to satisfy the end users with the high quality content. A number of offloading techniques, such as caching the multimedia content locally in small cell networks as described in FIG. 7, may reduce such demand on the core of the mobile networks.

Popular multimedia contents may use a content delivery network (CDN) to distribute the content, e.g., at several points of presence and create a number of CDN edge severs. The CDN control application may apply a distribution algorithm to one or more edge servers to store a copy of certain contents to improve the quality of experience (QoE) to end users. Mobile network operators may reduce the bandwidth demand on the core network components and provide a storage subsystem at different point of presence that may be shared by several CDN providers.

In a managed edge caching, mobile network operators may allow an external application (EA) to manage the local storage, such as content prepositioning, content placement, content replication, content deletion, etc. The EA may be a CDN application. The EA may use the storage subsystem in the small cell network for caching the popular multimedia contents by creating one or more edge servers or virtual edge servers. Services, in the mobile core network, may allow one or more external applications to have a point of contact (e.g., a single point of contact) towards the wireless network.

The EA may improve the content distribution algorithm by receiving wireless network related statistics and/or storage related information from a wireless and/or small cell core network component in a mobile network. The EA may query the wireless network and the storage servers in the mobile network. The queries may be periodic (e.g., once a day).

Services may be used in the mobile core network to allow one or more external applications to have a single point of contact towards the wireless network. Wireless networks may coordinate in the creation of virtual edge servers that may provide an interface to be used by external applications.

Methods, systems and instrumentalities described herein may be applied to a wireless and/or a wired network, for example, a macro cellular network, a small cell network, a Wi-Fi network, a WiMax network etc.

A configurable (e.g., locally configurable) storage subsystem within an access gateway may be used to reduce the data plane demand on the core network components. Small cell gateways may be used. Small cell gateways may provide a networking protocol stack that may be used by the storage subsystem. In a managed convent placement scenario, e.g., the CDNs may use the small cell storage subsystem to manage (e.g., store or remove) their own data. A centralized approach may be employed, for example, to streamline the communication between various small cell storage subsystems and one or more external applications. The content related activities may be provided as a single service, using a unified interface to the external applications by the mobile network operator. The centralized approach may be used to avoid fragmentation of the content related services to a number of isolated and/or hard to manage services (e.g., by an external application).

The mobile core networks may be modified, e.g., to include a centralized content controller (CCC). The CCC may be a content enablement service (CES). The CCC may be deployed as a standalone service or may be a part of OneAPI service. CCC may collect information from a small cell network (SCN) and store it, e.g., in a centralized database. The database may be accessed by EAs and/or content providers to query for the existence of storage subsystem within an SCN. The CES may be used to create virtual edge servers for their contents, e.g., within a zone in an SCN. Small cell access gateways may be modified, e.g., to include advanced features related to CES functionality. The modified node may be a content enablement gateway (CE-GW). CE-GW may be a single point of interaction to external entities of the small cell zone, for example, the CES and CDN applications. Interfaces may be used by different nodes and/or applications (e.g., CES, CE-GW, CDN, etc.) enabling them to interact with each other.

CDNs may pre-position their content objects, for example, based on the frequency of requesting such content (or anticipation of such frequency) within the proximity of their edge servers. Virtual edge servers may be provided for the CDNs to use as storage for the frequently requested material within a SCN.

A small cell network, for example, may be deployed in a shopping mall. A locally configurable storage may be used by one or more CDNs. The storage may provide advertisement materials relevant to the businesses at the shopping mall. For example, one or more businesses may use a specialized advertisement campaign that may be delivered by the CDN. The advertisements may target the shopping mall shoppers with promotional material. Offloading the content to local storage may reduce the bandwidth demand in the core of the core network.

In an example, a small cell network may be deployed within an airport facility, where a peak demand for internet may occur during certain peak hours. For example, business travelers may be interested in accessing multimedia contents from famous news websites. CDN may re-encode the original material into different screen sizes with various qualities. If such a setup is used without employing the offloading mechanism, the high quality material may cause a big bandwidth demand in the core of the mobile network, even when requested by a few devices within the small cell network. Content delivery network by pre-positioning the high quality material into the small cell network storage to avoid the possibility of the bandwidth demand in the core of the mobile network.

FIG. 7 illustrates an exemplary managed caching architecture. As illustrated in FIG. 7, a CCC (e.g., CES 742) may be an operator owned service that may be used by external entity (e.g., a content delivery network) to request and/or allow storage of one or more contents in a small cell storage subsystem. For example, the external entity may include content providers that may want to provide content to users in a particular geographic area. CES 742 may enable one or more EAs to manage (e.g., create, delete, etc.) a virtual edge server within one or more small cell networks. As illustrated by example in FIG. 7, one or more interfaces may be used to facilitate communication between CES 742, EA 704 and/or the small cell storage subsystems (e.g., SCN 720). The EA may be running on a server (e.g., a source server 702). The EA 704 may include one or more applications running on the source server 702. The EA 704 may be running on a dedicated server. The interfaces may include, for example, Lₐ interface 764, L_{b} interface 762, and Lₑ interface 750. As illustrated in FIG. 7, Lₐ interface 764 may be provided between EA 704 and CES 742. L_{b} interface 762 may be provided between CES 742, and SCN 720 (e.g., CE-GW 724 of SCN 720 over 760). L_{c} interface 750 may be provided between EA 704 and SCN 720 (e.g., Edge Server 722 of SCN 720).

With the content available within the small cell storage or the edge server 722, a WTRU 770 requesting for such content may be directed by the operator's DNS to the local storage within the small cell network 720. As illustrated in FIG. 7 by dotted lines 752 and 754, the WTRU's content request may be served, e.g., by connecting the WTRU 770 to the virtual edge server 722 via a radio interface 780 and HeNB 790, and using an appropriate transmission protocol.

As illustrated in the example caching architecture in FIG. 7, a centralized content controller (e.g., CES 742) may be an operator owned service. For example, the CCC may be offered using OpenAPI framework. CES 742 may interact, for example, with several small cell networks (e.g., SCN 720). The SCNs may include a storage subsystem. Storage within a small cell network may be shared by one or more external applications to deliver contents to the users of the small cell networks. CES may refuse a request for a storage service within a small cell network, e.g., if the storage service exceeds the available free amount of storage.

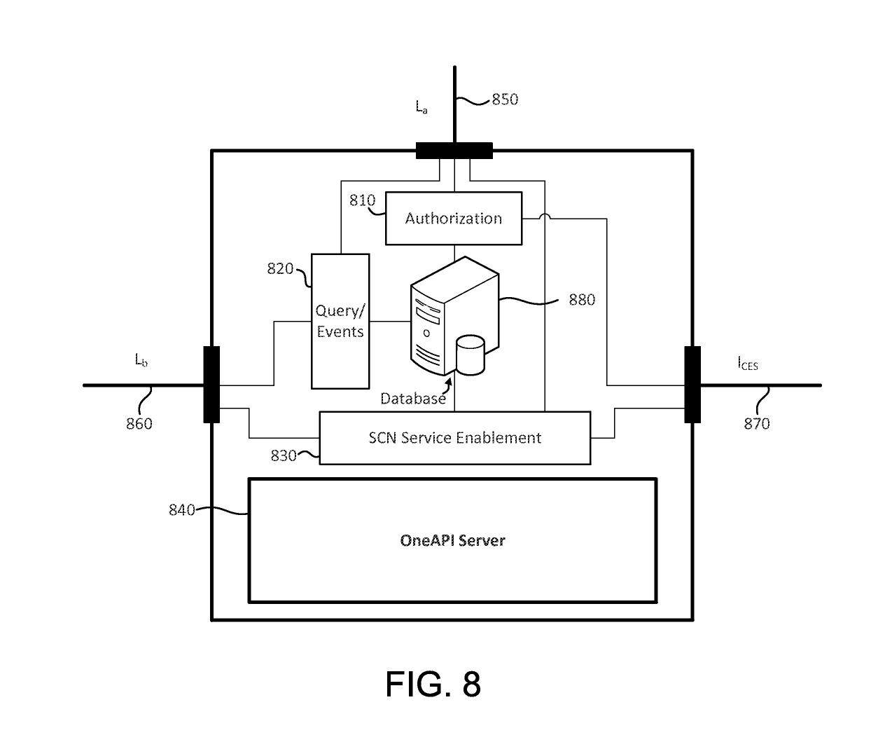

FIG. 8 illustrates an example of one or more functional components of CES enable the CES service, for example, in the core network (not shown in FIG. 8). One or more mobile network operators may deploy CES, for example, as a standalone service or alongside the OneAPI service (on the OneAPI server 840). The CES may include a database 880, an authorization function 810, a query/event handling function 820, an SCN service enablement 830, etc. The database 880 may store information regarding small cell networks and/or associated storage subsystems. The authorization function 810 may be used to establish a connection, e.g., between an external application (e.g., a CDN application) and a centralized content controller (e.g., CES). The centralized content controller may include a central database 880. This connection may be established, e.g., over the Lₐ interface 850. The CES authorization function 810 may access the core mobile network authorization function (not shown in FIG. 8), e.g., using the I_{ces} interface 870. A suitable database schema and a set of predefined procedures may be used to interface with the core CES database. The database queries and events may be used, e.g., by Lₐ, interface 850 or L_{b} interface 860. CDN application may request services from the SCNs, e.g., ingestion uniform resource identifier (URI), enabling logging services, and/or multimedia multicast services. The CDN requests may be communicated, e.g., via Lₐ interface 850. CES may process the CDN requests and forward them to the respective SCN using, e.g., L_{b} interface 860.

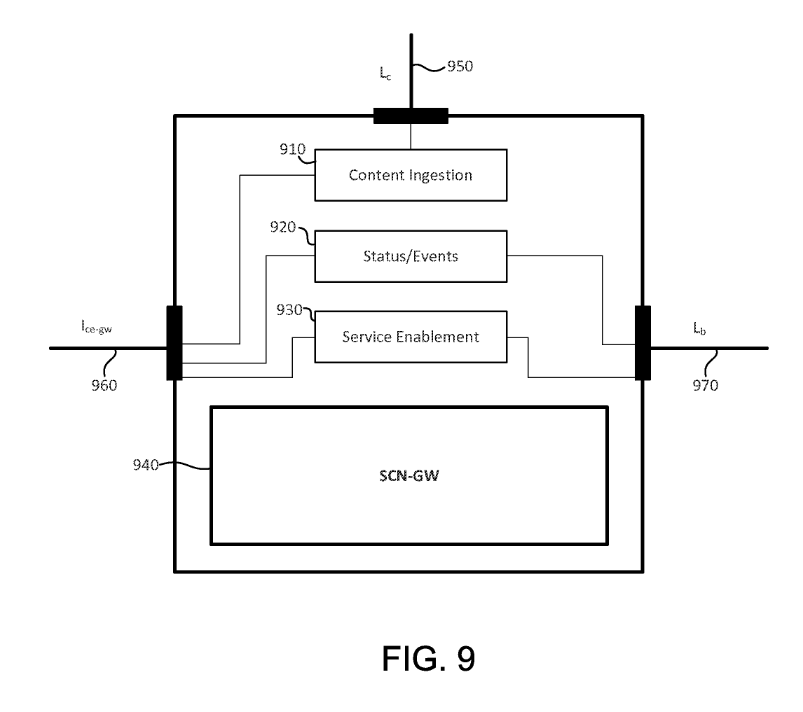

FIG. 9 illustrates a functional decomposition example of the CE-GW, where the small cell network gateway (SCN-GW) may include, for example, content ingestion function 910, status/event function 920, service enablement function 930, etc. As illustrated in FIG. 9, one or more CDN applications may use the L_{c} interface 950, for example, to ingest (e.g., store, copy, etc.) contents (e.g., multimedia content) into the SCN storage. Ingestion may allow content owners, running the EAs, to store their contents in one or more storages located at one or more SCNs. For example, ingestion may enable a CDN application to open a path to an SCN storage, and/or copy its content into the SCN storage. The L_{c} interface 950 may be used to modify ingested contents within the SCN storage. The requests may be processed at SCN-GW 940. The SCN-GW may forward the requests to the appropriate SCN storage using, e.g., the I_{ce-gw} interface 960. The core network (not shown in FIG. 9) may send queries and/or subscribe to certain events that may be used to feed the CES database. Status/event function 920 may be provide receiving and/or responding to the requests through L_{b} interface 970. One or more requests may be forwarded to an internal SCN storage, e.g., using I_{ce-gw} interface 960. The core network may request the enablement of certain services, for example, logging, fault tolerance, and/or multimedia multicast service on behalf of the CDN application. The service enablement function 930 may provide enabling and/or disabling the internal SCN services, for example, using I_{ce-gw} interface 960. The functionality of the SCN-GW 940 may be similar to the local gateway, converged gateway or a suitable access gateway that may be deployed in small cell networks.

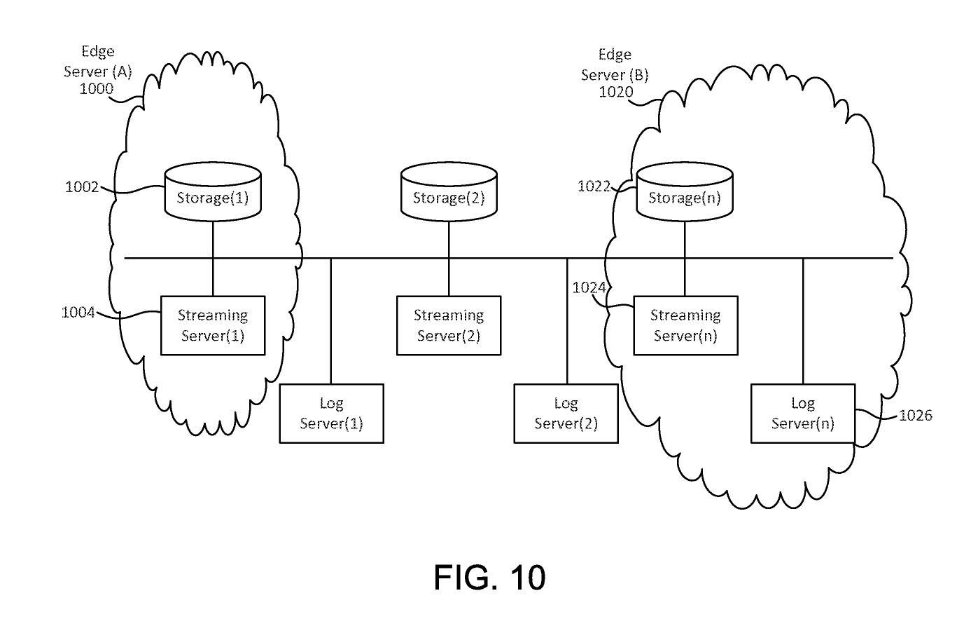

FIG. 10 illustrates an example of storage farm with streaming and/or logging services that may be shared among one or more CDN applications. The services may be allocated and/or de-allocated by the CE-GW (not shown in FIG. 10). The functional decomposition may allow customization of one or more virtual edge servers. For example, edge server (A) 1000 may include a storage 1002 with a streaming service on a streaming server 1004. Edge server (B) 1020 may include a storage 1022 with a streaming service on a streaming server 1024. Edge server (B) 1020 may include a logging service on a log server 1026. The logging service may provide mechanisms to report statistical parameters to the core network and/or the CDN application.

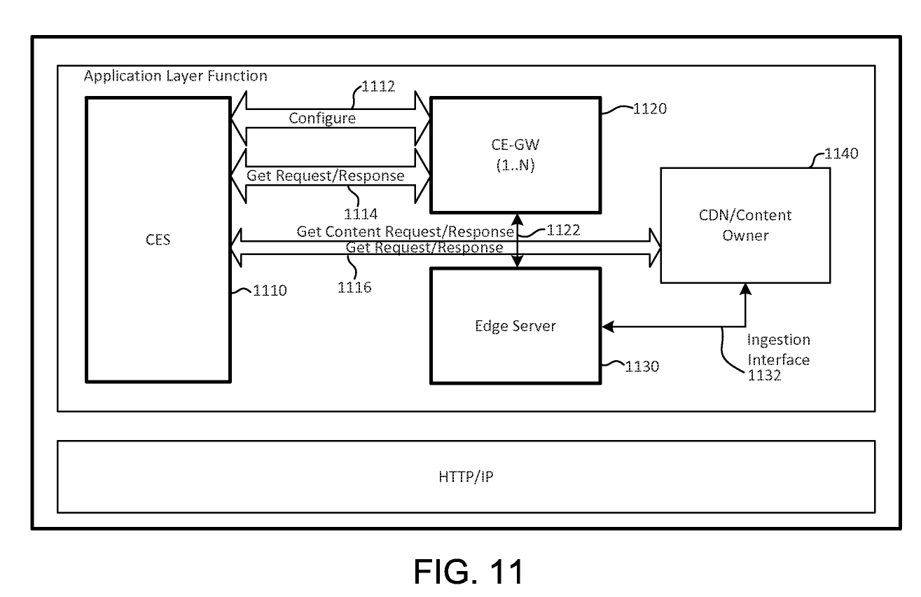

FIG. 11 illustrates an example of one or more of application layer functions of CES and the interaction over the Lₐ, L_{b}, and L_{c} interfaces. Application based protocols, for example, HTTP and/or HTTPS may be used to carry messages related to the one or more interfaces. As illustrated in FIG. 11, CDN/content owner 1140 may have an ingestion interface 1132 with Edge server 1130. The ingestion interface 1132 may be used to ingest (e.g., store, copy, etc.) contents into the Edge server 1130. The CDN/content owner may have a request/response interface 1116 with CES 1110. The CES 1110 may have a configuration interface 1112 and/or a get request/response interface 1114 with one or more CE-GWs 1120. The CE-GWs 1120 may have one or more get content request/response interfaces 1122 with edge server 1130.

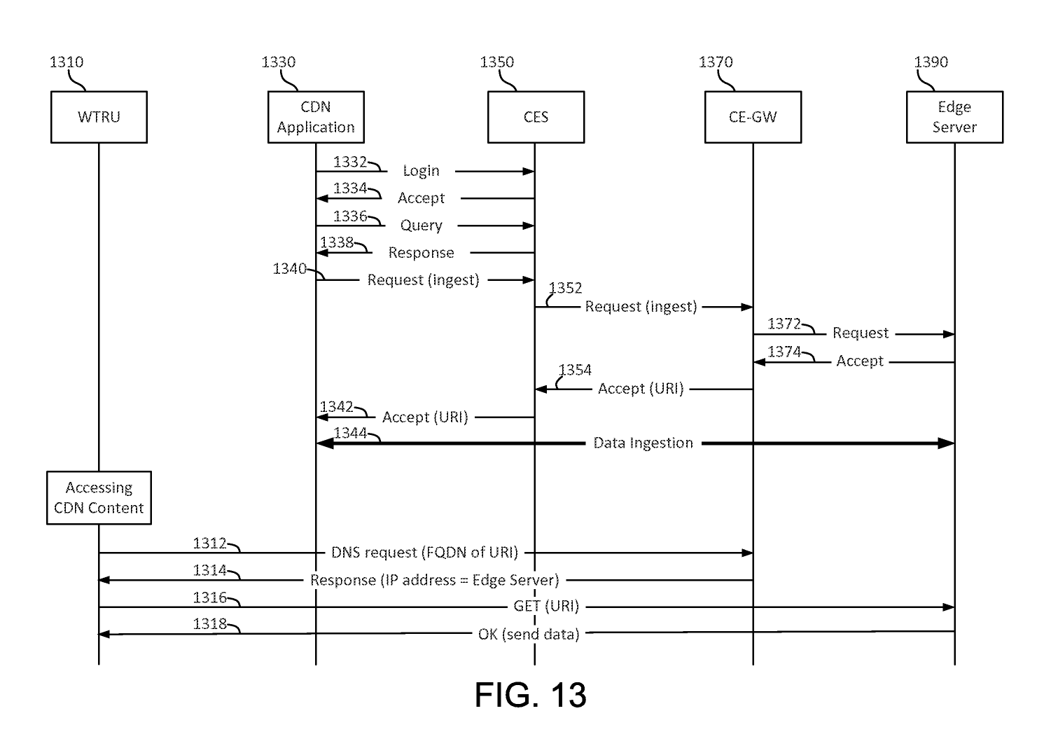

An external application (EA) (e.g., a CDN application) may use Lₐ interface to connect to the centralized content controller (CCC) (e.g., a CES service), such as described by example in FIG. 7, and/or FIG. 13. The CDN application may have an account (e.g., username and/or password) it may use for authentication and/or authorization with a CES, e.g., before the CDN application may be allowed to access the CES service. The communication between the CDN and CES may be secured, for example, using Hypertext Transfer Protocol Secure (HTTPS) protocol. CDN application may use the Lₐ interface to query the CES service of the available storage subsystem within one or more small cell networks. The query response from CES may include a map of the small cell networks associated with the amount of available storage in each location. The CDN application may use the Lₐ interface to acquire storage at one or more small cell networks. CDN application may use the Lₐ interface, e.g., to update, delete, and/or remove allocated amount of storage at one or more small cell networks. CDN application may use the Lₐ interface to request a logging service within certain small cell networks, to report wireless related statistics, and/or quality of experience related parameters. CDN application may use the Lₐ interface to allow streaming protocols, for example, real time streaming protocol (RTSP), session initiation protocol (SIP), HTTP progressive, and/or HTTP dynamic adaptive streaming (DASH) within the CE-GW.

The centralized content controller (e.g., CES) may have the latest information about one or more small cell networks and the available amount of storage for each small cell network. The small cell network information may be stored in a database system. The L_{b} interface may be used, e.g., to open and/or close connections with small cell networks. The connections may be used, e.g., to query about the status of the SCNs. Secured connections may be used as the transport protocol for this interface.

The centralized content controller may query small cell networks about their physical location and/or network topology to organize query response to EAs, e.g., in a map or graph format. CES may query the SCN of the availability of storage that may be used by the requesting CDN. The CES may receive response about the available storages in the SCN. The CES may reserve one or more storages in the SCN. The CES may receive a link (e.g., a URI) to the reserved URI. This URI may be used, e.g., by the operator's DNS to resolve to an IP address within the associated small cell network. CES may negotiate, e.g., the QoS and/or QoE parameters and/or the set of allowed data transport protocol with the small cell networks. CES may use the L_{b} interface to, e.g., enable logging service (e.g., detailed logging service) that may be used by the charging function of the core network.

The EA (e.g., CDN application) may store content materials in the allocated storage within the small cell network. The CDN application may organize the stored contents. For example, the stored contents may be stored in a hierarchy using a fault tolerance technique and/or a digital encryption scheme. CDN application using the L_{c} interface may apply a cache placement strategy. For example, during peak hours cache placement strategy may allow read-only operation on the allocated storage, while read-write operation may be allowed in any other hours.

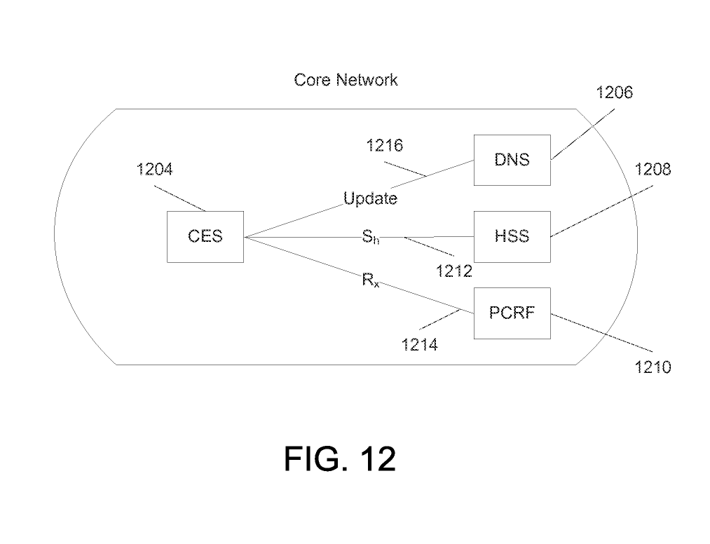

I_{ces} interface may be used by the CES to communicate with related functional entities in the core mobile network. CES may interact with the mobile core network in a similar manner the OneAPI servers may interact with the core mobile networks. The internal interface I_{ces} may be used internally. FIG. 12 illustrates an example of interaction between CES and core mobile network. As illustrated in FIG. 12 I_{ces} interface may be an integrated interface that may enable CES 1204 to interact with one or more core network entities, e.g., DNS 1206, HSS 1208, PCRF 1210 and ANDSF, etc. I_{ces} interface may be used as a single reference point that may refer to one or more interfaces. I_{ces} interface may be used to communicate with one or more core network components.

The CES, e.g., during the ingestion function, may receive ingestion URI from the SCN and forward the URI to the CDN application. The CDN application may store content data at the SCN. The URI may include a fully qualified domain name (FQDN). In order to enable WTRU requests (e.g., a WFRU camped within a femtozone) to stream and/or download contents associated with this URI, DNS records may be updated (e.g., using update interface 1216) to resolve this FQDN to IP addresses, e.g., within the local subriet of an SCN.

As illustrated in FIG. 12, CES 1204 may use the Sₕ interface 1212 to communicate with the home subscriber service (HSS) 1208 to access the authentication, authorization, and accounting (AAA) server during the authorization and authentication of CDN applications. Authentication and/or authorization may be used by providing username and/or password combination to access the CES service. CES 1204 may associate each CDN application with different level of agreement that may include variable quality of service (QoS) parameters and charging records. Rₓ interface 1214 may be used to perform such kind of operations.

The I_{ce-gw} interface may be used by the CE-GW to communicate with internal components within the SCN. The I_{ce-gw} interface may be viewed as an integrated interface of one or more smaller interfaces to interact, e.g., with SCN storage, edge servers, HeNB, etc. I_{ce-gw} interface may be considered as a single reference point that may refer to a number of interfaces used to communicate with other SCN components.

FIG. 13 illustrates an example of CDN content ingestion within an SCN storage subsystem, and a WTRU accessing the CDN content within the SCN. As illustrated in FIG. 13, at 1332, CDN application 1330 may login to SCN service by sending login information, e.g., username and/or password to CES 1350. The CES 1350 may apply the authentication and authorization function.

At 1334, the CES 1350 may send an acceptance to the CDN application 1330. At 1336, CDN application 1330 may send a query to CES 1350 to access one or more records within CES database. The query may include a request for available SCN storage within a geographical region. At 1338, the CES 1350 may send a response to the CDN application. The response to the CDN 1330 may include a list of SCNs (e.g., identification of the SCNs) that may satisfy the requested query. The CDN application may request for a virtual edge server with an amount of storage and one or more services. At 1340, CDN application 1330 may send a request for ingestion to a virtual edge server via CES 1350, and/or CE-GW 1370. At 1352, CES 1350 may forward the request for ingestion to a CE-GW 1370. At 1372, CE-GW 1370 may forward the request to a set of storages and services within an SCN infrastructure. At 1374, An SCN storage subsystem on edge server 1390 may send an acceptance message to CE-GW 1370 to allocate a virtual edge server to the CDN application. At 1354, CE-GW 137 may send a confirmation message to CES 1350. The confirmation message may include detailed information including the ingestion URI that may be used by the CDN application 1330. CES 1350 may apply SCN service enablement function and may extract the FQDN portion of the ingestion URI. This FQDN portion may be used by the core network DNS service. At 1342, CES 1350 may forward the acceptance message to the CDN application 1330. The acceptance message may include the ingestion URI. At 1344 data ingestion between the CDN application 1330 and the allocated edge server 1390 in the SCN may be applied.

A WTRU 1310 camped within an SCN zone may access material that may be delivered by the CDN and may be ingested by the CDN application in the SCN storage. At 1312, an application on WTRU 1310 may send a DNS request to resolve the IP addresses of the FQDN portion of the content URI to the CE-GW 1370. At 1314, the DNS at CE-GW 1370 may send a list of IP addresses to the WTRU with one or more of the IP addresses pointing to the virtual edge server 1390 within the SCN. At 1316, the WTRU application on WTRU 1310 may send a GET request message with the content URI to the SCN edge server 1390 to download and/or stream such material. At 1318, the SCN edge server 1390 may send the requested content to WTRU 1310.

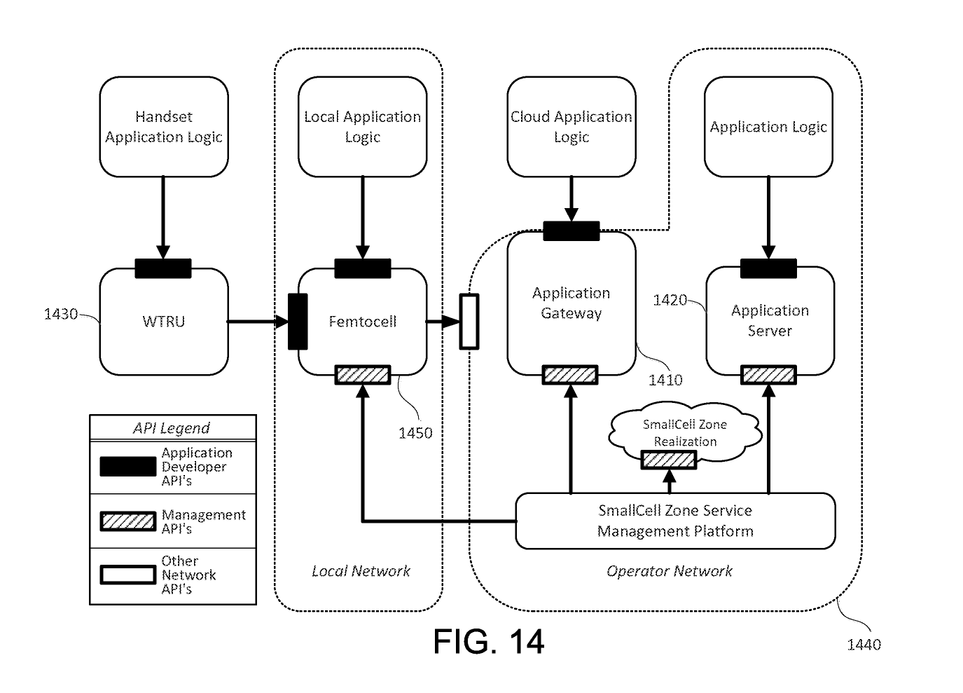

FIG. 14 illustrates an example of a small cell service architecture or FemtoZone. In a small cell service one or more Application Programming Interfaces (APIs) may be provided. As illustrated in FIG. 14, the APIs provided may include, for example, application developer APIs, management APIs, other network APIs, etc.

As illustrated in FIG. 14, one or more APIs may be provided. In an example, FemtoZone Service APIs may be implemented at a variety of locations in a network. For example, FemtoZone Service APIs may be implemented at one or more wireless transmit/receive units (WTRUs), such as handsets (e.g., WTRU 1430. As another example, FemtoZone Service APIs may be implemented at an application gateway 1410 of an operator network 1440. These APIs may be exposed to a third party application developer community and may include a FemtoContentEnablement API. FemtoZone Service APIs may also be implemented at a femtocell 1450 that may share similar, e.g., the same API definitions as the application gateway 1410. FemtoZone Service APIs may also be implemented at an application server 1420 of an operator network 1440.

Zonal Presence API may provide a subscription mechanism where one or more authorized applications may receive notifications of user activities within a zone. A zone may include one or more access points representing an entity, such as a chain store or shopping mall. OneAPI SMS/MMS interface may allow applications to send and/or receive SMS/MMS messages. Zonal Awareness implementation may restrict SMS/MMS message interactions when mobile devices are in a zone associated with the application. OneAPI location interface may allow an application to query the location of one or more mobile devices that may be connected to an operator network. The Zonal Awareness implementation may restrict location queries, e.g., when mobile devices are in a zone associated to the application.

The OneAPI web service is a lightweight RESTful web service that may allow portability of mobile applications across various mobile networks. A RESTful API may utilize HTTP commands, such as POST, GET, PUT, and/or DELETE, to perform an operation on a resource at the server. Mobile operators may support some or all of a number of APIs within the OneAPI web service. An example API within the OneAPI web service is Anonymous Customer Reference (ACR), which may allow the creation of an ACR for the current user and the use of that ACR in OneAPI requests in place of an MSISDN. HTTP POST may be used to create a Customer Reference and GET may be used to read an existing ACR. The following is an example of GET a resource uniform resource identifier (URI): http://example.com/customerReference/v1/{address}/acr.

A Customer Profile API may be used to query the customer profile of an end user who may be the customer of a mobile network operator. For example, HTTP GET may be used to retrieve the Customer Profile. The following is an example of GET a resource URI: hitp://example.com/customerProfile/v1/{endUserId}?attributes={comma separated list of attributes}.

A Zonal Presence API may read or be notified of entries and exits from small cell service architectures, such as Femtozones. For example, one or more of HTTP POST, GET, or DELETE commands may be used in an OneAPI Zonal Presence API. The following is an example of GET (e.g., to query the zone status and relevant statistics) a resource URI: http://example.com/zonalpresence/v1/zone/status/?zoneId={zoneId}.

Payments API may charge mobile subscribers for use of a Web application or content. For example, one or more of HTTP POST, GET, or PUT commands may be used in an OneAPI Payments API. The following is an example of POST (e.g., to charge a user) a resource URI: http://example.com/payment/v1/{endUserId}/transactions/amount.

An SMS API may be used to send SMS and/or to query an SMS delivery status. For example, one or more of HTTP POST, GET, or DELETE commands may be used in a OneAPI SMS API. The following is an example of GET (e.g., to query the delivery status) a resource URI: http://example.com/smsmessaging/v1/outbound/{senderAddress}/requests/{requestId}/deliveryI nfos.

An MMS API may be used to send MMS and/or to query an MMS delivery status. For example, one or more of HTTP POST, GET, or DELETE commands may be used in an OneAPI MMS API. The following is an example of POST (e.g., to send MMS) a resource URI: http://example.com/messaging/v1/outbound/{senderAddress}/requests.

Location API may be used to quety a location or locations of mobile terminal(s). HTTP GET command may be used to retrieve location info. The following is an example of a resource URI: http://example.com/location/v1/queries/location?address={address}&requestedAccuracy={metre s}

Voice Call Control API may be used to create a call between two or more parties, add or remove participants from the call, and/or get information about the participants. For example, one or more of HTTP POST, GET, or DELETE commands may be used in an OneAPI voice call control API. The following is an example of POST (to create a call) a resource URI: http://example.com/{api version}/thirdpartycall/callSessions

Data Connection Profile API may be used to request the connection type (3G, GPRS, etc.) of the terminal, and/or to retrieve the roaming status of the terminal. For example, HTTP GET may be used to retrieve the Terminal Status. The following is an example of GET a resource URI: http://example.com/terminalstatus/v1/queries/connectionType?address={terminalId}

Device Capability API may use an HTTP GET command to retrieve device capability. The following is an example of a resource URI: http://example.com/devicecapabilities/v1/{address}/capabilities

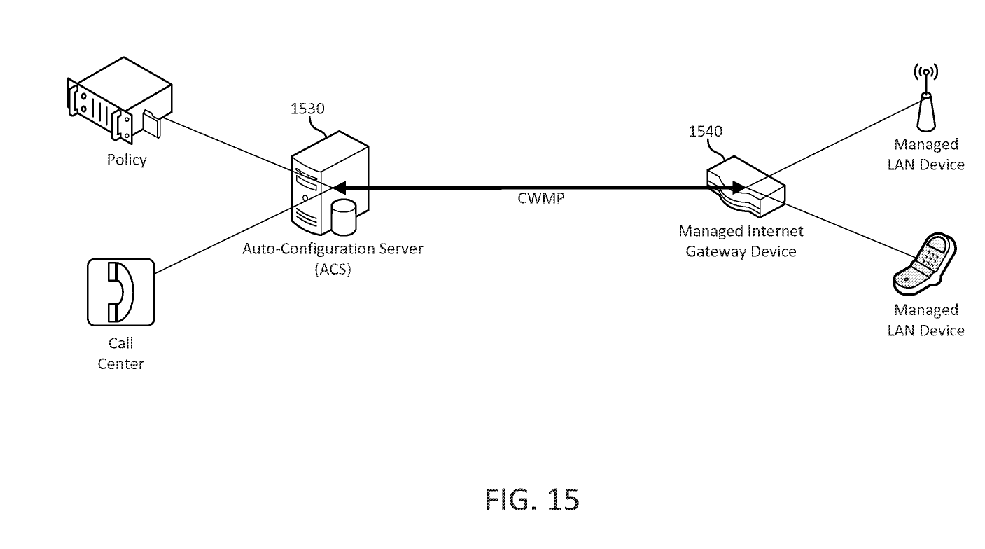

CPE WAN Management Protocol (CWMP) may be used as an application layer protocol for remote management of end-user devices. A bidirectional SOAP/HTTP-based protocol may be used to communicate between customer-premises equipment (CPE) and Auto Configuration Servers (ACS). FIG. 15 illustrates an example of an end to end architecture, where an ACS 1530 may communicate with the CPE (e.g., gateway device 1540) using CWMP.

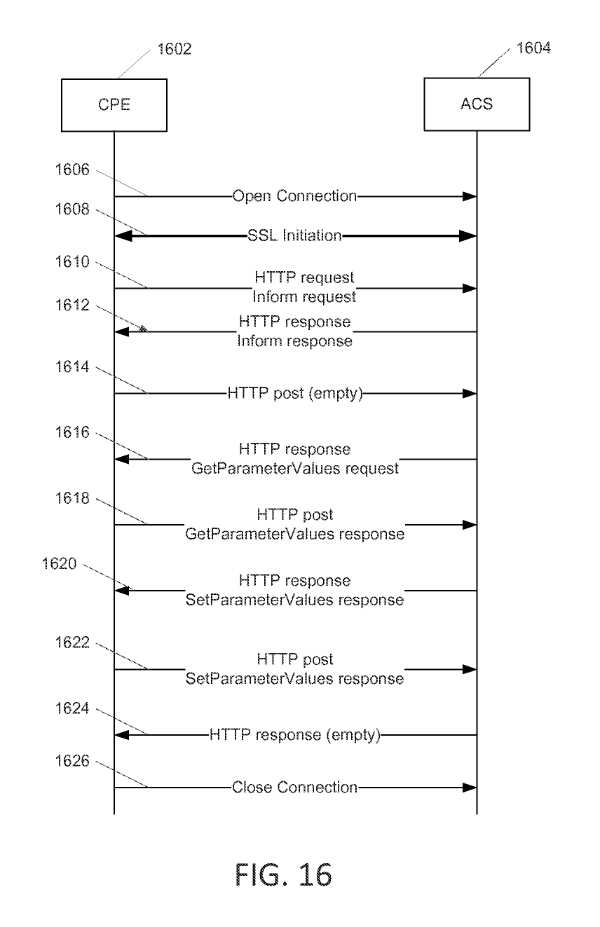

One or more of a configuration, or diagnostics may be performed through setting and/or retrieving the value of the device parameters. Device parameters may be organized in data models that may be formatted into XML documents. FIG. 16 illustrates an example of a transaction session between a CPE 1602 and an ACS 1604. As illustrated in FIG. 16, at 1606 a connection may be established between CPE 1602 and ACS 1604. At 1608, an SSL connection may be initiated between CPE 1602 and ACS 1604. At 1610, CPE 1602 may send an inform request message (e.g., a HTTP request message) to ACS 1604. At 1612, CPE 1602 may receive an inform response message (e.g., an HTTP response message). At 1614, CPE 1602 may send an empty HTTP post message to ACS 1604. At 1616, ACS 1604 may send a GetParameterValues request message. At 1618 ACS 1604 may receive a GetParameterValues response. The ACS 1604 may read the set of parameter values, and based on the result, at 1620, ACS 1604 send an HTTP response message including SetParameterValues response. ACS 1604 may use the SetParameterValues message to set one or more parameter values. At 1622, ACS 1604 may receive a SetParameterValues response message. At 1624, ACS 1604 may send an empty HTTP response message to ACS 1604. At 1626, the connection between the ACS 1604 and CPE 1602 may be closed.

One or more operations may be used to read parameter values. Fur example, a GetParameterNames operation may be used to retrieve a list of supported parameter keys from a device. A GetParameterValues operation may be used to retrieve current value of the parameters identified by keys. A SetParameterValues operation may be used to set value of one or multiple parameters. A GetParameterAttributes operation may be used to retrieve attributes of one or multiple parameters. A SetParameterAttributes operation may be used to set attributes of one or multiple parameters. A Download operation may be used to order CPE to download the file specified by a URL such as a Firmware Image, Configuration File, Ringer file, etc. An Upload operation may be used to order CPE to upload a specified file type to the specified destination. This could cover, for example, the current configuration file or log files.

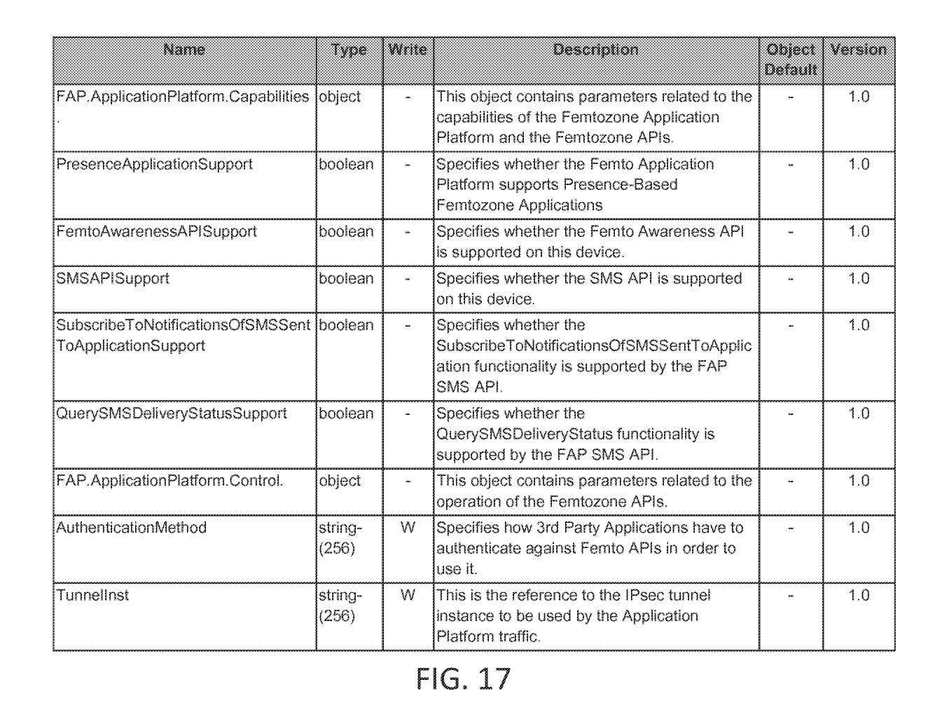

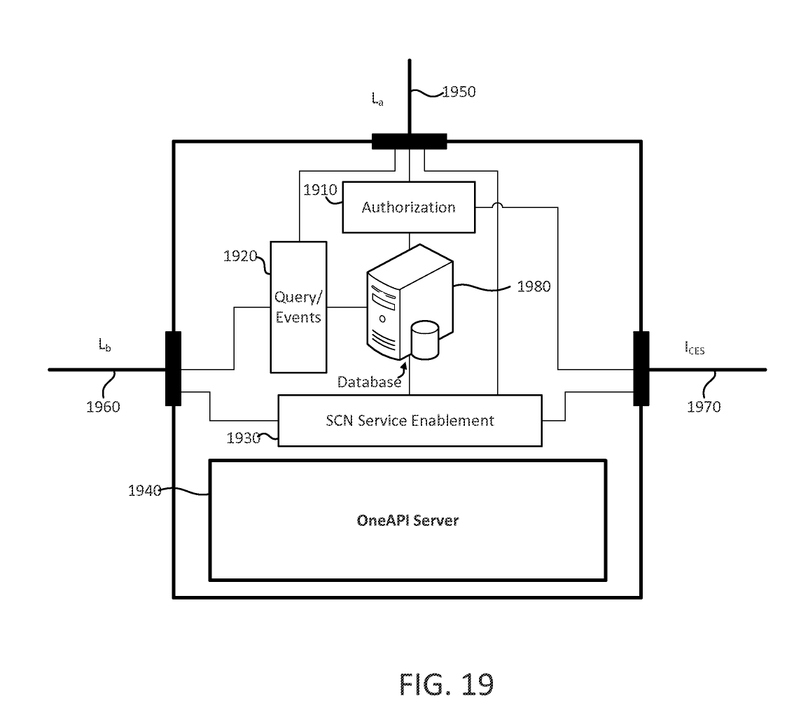

In an example, components specific to a FemtoZone small cell service architecture may be used to define common functions independent of the radio technologies that may be used by devices. FIG. 17 illustrates a table illustrating a list of one or more example components of a FemtoZone Application Platform Data Model. A FAP.ApplicationPlatform.Capabilities.object, for example, may contain parameters related to capabilities of a FemtoZone Application Platform and FemtoZone APIs. A PresenceApplicationSupport Boolean component may specify whether the FemtoZone Application Platform supports Presence-Based FemtoZone applications. A FemtoAwarenessAPISupport Boolean component may specify whether a Femto Awareness API is supported on a device. SMSAPISupport Boolean component may specify whether an SPS API is supported on a device. A SubscribeToNotificationsOfSMSSentToApplicationSupport Boolean component may specify whether a SubscribeToNotificationsOfSMSSentToApplication functionality is supported by a FAP SMS API. A QuerySMSDeliveryStatusSupport Boolean component may specify whether a QuerySMSDeliveryStatus functionality is supported by the FAP SMS API. A FAP.ApplicationPlatform.Control. object may contain parameters related to the operation of FemtoZone APIs. An AuthenticationMethod string component may specify how third party applications have to authenticate against Femto APIs in order to use them. A TunnelInst string component may be or include a reference to an IPsec tunnel instance that is to be used by traffic on the Application Platform.

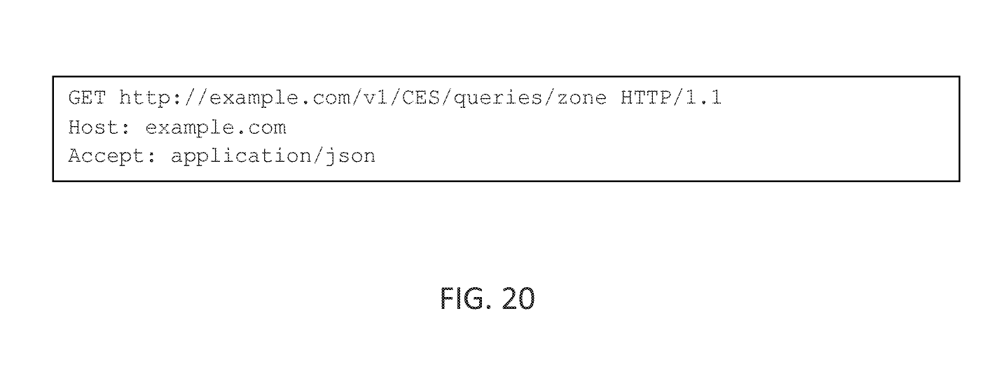

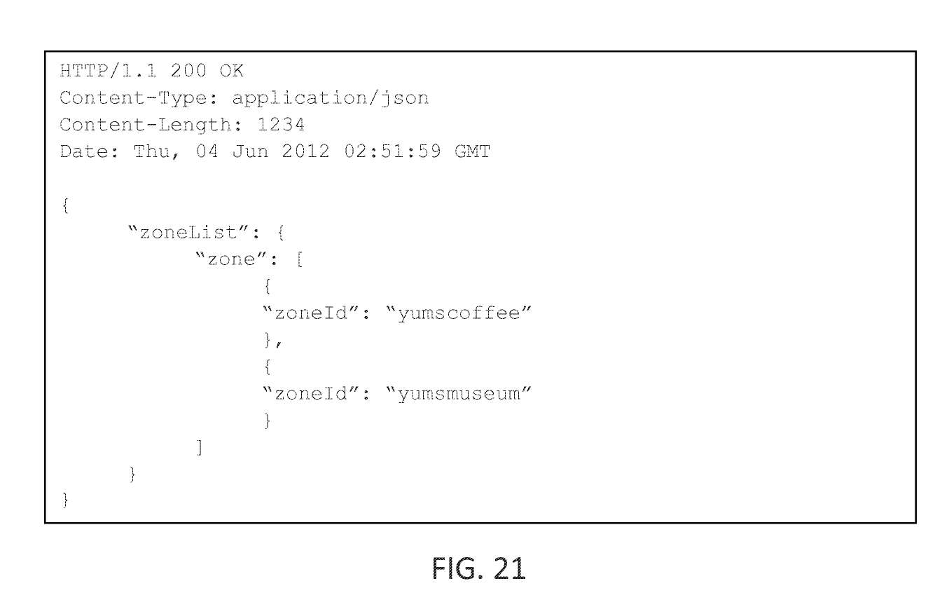

In an example, a data store query API or status API may provide the ability for CDN or other applications to query the data store capabilities of a FemtoZone. For example, an application can determine whether a data store is available at certain FemtoZones. The data store query API may take no request arguments and may respond with a list of FemtoZones where a data store service is available. The list may be provided as a list of FemtoZone identifiers, such as CSG IDs, Access Point IDs, and/or aliases. OneAPI query of available data stores may involve the use of a server side certificate for authentication and may use HTTP basic authentication. The query of available data stores may be accessed via an API (e.g., REST API) to provide the zone identifiers that the CDN may be authorized to see. A retrieval command (e.g., a GET command) may be used to retrieve the available data stores. The data store query API may use the following uniform resource indicator (URI): http://example.com/{api version}/CES/queries/zone. In the URI, the example.com may be replaced with the hostname of the OneAPI server that is being accessed. API version may indicate the version of the OneAPI Status API that is being accessed. The response content type for the status API may be application/JSON. FIG. 20 illustrates an example request to an example data store query API. FIG. 21 illustrates an example response from the example data store query API.

As another example, a query FemtoZone data store status API may allow an application to query the status of a particular data store within a specific FemtoZone. The query FemtoZone data store status API may take a FemtoZone ID as a request argument. The FemtoZone ID may be supplied, for example, as a CSG ID, Access Point ID, and/or alias. A response from the API may include response arguments such as a success or failure indicator; an indication of the available storage resources within the provided FemtoZone ID; networking related status information, such as average bandwidth, average delay to femtocell users, QoS parameters, and/or wireless related parameters; physical area parameters of the femtocells that are covered by the provided FemtoZone ID, e.g., a ZIP code or postal code of the area covered by the FemtoZone; a list of data-related services that are provided within a FemtoZone ID, which may include but are not limited to multimedia streaming services, adaptive file download, multicast services, backup service, etc.; a number of available access points in a FemtoZone ID; and/or a current number of users in a FemtoZone ID.

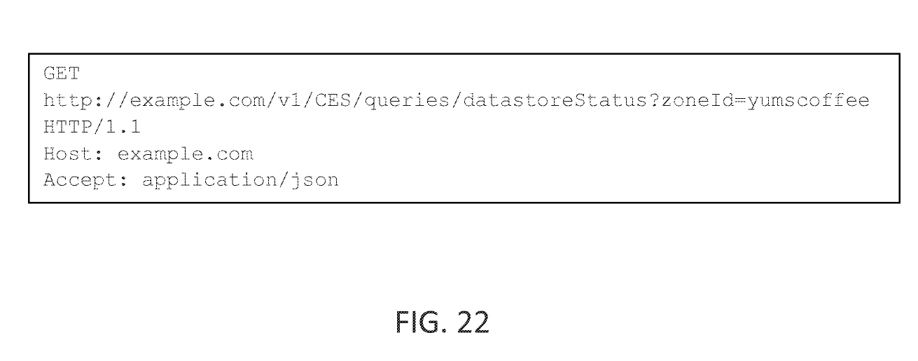

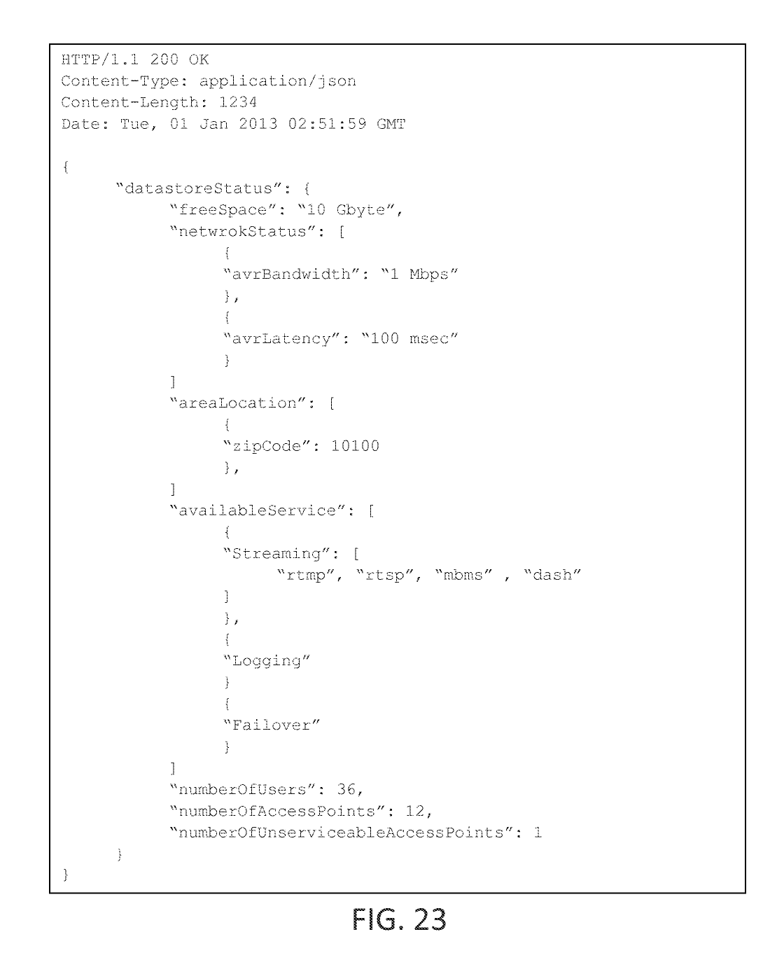

The query FemtoZone data store status API may involve the use of a server side certificate for authentication and may use HTTP basic authentication. It may be accessed via the REST API to query a zone for its status and other relevant information. A retrieval command (e.g., a GET command) may be used to retrieve the status of a data store in a FemtoZone. The URI used in this API may be: http://example.com/{api version}/CES/queries/datastoreStatus?zoneId={zone id}. In the URI, the example.com may be replaced with the hostname of the OneAPI server that is being accessed. API version may indicate the version of the OneAPI Status API that is being accessed. The response content type for the status API may be application/JSON. FIG. 22 illustrates an example request to an example FemtoZone data store status query API. FIG. 23 illustrates an example response from the example FemtoZone data store status query API.

In an example, a virtual edge server service API may be used to provide the ability for CDN or other applications to create, update, or delete a virtual edge server with certain capabilities in some of the FemtoZones. A create virtual edge server operation may allow an application to create an edge server of a data store in a particular FemtoZone. The create virtual edge server service API may take a number of request arguments, including, for example, a FemtoZone identifier, such as a CSG ID, an Access Point ID, or an alias; an argument that may specify the amount and type of storage that may be requested within the provided FemtoZone ID; a list of data related services that may be used with the edge server, including, for example, multimedia streaming services, adaptive file download, multicast services, backup services, etc.; and/or a client correlator that may be created by an application to uniquely identify an edge server request. If the application resends a request due to a missing response, resending the request with the same correlator may prevent the server from repeating the request.

A response from the API may include response one or more arguments including, for example, a success or failure indicator; an indication of resource allocation within the operator's application server, which indication can be used to modify the allocated resources within certain FemtoZones; a list of externally accessible URLs to the allocated data store and associated services for content ingestion, multimedia streaming, and/or logging services; and/or a client correlator that identifies the response as being related to a particular client request.

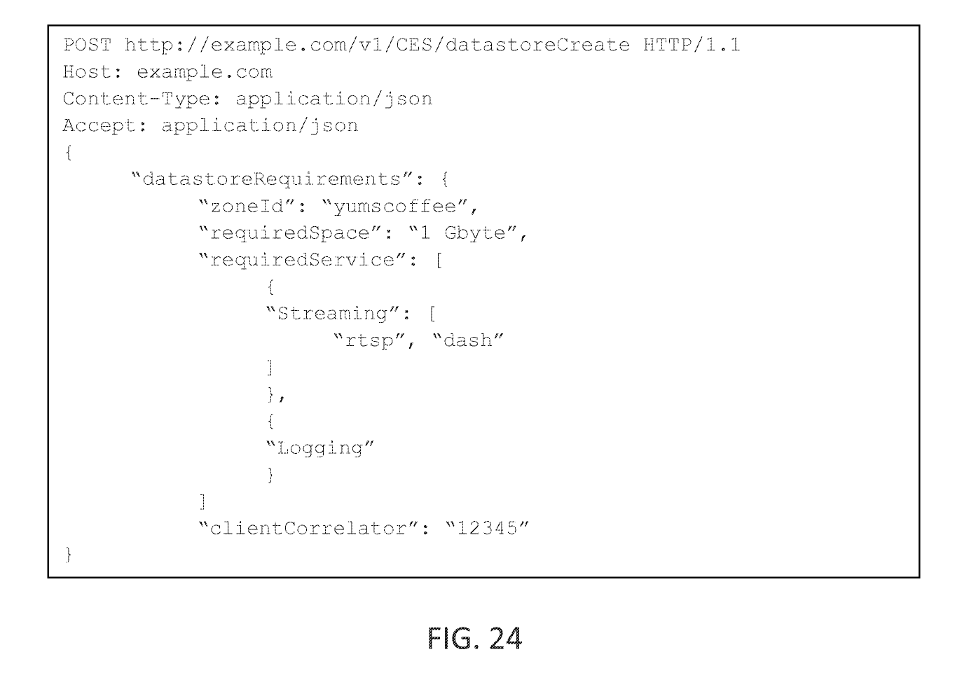

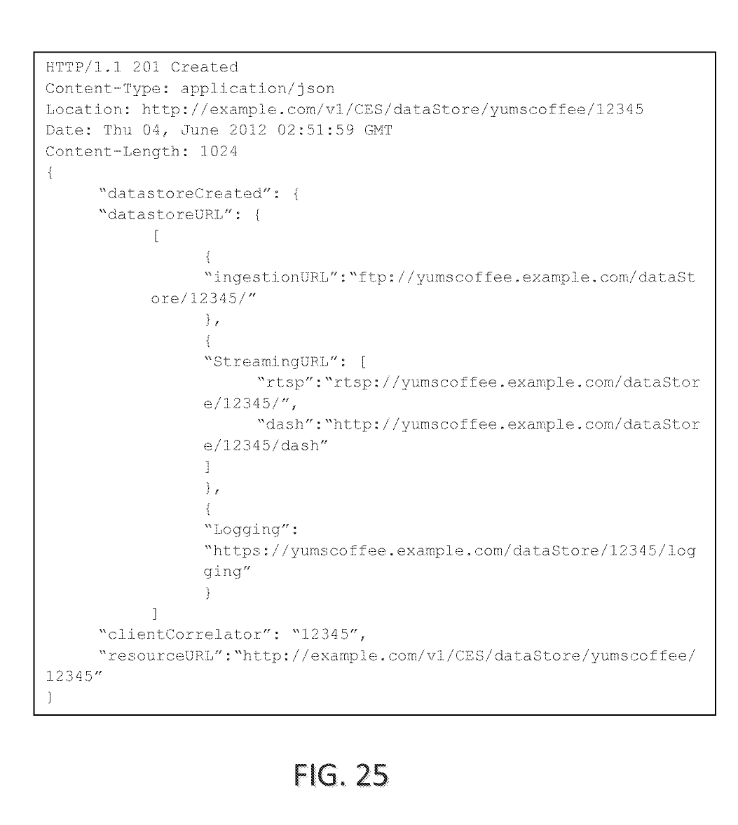

The create virtual edge server service API may involve the use of a server side certificate for authentication and may use HTTP basic authentication. The create virtual edge server service API may be accessed via the REST API to provide a data storage for some CDN applications. A request (e.g., a POST command) may be used to create a virtual edge server. The URI used in this API may be:http://example.com/{api version}/CES/datastoreCreate. In the URI, the example.com may be replaced with the hostname of the OneAPI server that is being accessed. API version may indicate the version of the OneAPI Status API that is being accessed. The request and response content type for the virtual edge server service API may be application/JSON. FIG. 24 illustrates an example request to an example create virtual edge server service API. FIG. 25 illustrates an example response from the example create virtual edge server service API.

A delete virtual edge server operation may allow an application to delete an edge server from a particular FemtoZone. The delete virtual edge server service API may take as a request argument a resource URL that may identify a resource allocation within the operator's application server and may refer to a created virtual edge server within a FemtoZone. A response from the API may include as a response argument a success or failure indicator.

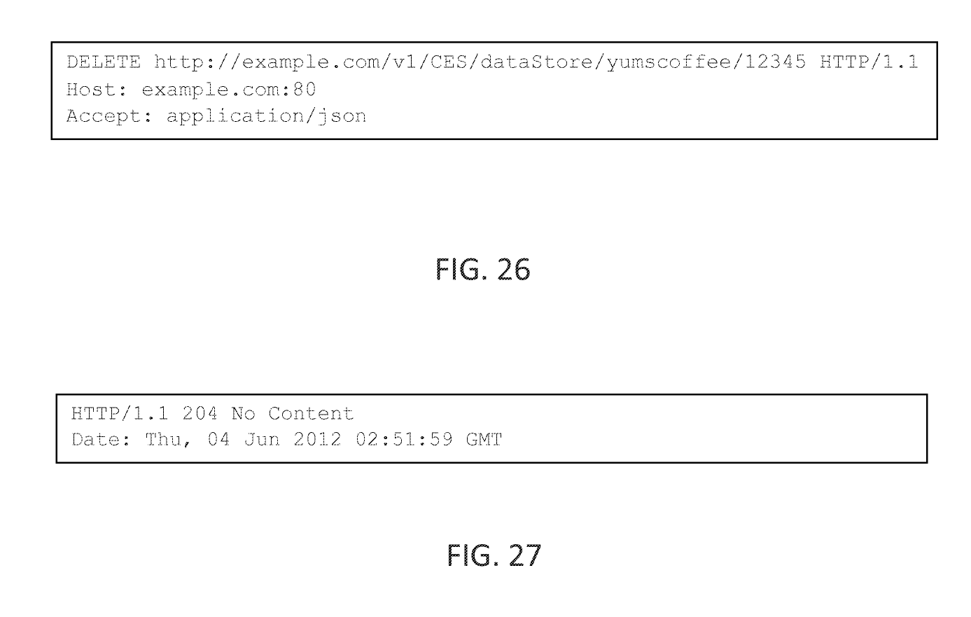

The delete virtual edge server service API may involve the use of a server side certificate for authentication and may use HTTP basic authentication. The delete virtual edge server service API may be accessed via the REST API to remove an allocated data storage for some CDN applications. The DELETE command may be used to remove a virtual edge server. The URI used in this APT may be the resource URL that was sent during the create virtual edge server operation. FIG. 26 illustrates an example request to an example delete virtual edge server service API. FIG. 27 illustrates an example response from the example delete virtual edge server service API.

An update virtual edge server operation may allow an application to update a virtual edge server that has already been created by modifying the amount of allocated storage or updating the services used by the edge server. The update virtual edge server service API may take a number of request arguments, including, for example, a resource URL that may identify a resource allocation within the operator's application server and that may refer to a created virtual edge server within a FemtoZone; an argument that may specify the amount and type of storage that is requested to be modified; a list of data related services that may be modified; and/or a client correlator that may be created by an application to uniquely identify an edge server request. If the application resends a request due to a missing response, resending the request with the same correlator may prevent the server from repeating the request.

A response from the API may include a number of arguments, including, for example, a success or failure indicator; a resource URL that may identify a resource allocation within the operator's application server and that may be different from the originally created resource URL; a list of externally accessible URLs to the allocated data store and associated services for content ingestion, multimedia streaming, and/or logging services; and/or a client correlator that identifies the response as being related to a particular client request.

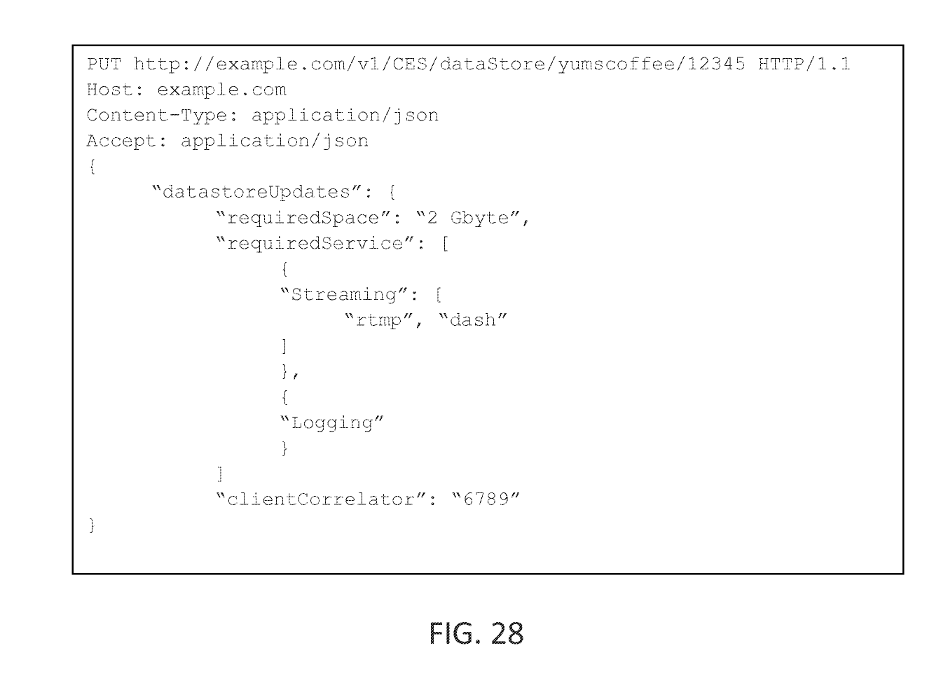

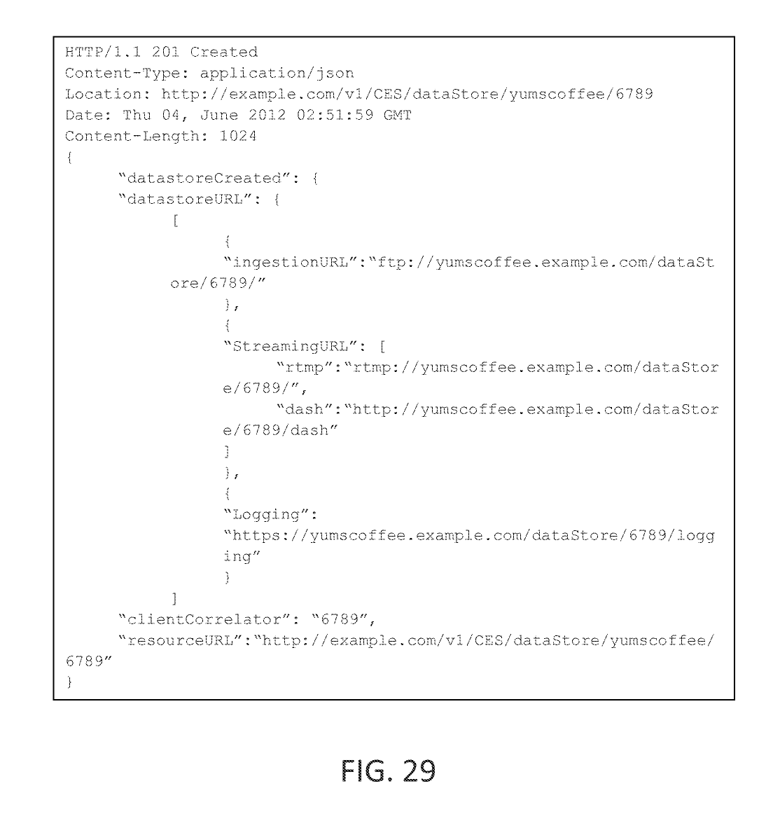

The update virtual edge server service API may involve the use of a server side certificate for authentication and may use HTTP basic authentication. The update virtual edge server service API may be accessed via the REST API to modify a data store for some CDN applications. A PUT command may be used to update a virtual edge server. The URI used in this API may be the resource URL that was sent during the create virtual edge server operation. The request and response content type for the virtual edge server service API may be application/JSON. FIG. 28 illustrates an example request to an example update virtual edge server service API. FIG. 29 illustrates an example response from the example update virtual edge server service API.

An edge server status query operation may allow an application to query the status of an already created virtual edge server. The status information might carry a comprehensive data store and network related data that is captured during an observation period in the FemtoZone, where the virtual edge server may be located. The edge server status query service API may take as a request argument, for example, a resource URL that may identify a resource allocation within the operator's application server and that may refer to a created virtual edge server within a FemtoZone. A response from the API may include a number of arguments, including, for example, a success or failure indicator; a FemtoZone identifier that may identify the virtual edge server; a timestamp that may carry time data related to the observation period where the statistical information was collected; a list of status information that is related to the allocated data store, e.g., that may carry the hard disk failure rate and/or the average throughput from the data store; a list of status parameters that may be related to networking resources, e.g., the average bandwidth and latency or the average number of users accessing the data store; a list of status parameters that may be related to FemtoZone parameters, such as a FemtoZone identifier, geolocation, a total number of users using the edge server, the total number of AP used by the edge server, etc.; and/or a list of externally accessible URLs to the allocated data store and associated services for content ingestion, multimedia streaming, and/or logging services.

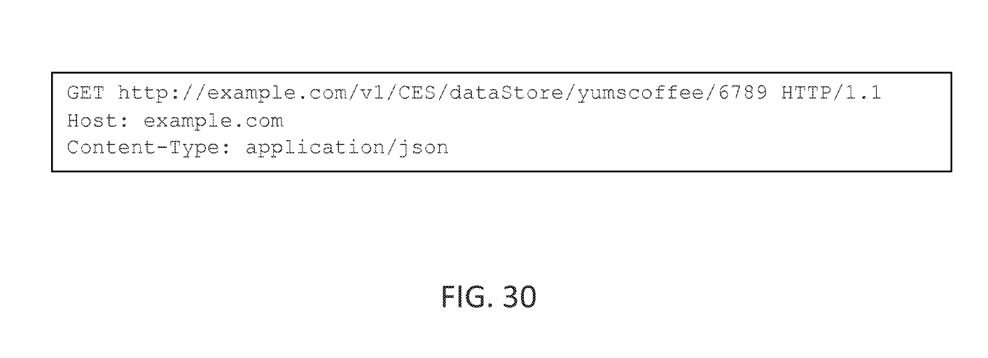

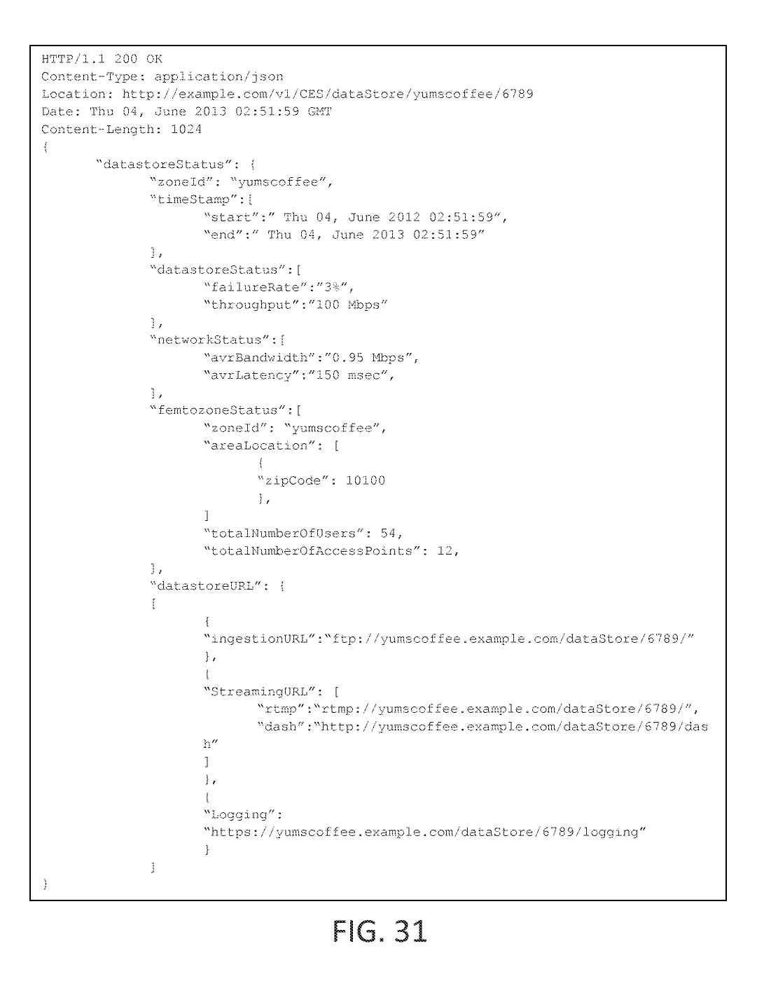

The edge server status query service API may involve the use of a server side certificate for authentication and may use HTTP basic authentication. It may be accessed via the REST API to query the status of a virtual edge server. The URI that may be used in this API may be the resource URL that was sent during the create or update virtual edge server operation. The response content type for the edge server status query service API may be application/JSON. FIG. 30 illustrates an example request to an example edge server status query service API. FIG. 31 illustrates an example response from the example edge server status query service API.

In another example, a data store event service API may provide the ability for CDN applications to subscribe to certain events related to content enablement services within certain FemtoZones. A subscribe to data store events operation may allow an application to subscribe to events related to DataStore activities within a FemtoZone. The data store event service API may take one or more request arguments, including, for example, a FemtoZone identifier that may identify the FemtoZone that the subscription may apply to. The API implementation may allow the application access to certain FemtoZones (e.g., to only certain FemtoZones). Other request arguments may include a notify URL, a client correlator, callback data, etc. The notify URL may indicate to the application server where the server may send notifications. A client correlator that may be created by the application to identify the subscription request such that, if the application resends a request due to a missing response, then resending the request with the same correlator may prevent the server from repeating the request. Callback data may be context data that may be included with the response to a request.

A response from the API may include a number of response arguments, including, for example, a resource URL, callback data of the request, etc. Resource URL may be used to identify the subscription for canceling the subscription. Notifications from the API may include a number of notification arguments, for example, a FemtoZone identifier, a FemtoZone status, callback data. FemtoZone identifier that may identify the FemtoZone of the notification. FemtoZone status indicator, such as a list of status parameters may be related to FemtoZone parameters, e.g., the geo-location, total number of users, the total number of AP in this FemtoZone, etc. Callback data may be context data that may have been passed as part of the subscription to notifications request.

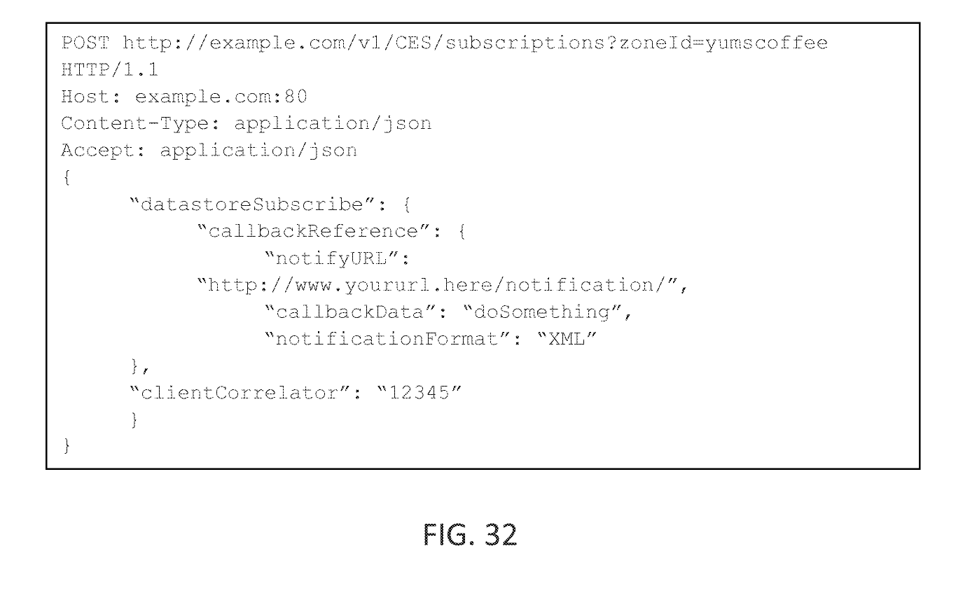

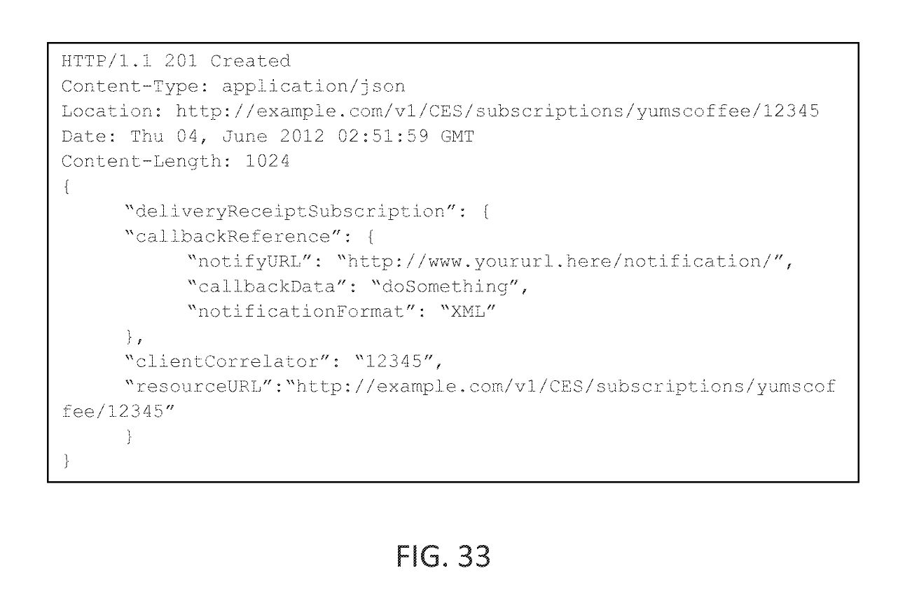

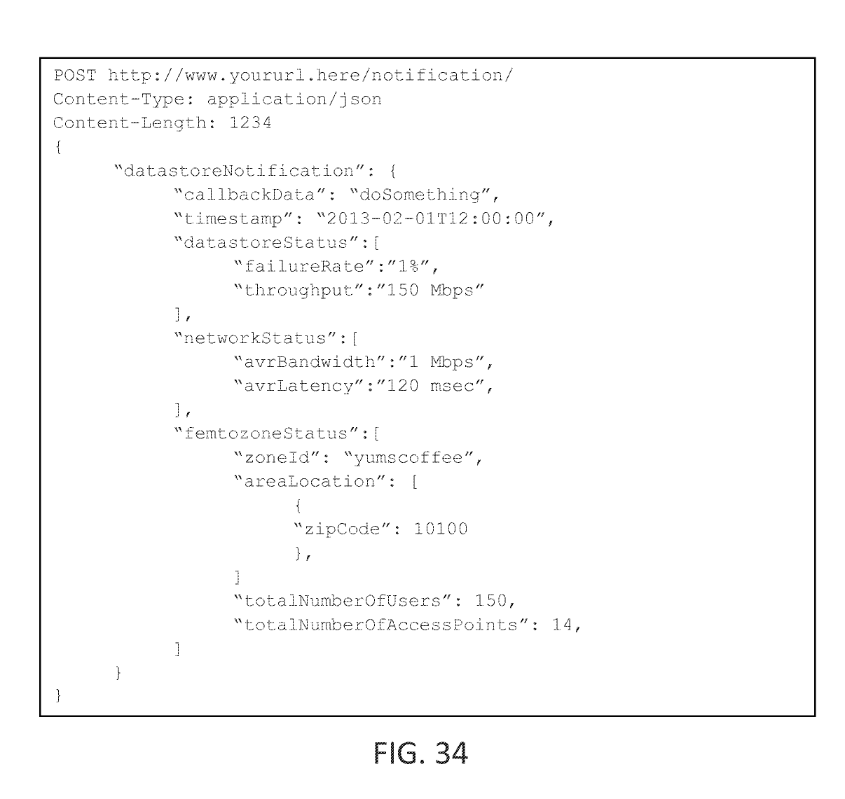

The data store event service API may involve the use of a server side certificate for authentication and may use HTTP basic authentication. It may be accessed via the REST API to provide a CDN application with customized information related to a certain FemtoZone. A request command (e.g., a POST command) may be used to subscribe to data store events. The URI used by this API may be: http://example.com/{api version}/CES/subscriptions?zoneId={zone id}. In this URI, the example.com may be replaced with the hostname of the OneAPI server that is being accessed. API version may indicate the version of the OneAPI Status API that is being accessed. The request and response content type for the subscribing to events API may be application/JSON. FIG. 32 illustrates an example request to an example data store event service API. FIG. 33 illustrates an example response from the example data store event service API. FIG. 34 illustrates an example notification from the example data store event service API.

In another example, a data store event service API may provide the ability for CDN applications to unsubscribe from, e.g., remove its subscription to, events related to data store activities within a FemtoZone. The data store event service API may take as an argument, for example, a resource URL, e.g., a subscription ID, that may be contained in the response to the subscribe to notification request. The response from the data store event service API may include as a response argument, for example, a success or failure indicator.

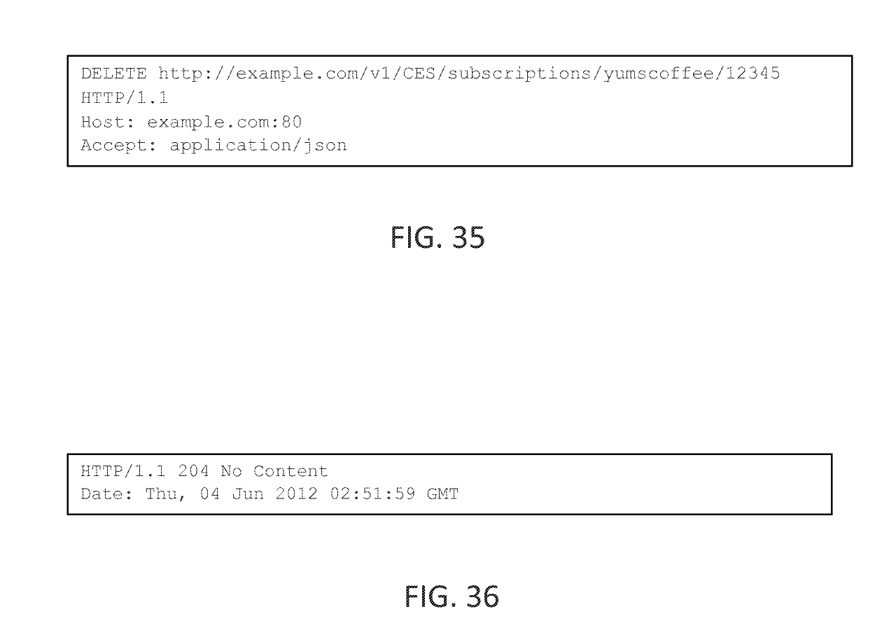

The data store event service API may use HTTP basic authentication, and may use a server side certificate for authentication. Unsubscribe to data store events may be accessed via the REST API, e.g., to remove previously assigned notification requests. A DELETE command may be used to remove a notification request. The URI used in this API may be the resource URL that was sent during a notification subscription operation. FIG. 35 illustrates an example request to an example data store event service API. FIG. 36 illustrates an example response from the example data store event service API.

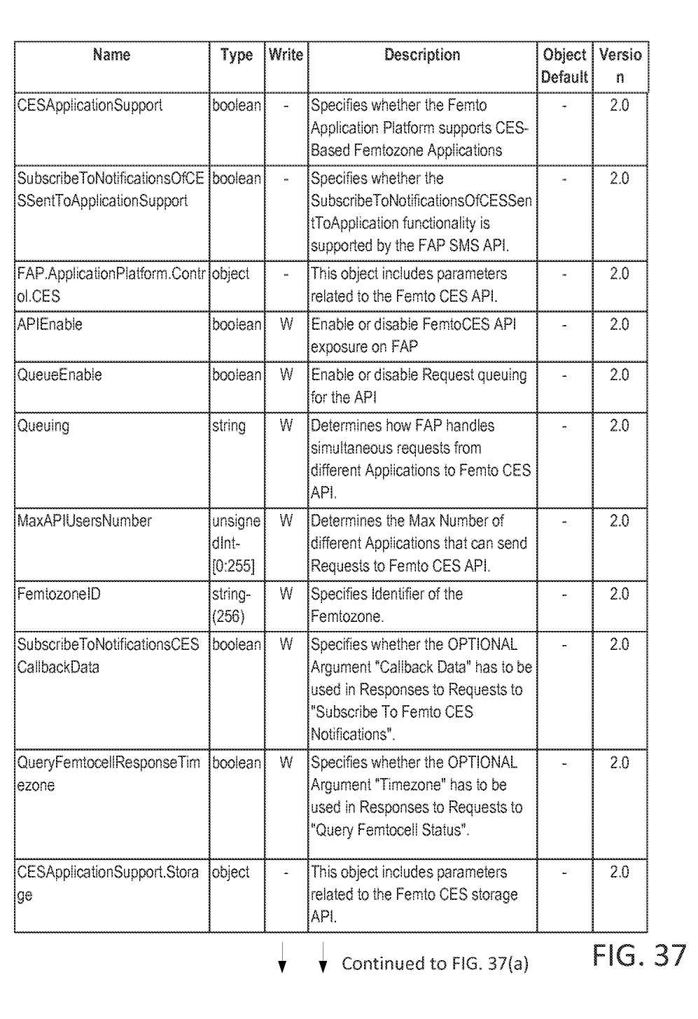

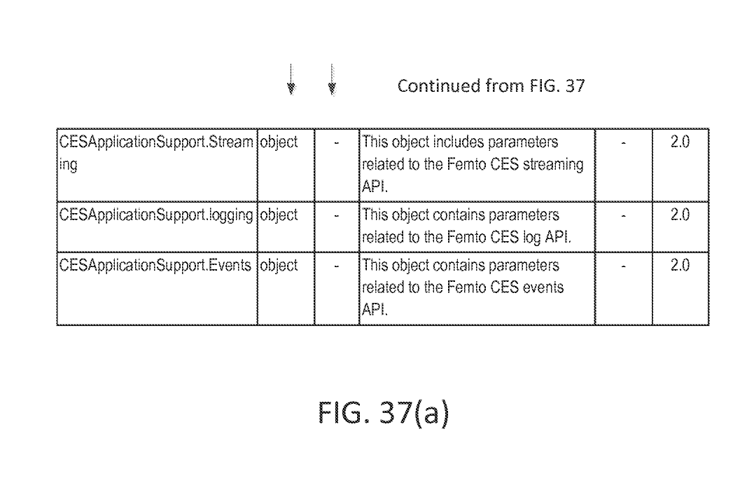

In another example, a FemtoZone CES Application Platform data model may have a number of components, for example, for management by a mobile network operator (MNO) using L_{b} interface. The table depicted in FIG. 37 and FIG. 37(a) illustrates a list of one or more example components of a FemtoZone CES Application Platform Data Model. As illustrated in FIG. 37 and FIG. 37(a), a CESApplicationSupport Boolean component may specify whether the Femto Application Program supports CES-based Femtozone Applications. A SubscribeToNotificationsOfCESSentToApplicationSuppot Boolean component may specify whether the SubscribeToNotificationsOfCESSentToApplication functionality is supported by the FAP SMS API. A FAP.ApplicationPlatform.Control.CES object may include parameters related to the Femto CES API. An APIEnable Boolean component may enable or disable FemtoCES API exposure on FAP. A QueueEnable Boolean component may enable or disable Request queuing for the API. A Queuing string component may determine how FAP handles simultaneous requests from different Applications to the Femto CES API. A MaxAPIUsersNumber unsigned integer component may determine the maximum number of different Applications that can send requests to the Femto CES API. A Femtozone ID string component may specify an identifier of a FemtoZone. A SubscribeToNotificationsCESCallbackData Boolean component may specify whether the argument Callback Data is used in responses to request to subscribe to Femto CES notifications. A QueryFemtocellResponseTimezone Boolean component may specify whether the argument Timezone is used in responses to requests to query a femtocell status. A CESApplicationSupport.Storage component may include parameters related to the Femto CES storage API. A CESApplicationSupport.Streaming component may include one or more parameters related to the Femto CES streaming API. A CESApplicationSupport.Logging component may include parameters related to the Femto CES log APT. A CESApplicationSupport.Events component may include parameters related to the Femto CES events API.

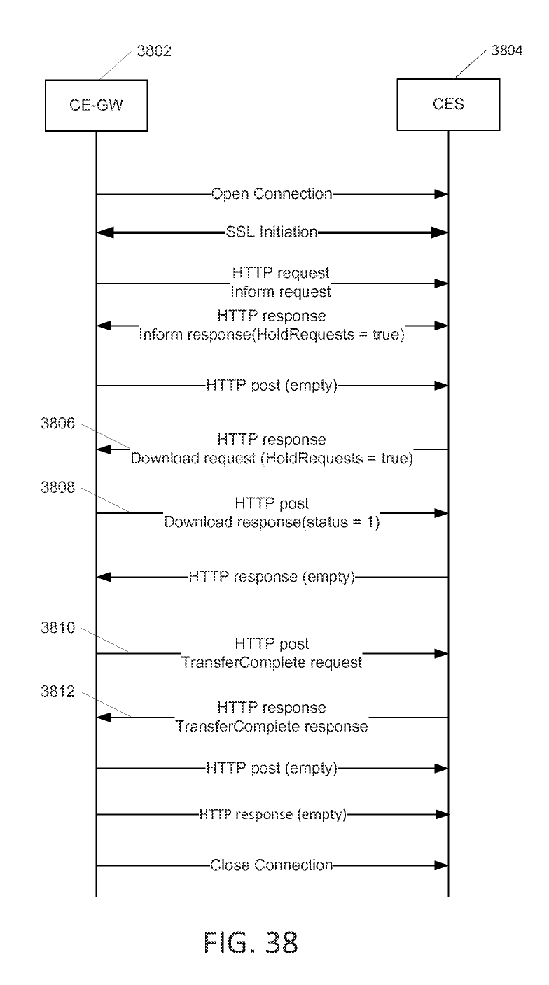

FIG. 38 illustrates an example message sequence diagram for a configuration download using an L_{b} interface. As illustrated in FIG. 38, at 3806 and 3808, the CES 3804 may initiate a file download to change the configuration file of the CE-GW 3802. At 3810 and 3812, the CE-GW 3802 may send a TransferComplete messages (e.g., in the same session). The sequence of messages as illustrated in FIG. 38 may be used to set a number of custom parameters related to the Femto CES storage data objects, which may enable the creation of a virtual edge server. Examples of custom parameters may include the storage size in megabytes, unique ID for each requesting CDN application, etc.

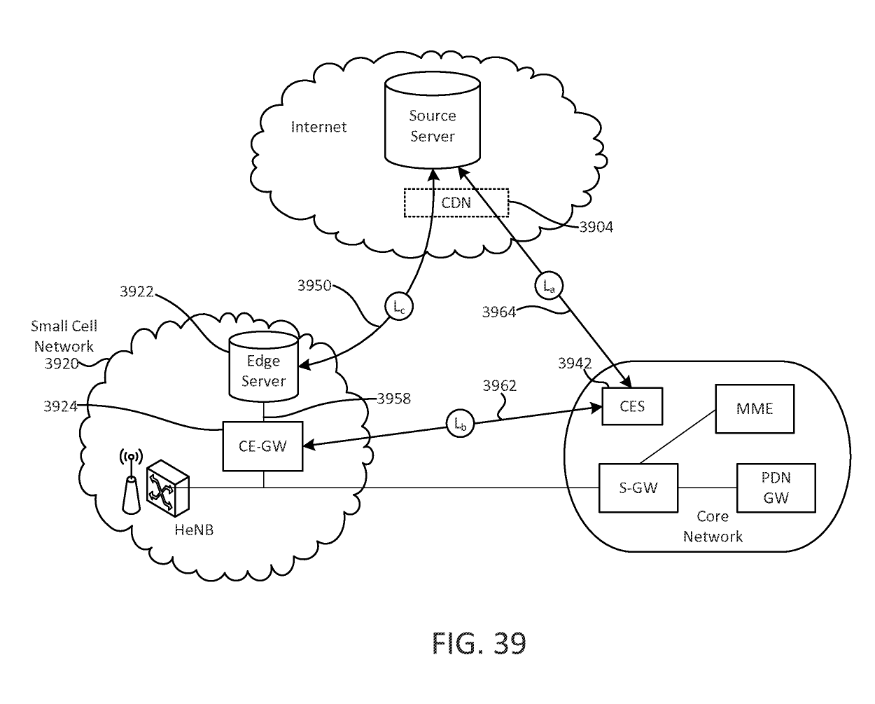

FIG. 39 is a diagram illustrating an example of a managed caching architecture. In managed caching architecture, a control entity within a core network (e.g., a mobile core network) may control the cache/storage within the femtozone. As illustrated in FIG. 39, one or more interfaces may be provided that may facilitate the managed edge caching in the small cell networks. An interface (e.g., La interface 3964) may be an externally exposed single interface for each of the EAs to communicate with the centralized content controller (CCC) (e.g., CES) node in the operator core network. This interface may be realized using the femtozone oneAPI services. The Lb interface 3962 may be and interface between a mobile network and a small cell. The Lb interface may be used by a mobile network operator or a small cell operator for communication between the CES node 3942, and the CE-GW 3924. The CES node 3942 may reside in a core network 3940. The CE-GW 3924 may reside in the small cell network 3920. The Lb interface 3962 may be based on a network management protocol (e.g., TR069 protocol). The Lc interface 3950 may be an external interface that may be used for the content ingestion by the CDN control applications 3904 on the storage subsystem. The EIF interface 3958 may be an internal interface that may be used for the communication between the CE-GW 3924 and the edge server farm (ESF) 3922 within the small cell network (SCN) 3920. The EIF interface 3958 may be a proprietary interface. For each of the requests for the contents which may be locally cached, the CE-GW 3924 may terminate towards the edge server 3922 within the small cell network 3920, and the contents may be locally served by the edge server 3922.

CES 3942 may be an operator owned service. CES 3942 may be a service similar to those services offered within openAPI framework. CES 3942 may interact with one or more small cell networks, where one or more of the small cell networks may include a storage subsystem and/or others may not have storage. Storage within a small cell network 3920 may be shared by one or more CDN networks to deliver several contents to the users of the small cell network. The CES 3942 may refuse a request for a storage service within small cell networks, for example if the CES 3942 exceeds the available free amount of storage.

Managed caching may be used for edge caching with the MNO allowing the CDN to manage the local storage, such as content prepositioning, content placement, content replication, content deletion on the ESF, etc. An eCGW may implement the proxy functionality S1-MME stack support. The eCGW may act as a H(e)NB proxy towards the EPC and/or the EPC proxy towards the H(e)NBs. The eCGW may have the limited DNS server functionality to resolve the DNS queries for locally cached contents with the ESF IP addresses.

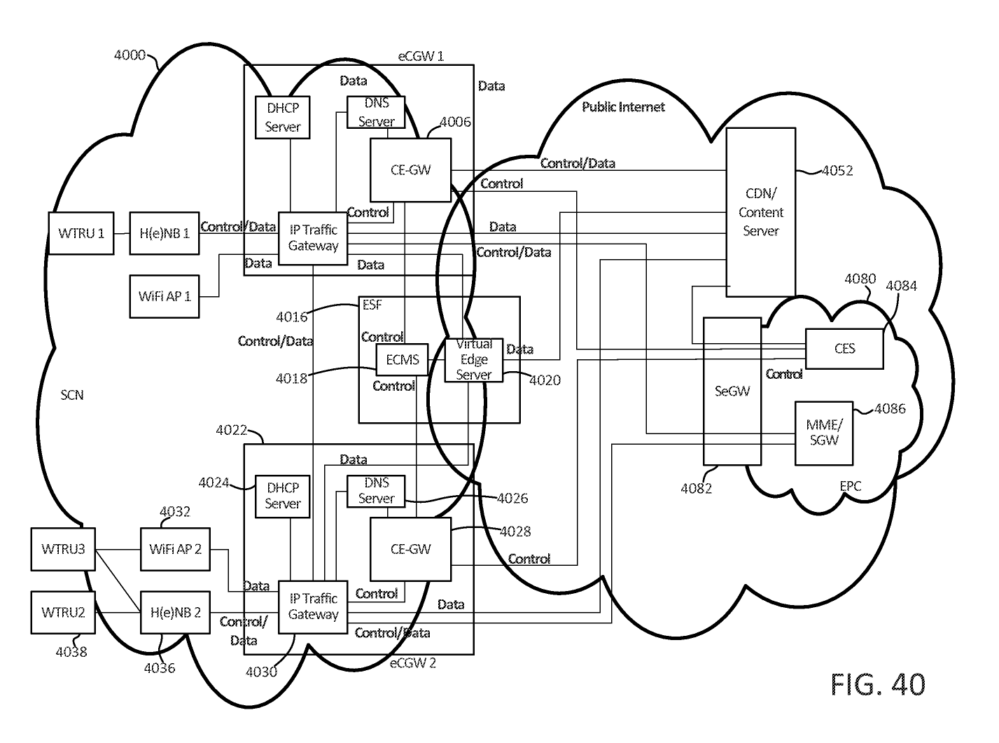

FIG. 40 illustrates an example of a functional architecture for the managed edge caching. The architecture in FIG. 40 illustrates one or more functional blocks. As illustrated in FIG. 40, a content enabled gateway (CE-GW) (e.g., CE-GW 4006 or CE-GW 4028) within a femtozone may facilitate storage allocation, deletion, etc. on behalf of CES 4084.

The managed caching system design may be centered on the converged gateway (CGW). The CGW may terminate the GTP tunnel that may be created between a WTRU (e.g., WTRU 4038) and an MCN for the traffic handling. The terminated GTP tunnel may enable the CGW to support NB-IFOM. The CGW may support the selective IP traffic offloading (SIPTO) functionality to offload the traffic directly to the public internet bypassing the core network.

FIG. 40 illustrates an example of an enhanced Converged Gateway (eCCGW) architecture. A CGW may support managed edge caching. As illustrated in FIG. 40, an eCGW (e.g., eCGW2 4022) may include IP traffic gateway 4030, content enablement gateway (CE-GW) 4028, DHCP server 4024, DNS server 4026, and/or edge server farm. The edge server farm may be a virtual edge server farm 4020. The eCCGW may be connected to one or more HeNB(s) (e.g., HeNB 2 4036), and/or one or more Wi-Fi AP(s) (e.g., WiFi AP 2 4032). The eCGW (e.g., eCGW2 4022) may be connected to the EPC 4080 and/or to one or more CDN/content servers (e.g., CDN content server 4052) in the public internet. The EPC 4080 may include SeGW 4082 and/or MME/SGW 4086.

The content enablement gateway (e.g., CE-GW 4028) may sit in the small cell network (e.g., SCN 4000). Content enablement gateway (e.g., CE-GW 4028) may facilitate service enablement and/or content ingestion. The Content enablement gateway (e.g., GE-GW 4028) may communicate with the CES 4084 over Lb interface. The content enablement gateway (e.g., CE-GW 4028) may interact with the ESF 4016 using an ETF interface.

Edge server farm (e.g., ESF 4016) may be the storage subsystem in the small cell network. ESF 4016 may include ESF Control and Management System (ECMS) 4018, virtual edge server 4020, etc. The edge server farm may provide the storage space to the CDN control applications to perform the managed edge caching. The edge server farm may include an amount of storage with multimedia streaming and logging services. The storage space and/or the data store services may be shared among one or more CDN applications. The ESF may support the functional decomposition of the total storage space into customized virtual edge servers (e.g., virtual edge server 4020).

CDN control applications may provide mechanism to distribute the popular multimedia contents in to several points of presence by creating the edge servers in the small cell networks and/or storing the copies of content to improve the quality of experience (QoE) to the end users. The CDN control applications (e.g., CDN/content server 4052) may have an interface towards the CES 4084 in the operator core network 4080. The CES 4084 may have a database that may include one or more SCNs and/or the respective storage subsystems, data store service capabilities information, etc. The CES 4084 may facilitate the SCN service enablement by routing the CES management messages from CDN control applications (e.g., CDN/content server 4052) towards the respective CE-GWs in the SCN.

Various examples are described herein that may be used to support managed edge caching, such as querying the SCN related information, virtual edge server service procedures, content management procedures, subscription and/or notification procedures, fetching the statistics information from SCN, etc. A query may be performed for the available SCN storage subsystems and/or the SCN storage subsystem capabilities. A virtual edge server may be created, deleted, and/or updated. A query may be performed for the status of a virtual edge server. Content management may be performed on the virtual edge server by CDN control application. Notification services may be subscribed for. The statistics information may be fetched from the SCN, for example by the CDN control application.

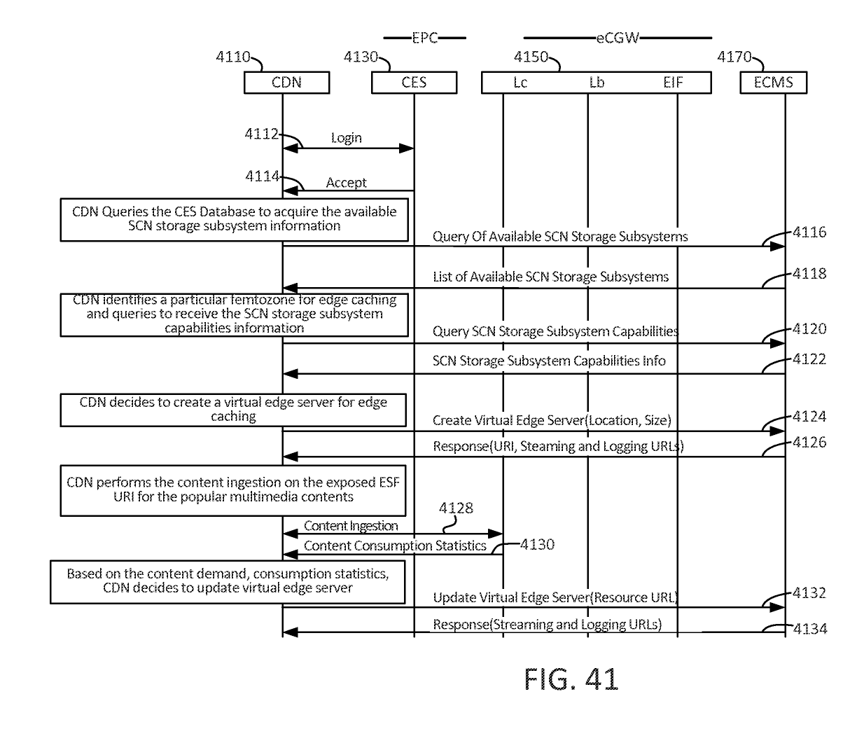

FIG. 41 is a diagram illustrating example procedures and/or messages that may be communicated between a CE-GW and an ESF. As illustrated in FIG. 41, at 4112 an EA (e.g., a CDN control application 4110) may login to centralized content controller (CCC) (e.g., CES 4130) or a CCC database using the La interface. At 4114 CDN 4110 may receive an accept message from CES 4130. At 4116, CDN 4110 may query the CDN database to acquire information about the available SCN storage subsystems. At 4118, CDN 4110 may receive a list of available SCN storage subsystems. CDN 4110 may identify one of the SCN storage subsystems or a femtozone for edge caching. At 4120, CDN 4110 may query the ECMS 4170 capabilities information of the identified SCN storage subsystem from CES database. At 4122, CDN 4110 may receive SCN storage subsystem capabilities information. For example, the SCN subsystem capabilities information may include information about storage system and available storage space. For example, the SCN subsystem capabilities information may include storage space, performance data, streaming capability like HTTP, RSTP, etc. CDN 4110 may decide to create a virtual edge server for edge caching. At 4124, the CDN may send a request to ECMS 4170 to create a virtual edges server. The request to create the edge server may include information, for example, location and/or size of the virtual server. At 4126, CDN 4110 may receive the content ingestion URI that may be used for content placement on the edge server over the Lc interface of the eCGW 4150. At 4128, CDN 4110 may perform the content ingestion on the exposed ESF URI for the popular multimedia contents. At 4130, CDN 4110 receive content consumption statistics. The content consumption statistics may include information for example, average number of sessions, average throughput, average failure rate, average central processing unit (CPU) utilization, etc.

CDN 4110 may update the virtual edge server, for example, based on one or more parameters, including content demand, consumption statistics, etc. At 4132, CDN 4110 may send an update message to the virtual edge server. At 4134, CDN 4110 may receive a response message to the update request. The response message may, for example, include streaming and logging URLs.

CPE WAN management protocol may be used for communication between the CE-GW 3924 and the CES 3920 over the Lb interface 3962, for example, as illustrated in FIG. 39. The CPE WAN management protocol may be defined in TR-069 of the broadband forum specifications, for example. The CPE WAN management protocol may be a bidirectional SOAP/HTTP-based protocol that may be used to communicate between customer-premises equipment (CPE) and Auto Configuration Servers (ACS). A client (e.g., TR-069 client) may reside in the CE-GW 3924 and/or a server (e.g., TR-069 server) may reside in the CES 3942.

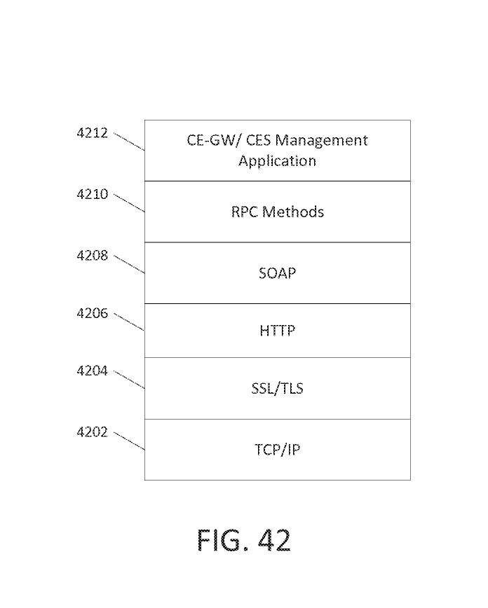

The protocol stack (e.g., for the CE-GW WAN management protocol) may include one or more components. FIG. 42 illustrates an example protocol stack for the CE-GW WAN management protocol. As illustrated in FIG. 42, the protocol stack may include a TCP/IP layer 4202, a secure socket layer/transport layer security (SSL/TLS) layer 4204, an HTTP layer 4206, a simple object access protocol (SOAP) layer 4208, a remote procedure call (RPC) functions layer 4210 (e.g., with one or more RPC methods), and a CE-GW/CES Management Application layer 4212. TABLE 1 illustrates an example of various protocol layers and an example description for each of the layers.

TABLE 1

| Layer | Description |
|---|---|
| CE-GW/CES Application | The application may use the CE-GW |
| | WAN management protocol on the CE- |
| | GW and/or the CES. The application |
| | may be locally defined. The application |
| | may be included as part of the CE-GW |
| | WAN management protocol. |
| RPC Functions | The RPC functions may be defined by the |
| | CE-GW WAN Management Protocol. |
| | These functions may be used for setting |
| | and/or retrieving the value of the device |
| | parameters. |
| SOAP | An XML-based syntax may be used to |
| | encode remote procedure calls (e.g., |
| | SOAP 1.1 and/or other versions of |
| | SOAP). Device parameters may be |
| | organized in data models that may be |
| | formatted into XML documents |
| HTTP | HTTP 1.1 and/or other versions of HTTP |
| | may be used. |
| SSL/TLS | The SSL/TLS may include the internet |
| | transport layer security protocols. The |
| | SSL may be the secure socket layer (e.g., |
| | SSL 3.0). The TLS may be a transport |
| | layer security (e.g., TLS 1.0). |
| TCP/IP | TCP/IP may include an internet protocol |
| | layer. TCP/IP may include a standard |
| | TCP/IP. |

TABLE 2 includes various RPC functions. The RPC functions may be supported to enable communication between the CE-GW and CES over the Lb interface.

TABLE 2

| RPC Function | Description |
|---|---|
| SetParameterNames | SetParameterNames may be used to set a list of supported |
| | parameter keys from the device. |
| GetParameterValues | GetParameterValues may be used to retrieve a current value of |
| | the parameters identified by keys. |
| SetParameterValues | SetParameterValues may be used to set the value of one or more |
| | parameters. |
| SetParameterAttributes | SetParameterAttributes may be used to set attributes of one or |
| | more parameters |
| GetParameterAttributes | GetParameterAttributes may be used to retrieve attributes of one |
| | or more parameters. |
| AddObject | AddObject may be used to create an instance of a multi-instance |
| | object, which may include a collection of parameters for |
| | example. |
| DeleteObject | DeleteObject may be used to remove an instance of an object. |
| Reboot | Reboot may be used to invoke reboot procedure on the device. |
| Download | Download may be used to order the CE-GW to download the file |
| | specified by URL, such as a firmware image, a configuration file, |
| | a ringer file, etc. |
| Upload | Upload may be used to order the CE-GW to upload specified file |
| | type to the specified destination. This could cover, for example, |
| | the current configuration file or log files |

Transaction session procedures are described herein. A transaction session may begin with an inform message, e.g., from the CE-GW (e.g., CE-GW 3942 as described in FIG. 39), which may be included in the initial HTTP post. This may serve to initiate the set of transactions and/or communicate the limitations of the CE-GW with regard to message encoding. The session may cease when the CES and/or the CE-GW having no more requests to send. The session may cease when no responses remain due from the CES and/or the CE-GW. At such time, the CE-GW may close the connection.

CE-GW operations are described herein. A CE-GW (e.g., CE-GW 742 as described in FIG. 7 or CE-GW 3942 as described in FIG. 39) may initiate a transaction session. For example, the transaction session may be initiated after the connection to the CES is successfully established. The CE-GW may initiate a session by sending an initial inform request to the CES. The inform request may indicate to the CES the current status of the CE-GW and/or that the CE-GW is ready to accept requests from the CES.

In the initial HTTP post carrying the inform request, an SOAP envelope may be allowed. The MaxEnvelopes argument in the inform response may indicate the maximum number of envelopes that may be carried by each subsequent HTTP post.

For incoming requests, such as on reception of SOAP requests from the CES for example, the CE-GW may respond to each request in the order they are received. Though the CE-GW may respond to each request in the order they are received, one or more responses may be sent in a single HTTP post (e.g., if the CES may accept more than one envelope), or distributed over multiple HTTP posts. To prevent deadlocks, the CE-GW may not hold off responding to a CES request to wait for a response from the CES to an earlier CE-GW request.

For outgoing requests, such as when the CE-GW has request messages to send (e.g., after the initial inform request), the CE-GW may send the messages in any order. The messages may be sent with respect to the responses being sent by the CE-GW to the CES. For example, the CE-GW may insert one or more requests at any point in the sequence of envelopes it transmits to the CES. There may be any number of requests that a CE-GW may send prior to receiving responses (e.g., the number of outstanding requests). A CE-GW may incorporate a locally specified limit.

If the CE-GW receives an envelope from the CES, such as a request or a response for example, with the HoldRequests header equal to true, the CE-GW may refrain from sending requests in subsequent HTTP posts. The CE-GW may restart sending envelopes, and/or may be limited to sending envelopes, when it receives an envelope with the HoldRequests header equal to false, or equivalently, no HoldRequests header. In determining whether it may send a request, the CE-GW may examine each envelope received through the end of the most recent HTTP response. The last envelope in an HTTP response may determine whether requests are allowed on the next HTTP post. If the CE-GW receives an empty HTTP response from the CES, this may be interpreted as HoldRequests equal false.

The CE-GW may send at least one request or response in any HTTP post sent to the CES, e.g., if there are one or more outstanding requests from the CES, or if the CE-GW has one or more outstanding requests and/or HoldRequests is false. An empty HTTP post may be sent if the CES does not have requests or responses outstanding.

Examples are described herein for session termination. The CE-GW may terminate the transaction session when one or more of the following conditions are met: the CES has no further requests to send the CE-GW, the CE-GW has no further requests to send to the CES, the CE-GW has received each outstanding response messages from the CES, and/or the CE-GW has sent each outstanding response messages to the CES resulting from prior requests. The CE-GW determines that the CES has no further requests to send the CE-GW if at least one of the following is true: the most recent HTTP response from the CES includes no envelopes, and/or the most recent envelope received from the CES includes a NoMoreRequests header that equals true. This header may be used by a CE-GW. The CE-GW may terminate a session if it has not received an HTTP response from a CES for a locally determined time period. In an example, the time period may be not less than 30 seconds. The CE-GW may continue the session, e.g., if the above conditions are not met.

The CE-GW may wait until after the session has cleanly terminated based on the above criteria before performing the reboot, e.g., if one or more messages exchanged during a session result in the CE-GW being reboot to complete the requested operation. If the session terminates unexpectedly, the CE-GW may attempt to establish another session. The session establishment procedure may be started from the beginning. The CE-GW may place locally specified limits on the number of times it attempts to re-establish a session.

Operations associated with a centralized content controller are described herein. For session initiation, a CES (e.g., CES 742 in FIG. 7 or CES 3942 in FIG. 39) may respond with an inform response, e.g., after receiving the initial inform request from the CE-GW. The CES may follow this with one or more requests that may be sent to the CE-GW. The MaxEnvelopes argument in the inform request may indicate the maximum number of envelopes that may be carried by each HTTP response that may be sent by the CES to the CE-GW. The initial HTTP response carrying the inform response may carry additional requests up to the total limit imposed by MaxEnvelopes, e.g., if the CE-GW may accept more than one envelopes.

Incoming requests are described herein. CES may respond to each request, e.g., on reception of SOAP requests from CE-GW. For example, the CES may respond to each request in the order it is received. One or more responses may be sent in a single HTTP response (e.g., if the CE-GW may accept more than one envelopes), or distributed over multiple HTTP responses. The CES may not hold off responding to a CE-GW request to wait for a response from the CE-GW to an earlier CES request, e.g., in order to prevent deadlocks. CES may set the HoldRequests header to true, e.g., when the CES decides to prevent the CE-GW from sending requests during some portion of the session. The HoldRequests header may be set to true in each envelope transmitted to the CE-GW, for example until the CES again decides to allow requests from the CE-GW. The CES may allow CE-GW requests before completion of a session. This may be done explicitly via the HoldRequests header or implicitly by sending an empty HTTP response.

Outgoing requests are described herein. CES may send request message in any order with respect to responses that may be sent by the CES to the CE-GW. For example, the CES may insert one or more requests at any point in the sequence of envelopes it transmits to the CE-GW (e.g., after the inform response). There may be any number of requests a CES may send prior to receiving responses (e.g., the number of outstanding requests). The CES may incorporate a locally specified limit. If the CES has one or more requests remaining to be sent and/or one or more responses outstanding from earlier requests from the CE-GW, the CES may send at least one request and/or response in any HTTP response sent back to the CE-GW. An empty HTTP response may be allowed if the CES has no more requests or responses outstanding.

Session termination is described herein. CE-GW may be responsible for connection initiation and/or teardown, e.g., since the CE-GW may be driving the HTTP connection to the CES. The CES may consider the session terminated when one or more of the following conditions are met: the CE-GW has no further requests to send to the CES, the CES does not have any further requests to send to the CE-GW, the CE-GW has sent each outstanding response messages to the CES resulting from prior requests, and/or the CES has received each outstanding response messages from the CE-GW. The CES may conclude sending requests to the CES if at least one of the following is true: the most recent HTTP post from the CE-GW contains no envelopes, and/or the most recent envelope received from the CE-GW includes a NoMoreRequests header equal to true. This header may be used by the CES. If one or more of the above criteria have not been met, and/or the CES has not received an HTTP post from a given CE-GW within a timeout (e.g., a locally defined timeout), it may consider the session terminated. For example, the timeout may not be less than 30 seconds. The CES may attempt to re-establish a session by performing a connection request.

The CES may maintain the latest information about the small cell networks and/or the available amount of storage for each location in a database. The interface may be used to open and/or close connections with one or more small cell networks to query about their latest status. Secured connections may be used as the transport protocol for the interface. Some other activities may occur. For example, the CES may query small cell networks about their physical location and/or network topology to organize a query response to CDNs. The network topology may be organized in a map or graph format. The CES may query the small cell network of the availability of an externally exposed ingestion URI to be used by requesting the CDN. This URI may be used by the operator's DNS to resolve to an IP address within the associated small cell network. The CES may negotiate the QoS/QoE parameters and/or the set of allowed data transport protocol with small cell networks. The CES may use this interface to enable a detailed logging service, which may be used by the charging function of the core network.

One or more interface procedures may be supported on the La interface. For example, a query of SCN storage subsystem capabilities may be performed, a virtual edge server may be created, deleted, and/or updated, the status of an edge server may be queried, and/or DataStore events may be subscribed to and/or unsubscribed to. The Lb interface functionality may be realized using the Customer premises equipment (CPE) Wide area network (WAN) Management Protocol (CWMP) protocol. The CWMP protocol may be described in the TR069 specifications. Bidirectional SOAP/HTTP based connections may be used. The Server (e.g., TR069 server) may be placed at a CES node and/or the CE-GW may act as the client (e.g., TR069 client). The SOAP/HTTP based connections may not be persistent and/or may be established before each of the Lb interface procedures. Described herein are the data model parameters used in the TR069 transaction procedures.

The SCN storage subsystem capabilities may be queried. The API may provide the ability for the CES to query the SCN storage subsystem capabilities. HTTP basic authentication, or other forms of authentication, may be performed between the client (e.g., TR069 client) at the CE-GW and the server (e.g., TR069 server) at the CES.

The query femtozone DataStore status may be accessed via the API (e.g., TR069 API) to query a zone for its status and/or other relevant information. The connection request may be initiated from the H(e)MS/ACS towards the IP traffic GW to initiate the connection. An inform RPC function may be used to inform the Global ID and/or the device state of the CE-GW. The CE-GW may send the inform request function towards the CES. The CES may respond with the inform response. The GetParameterValues RPC function may be used to retrieve the femtozone status information. The CES may send the GetParameterValues Request function towards the CE-GW. The CE-GW may respond with the GetParameterValues Response.

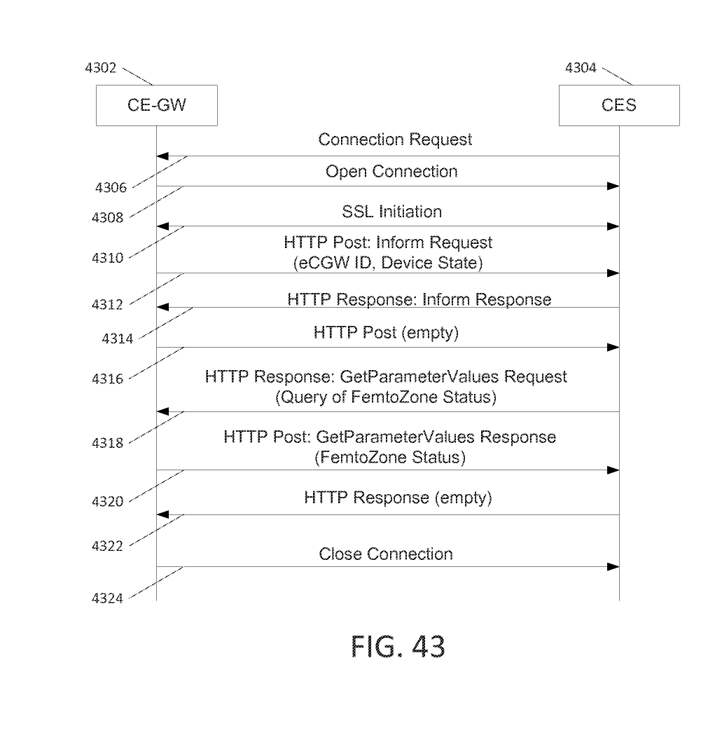

FIG. 43 is a diagram illustrating an example transaction procedure that may be performed to query for the SCN storage subsystem capabilities. A connection (e.g., an SSL connection) may be initiated between CE-GW 4302 and CES 4304, e.g., as illustrated in FIG. 43 at 4306, 4308, and/or 4310. At 4312, CE-GW 4302 may send an inform request to CES 4304. An example format for the inform request is provided below. The example format provided below is merely provided as an example, as various features may be included, excluded, or modified.

Inform Request

```
<soap:Body>
<cwmp:Inform>
<MaxEnvelopes>1</MaxEnvelopes>
<ParameterList soap-enc:arrayType=“cwmp:ParameterValueStruct[6]”>
        <ParameterValueStruct>
          <Name> InternetGatewayDevice.DeviceInfo. GlobalID
          </Name>
          <Value xsi:type=“xsd:string”>VendorID_SerialNumber
          </Value>
        </ParameterValueStruct>
        <ParameterValueStruct>
          <Name> InternetGatewayDevice.DeviceInfo.
          DeviceState</Name>
          <Value xsi:type=“xsd: unsignedInt”>0</Value>
        </ParameterValueStruct>
      </ParameterList>
    </cwmp:Inform>
  </soap:Body>
```

MaxEnvelopes in the inform request message may indicate to the CES 4304 the maximum number of SOAP envelopes that may be included in an HTTP response message. The device state may take the values 0(e.g., initialization), 1 (e.g., established).

At 4314, CE-GW 4302 may receive an inform response. An example format for the inform response is provided below. The example format provided below is merely provided as an example, as various features may be included, excluded, or modified.

Inform Response

```
<soapenv:Envelope xmlns:soap=“http://schemas.xmlsoap.org/soap/encoding/”
xmlns:xsd=“http://www.w3.org/2001/XMLSchema” xmlns:cwmp=“urn:dslforum-org:cwmp-1-
0” xmlns:soapenv=“http://schemas.xmlsoap.org/soap/envelope/”
xmlns:xsi=“http://www.w3.org/2001/XMLSchema-instance”>
  <soapenv:Header>
    <cwmp:ID soapenv:mustUnderstand=“1”>1 </cwmp:ID>
  </soapenv:Header>
  <soapenv:Body>
    <cwmp:InformResponse>
      <MaxEnvelopes>1</MaxEnvelopes>
    </cwmp:InformResponse>
  </soapenv:Body>
</soapenv:Envelope>
```

The cwmp:ID in the inform response message may be a unique session identifier for each of the SOAP transaction sessions. MaxEnvelopes in the inform response message may indicate to the CE-GW 4302 the maximum number of SOAP envelopes that may be included in HTTP Post message.

At 4316, CE-GW 4302 may send an empty HTTP post message to CES 4304. At 4318, CES 4304 may send GetParameterValues request to CE-GW 4302. An example format for the GetParameterValues request is provided below. The example format provided below is merely provided as an example, as various features may be included, excluded, or modified.

GetParameterValues Request

```
<soap:Body>
    <cwmp:GetParameterValues>
      <ParameterNames>InternetGatewayDevice.DeviceInfo.
      </ParameterNames>
    </cwmp:GetParameterValues>
  </soap:Body>
```

At 4320, CES 4304 may receive a GetParameterValues response from CE-GW 4302. An example format for the GetParameterValues response is provided below. The example format provided below is merely provided as an example, as various features may be included, excluded, or modified.

GetParameterValues Response

```
  <soap:Body>
      <cwmp:GetParameterValuesResponse>
        <ParameterList soap-enc:arrayType=“cwmp:ParameterValueStruct[1]”>
          <ParameterValueStruct>
              <Name> InternetGatewayDevice.DeviceInfo.FreeSpace</Name>
              <Value xsi:type=“xsd:string”>10 Gbyte</Value>
          </ParameterValueStruct>
          <ParameterValueStruct>
              <Name> InternetGatewayDevice.DeviceInfo.FemtoZoneInfo.NetworkStatus.
              AvgeBandwidth </Name>
              <Value xsi:type=“xsd:string”>1 Mbps</Value>
          </ParameterValueStruct>
        <ParameterValueStruct>
              <Name> InternetGatewayDevice.DeviceInfo.FemtoZoneInfo.NetworkStatus.
                AvgeLatency</Name>
              <Value xsi:type=“xsd:string”>100 msec</Value>
          </ParameterValueStruct>
        <ParameterValueStruct>
              <Name:> InternetGatewayDevice.DeviceInfo.FemtoZoneInfo.AreaLocation.
ZipCode
            </Name>
              <Value xsi:type=“xsd:unsignedInt”>10100</Value>
          </ParameterValueStruct>
        <ParameterValueStruct>
              <Name> InternetGatewayDevice.DeviceInfoSupportedStreamingCapabilities
</Name>
            <Value xsi:type=“xsd:string”> “rtmp”, “rtsp”, “mbms” , “dash”
          </Value>
          </ParameterValueStruct>
        <ParameterValueStruct>
              <Name> InternetGatewayDevice.DeviceInfo.LoggingCapable</Name>
              <Value xsi:type=“xsd:boolean”>1</Value>
          </ParameterValueStruct>
        <ParameterValueStruct>
              <Name> InternetGatewayDevice.DeviceInfo.NotificationCapable</Name>
              <Value xsi:type=“xsd:boolean”>1</Value>
          </ParameterValueStruct>
        </ParameterList>
      </cwmp:GetParameterValuesResponse>
    </soap:Body>
```

At 4322, CE-GW 4302 may receive an empty HTTP response. At 4324, CE-GW 4302 may close the connection between CE-GW 4302 and CES 4304.

Examples are described herein for creating a virtual edge server. An application may create a virtual edge server of a DataStore in a femtozone. Authentication may be performed. For example, HTTP basic authentication may be performed between a client (e.g., TR069 client) at CE-GW and a server (e.g., TR069 server) at CES.

The virtual edge server may be created and/or accessed via an API (e.g., TR069 API) to provide a data storage for the CDN applications. An inform RPC function may be used to inform the global ID and/or the device state of the CE-GW. The CE-GW may send the inform request feature towards the CES. The CES may respond with an inform response. AddObject may be used to create a virtual edge server. The CES may send the AddObject request function toward the CE-GW. The CE-GW may respond with the AddObject response. SetParameterValues may be used to populate the contents of the added data objects added. The CES may send the SetParameterValues request function toward the CE-GW. The CE-GW may respond with a SetParameterValues response. GetParameterValues may be used to retrieve the ingestion and/or streaming URL for the edge server. The CES may send the GetParameterValues request feature toward the CE-GW. The CE-GW may respond with the GetParameterValues response.

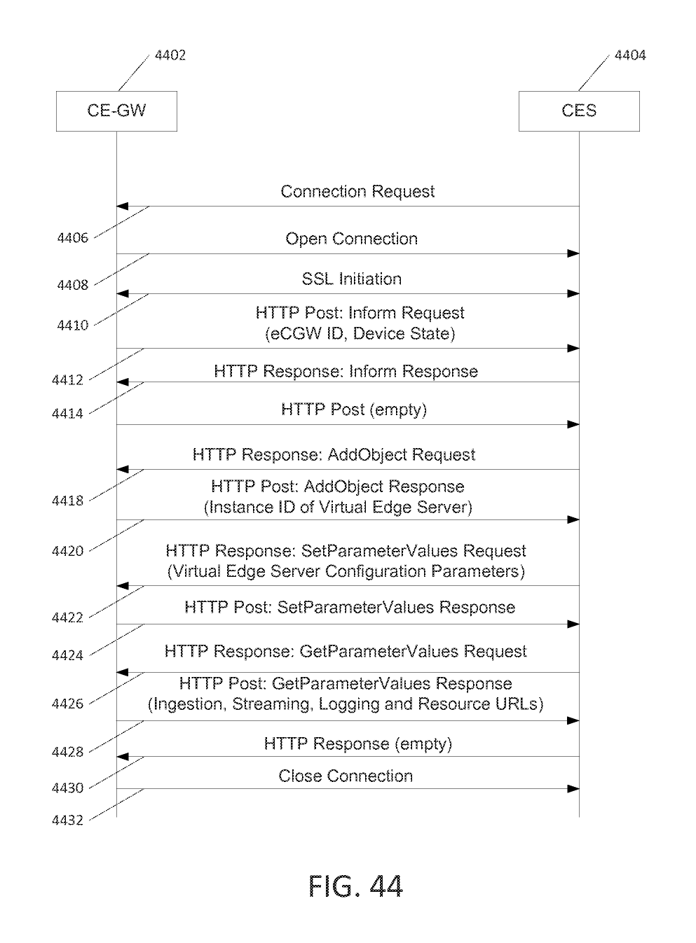

FIG. 44 is a diagram illustrating an example transaction procedure that may be performed to create a virtual edge server. A connection (e.g., an SSL connection) may be initiated between CE-GW 4402 and CES 4404, e.g., as illustrated in FIG. 44 at 4406, 4408, and/or 4410. At 4412, CE-GW 4402 may send an inform request to CES 4404. An example format for the inform request is provided below. The example format provided below is merely provided as an example, as various features may be included, excluded, or modified.

Inform Request

```
<soap:Body>
  <cwmp:Inform>
<MaxEnvelopes>1</MaxEnvelopes>
<ParameterList soap-enc:arrayType=“cwmp:ParameterValueStruct[6]”>
          <ParameterValueStruct>
            <Name> InternetGatewayDevice.DeviceInfo GlobalID
            </Name>
            <Value xsi:type=“xsd:string”>VendorID_SerialNumber
            </Value>
          </ParameterValueStruct>
          <ParameterValueStruct>
            <Name>InternetGatewayDevice.DeviceInfo.
            DeviceState</Name>
            <Value xsi:type=“xsd: unsignedInt”>0</Value>
          </ParameterValueStruct>
        </ParameterList>
      </cwmp:Inform->
    </soap:Body>
```

MaxEnvelopes in the inform request message may indicate to the CES 4404 the maximum number of SOAP envelopes that may be included in an HTTP response message. The device state may take the values 0(e.g., initialization), 1(e.g., established).

At 4414, CE-GW 4402 may receive an inform response message from CES 4404. An example format for the inform response is provided below. The example format provided below is merely provided as an example, as various features may be included, excluded, or modified.

Inform Response

```
<soapenv:Envelope xmlns:soap=“http://schemas.xmlsoap.org/soap/encoding/”
xmlns.xsd=“http://www.w3.org/2001/XMLSchema” xmlns.cwmp=“urn:dslforum-org:cwmp-1-
0” xmlns:soapenv=“http://schemas.xmlsoap.org/soap/envelope/”
xmlns:xsi=“http://www.w 3.org/2001/XMLSchema-instance”>
  <soapenv:Header>
    <cwmp:ID soapenv:mustUnderstand=“1”>1</cwmp:ID>
  </soapenv:Header>
  <soapenv:Body>
    <cwmp:InformResponse>
      <MaxEnvelopes>1</MaxEnvelopes>
    </cwmp:InformResponse>
  </soapenv:Body>
</soapenv:Envelope>
```

The cwmp:ID in the inform response message may be a unique session identifier for each of the SOAP transaction sessions. MaxEnvelopes in the inform response message may indicate to the CE-GW 4404 the maximum number of SOAP envelopes that may be included in HTTP post message.

At 4418, CES 4404 may send an AddObject request to CE-GW 4402. An example format for the AddObject request is provided below. The example format provided below is merely provided as an example, as various features may be included, excluded, or modified.

AddObject Request

<soapenv:Body>
<cwmp:AddObject>
<ObjectName> InternetGatewayDevice.DeviceInfo:StorageVolume
</ObjectName>
<ParameterKey>1</ParameterKey>
</cwmp:AddObject>
</soapenv:Body>

At 4420, CES 4404 may receive an AddObject response from CE-GW 4402. An example format for the AddObject response is provided below. The example format provided below is merely provided as an example, as various features may be included, excluded, or modified.

AddObject Response

<SOAP-ENV:Body SOAP-ENV:encodingStyle=“http://schemas.xmlsoap.org/soap/encoding/”>
<cwmp:AddObjectResponse>
<InstanceID>1</InstanceID>
<Status>0</Status>
</cwmp:AddObjectResponse>
</SOAP-ENV:Body>

The instance that may be returned as part of AddObject response may be used to uniquely identify the virtual edge server (e.g., logical storage volume) for the later transactions (e.g., TR069 transactions)

At 4422, CES 4404 may send a SetParameterValues request to CE-GW 4402. An example format for the SetParameterValues request is provided below. The example format provided below is merely provided as an example, as various features may be included, excluded, or modified.

SetParameterValues Request

```
<soap:Body>
    <cwmp:SetParameter Values>
        <ParameterList soap-enc:arrayType=“cwmp:ParameterValueStruct[1]”>
          <ParameterValueStruct>
              <Name> InternetGatewayDevice.DeviceInfo.FemtoZoneInfo.FemtoZoneID</Name>
              <Value xsi:type=“xsd:string”>zoneABC </Value>
          </ParameterValueStruct>
        <ParameterValueStruct>
              <Name>InternetGatewayDevice.DeviceInfo.StorageVolume.1.RequiredSpace </Name>
              <Value xsi:type=“xsd:string”>1 Gbyte </Value>
          </ParameterValueStruct>
      <ParameterValueStruct>
              <Name>InternetGatewayDevice.DeviceInfo.StorageVolume.1.StreamingCapabilites.
            RTSPStreamingEnable </Name>
              <Value xsi:type=“xsd:boolean”>1 </Value>
          </ParameterValueStruct>
      <ParameterValueStruct>
              <Name> InternetGatewayDevice.DeviceInfo.StorageVolume.1.StreamingCapabilites.
            HTTPDynamicStreamingEnable </Name>
              <Value xsi:type=“xsd:boolean”>1 </Value>
          </ParameterValueStruct>
        <ParameterValueStruct>
        <Name> InternetGatewayDevice.DeviceInfo.StorageVolume.1.LoggingCapabilities
</Name>
              <Value xsi:type=“xsd:boolean”>1 </Value>
          </ParameterValueStruct>
        </ParameterList>
    </cwmp:SetParameterValuesResponse>
  </soap:Body>
                The client correlator may be used as the cwmp:ID for the transactions (e.g.,
TR069 transactions).
```

At 4424, CES 4404 may receive a SetParameterValues response from CE-GW 4402. An example format for the SetParameterValues response is provided below. The example format provided below is merely provided as an example, as various features may be included, excluded, or modified.

SetParameterValues Response

```
<soap:Body>
    <cwmp:SetParameterValuesResponse>
      <Status>0</Status>
</cwmp:SetParameterValuesResponse>
  </soap:Body>
```

Status in the SetParameterValues Response message may take values 0 (e.g., success), 1 (e.g., failure—internal server error), 2 (e.g., failure—invalid), etc.

At 4426, CES 4404 may send a GetParameterValues request to CE-GW 4402. An example format for the GetParameterValues request is provided below. The example format provided below is merely provided as an example, as various features may be included, excluded, or modified.

```
GetParameterValues Request
  <soap:Body>
      <cwmp:GetParameterValues>
          <ParameterNames> InternetGatewayDevice.DeviceInfo.StorageVolume.1.
        </ParameterNames>
      </cwmp:GetParameterValues>
    </soap:Body>
```

At 4428, CES 4404 may receive a GetParameterValues response from CE-GW 4402. An example format for the GetParameterValues response is provided below. The example format provided below is merely provided as an example, as various features may be included, excluded, or modified.

```
GetParameterValues Response
<soap:Body>
  <cwmp:GetParameterValuesResponse>
    <ParameterList soap-enc:arrayType=“cwmp:ParameterValue Struct[1]”>
      <ParameterValueStruct>
        <Name> InternetGatewayDevice.DeviceInfo.StorageVolume.1.IngestionURL </Name>
        <Value xsi:type=“xsd:string”>
                      ftp:/ /yumscoffee.example.com/ dataStore/ 12345/ < / Value>
                  </ParameterValueStruct>
                  <ParameterValueStruct>
                      <Name> InternetGatewayDevice.DeviceInfo.StorageVolume.1.StreamingURLs[1]
                    </Name>
                  <Value xsi:type=“xsd:string”>
                      “rtsp”:“rtsp:/ / yumscoffee.example.com/ dataStore/ 12345/”</ Value>
              </ParameterValueStruct>
                      <Name> InternetGatewayDevice.DeviceInfo.StorageVolume.1.StreamingURLs[2]
          </ Name>
                  <Value xsi:type=“xsd:string”>
                      “dash”:“http:/ / yumscoffee.example.com/ dataStore/ 12345/ dash” < / Value>
              </ParameterValueStruct>
              <ParameterValueStruct>
                      <Name> InternetGatewayDevice.DeviceInfoStorageVolume.1.LoggingURLs[1]
                                                </ Name>
                      <Value xsi:type=“xsd:string”>
                  “https”:/ / yumscoffee.example.com/ dataStore/ 12345/ logging”</ Value>
                  </ ParameterValueStruct>
                      <Name>
InternetGatewayDevice.DeviceInfoStorageVolume.1.ResourceURL</Name>
                      <Value xsi:type=“xsd:string”>
                    “http:/ / example.com/ v1 / CES/ dataStore/ yumscoffee/ 12345”</ Value>
                  </ParameterValueStruct>
                </ ParameterList>
            </cwmp:GetParameterValuesResponse>
          </soap:Body>
```

At 4430, CE-GW 4402 may receive an empty HTTP response from CES 4404. At 4432, CE-GW 4402 may close the connection between CE-GW 4402 and CES 4404.

Examples are provided herein for deleting the virtual edge server. The virtual edge server may be deleted using an API. The API may provide the ability for CES or any other applications to delete a virtual edge server in the femtozone.

Authentication may be performed. HTTP basic authentication may be performed between the client (e.g., TR069 client) at the CE-GW and the server (e.g., TR069 server) at the CES,

Delete virtual edge server may be accessed via the API (e.g., TR069 API) to delete a virtual edge server in the femtozone. The connection request may be initiated from the H(e)MS/ACS towards the IP traffic GW to initiate the connection. The inform RPC function may be used to inform the global ID and/or the device state of the CE-GW. The CE-GW may send the inform request function toward the CES. The CES may respond with the inform response. The DeleteObject RPC function may be used to delete the virtual edge server. The CES may sends the DeleteObject request function toward the CE-GW. The CE-GW may respond with the DeleteObject response.

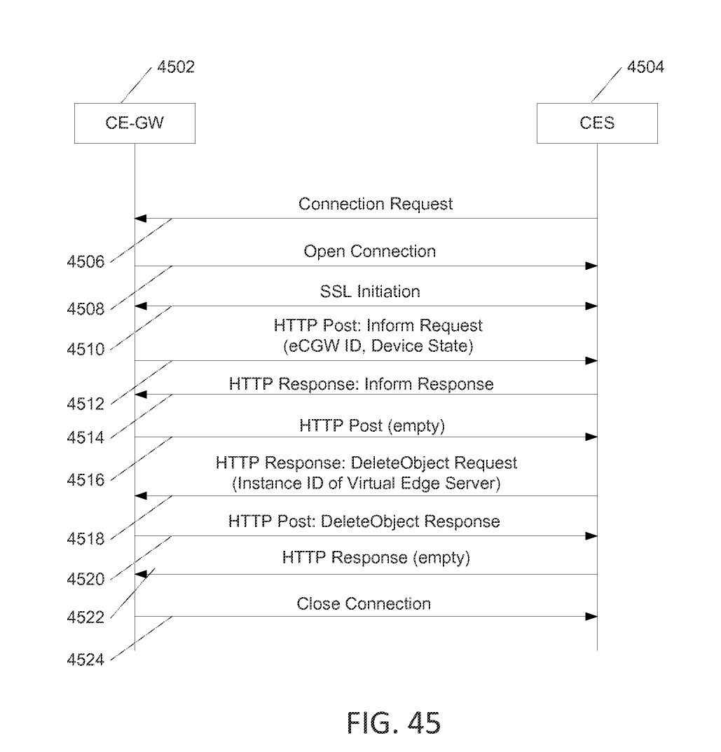

FIG. 45 is a diagram illustrating an example transaction procedure that may be performed to delete the virtual edge server. A connection (e.g., an SSL connection) may be initiated between CE-GW 4502 and CES 4504, e.g., as illustrated in FIG. 45 at 4506, 4508, and/or 4510. At 4512, CE-GW 4502 may send an inform request to CES 4504. An example format for the inform request is provided below. The example format provided below is merely provided as an example, as various features may be included, excluded, or modified.

```
Inform Request
<soap:Body>
<cwmp:Inform>
<MaxEnvelopes>1</MaxEnvelopes>
<ParameterList soap-enc:arrayType=“cwmp:ParameterValueStruct[6]“>
        <ParameterValueStruct>
          <Name> InternetGatewayDevice.DeviceInfo. GlobalID </Name>
          <Value xsi:type=“xsd:string”>VendorID_SerialNumber </Value>
        </ParameterValueStruct>
        <ParameterValueStruct>
          <Name> InternetGatewayDevice.DeviceInfo. DeviceState</Name>
          <Value xsi:type=“xsd: unsignedInt”>0</Value>
        </ParameterValueStruct>
      </ParameterList>
    </cwmp:Inform>
  </soap:Body>
```

MaxEnvelopes in the inform request message may indicates to the CES 4504 the maximum number of SOAP envelopes that may be included in an HTTP response message. The device state may take the values, e.g., 0 (e.g., initialization), 1 (e.g., established), etc.

At 4514, CE-GW may receive an Inform response. An example format for the inform response is provided below. The example format provided below is merely provided as an example, as various features may be included, excluded, or modified.

```
Inform Response
<soapenv:Envelope xmlns:soap=“http://schemas.xmlsoap.org/soap/encoding/”
xmlns:xsd=“http://www.w3.org/2001/XMLSchema” xmlns:cwmp=“urn:dslforum-org:cwmp-1-
0” xmlns:soapenv=“http://schemas.xmlsoap.org/soap/envelope/”
xmlns:xsi=“http://www.w3.org/2001/XMLSchema-instance”>
  <soapenv:Header>
    <cwmp:ID soapenv:mustUnderstand=“1”>1</cwmp:ID>
  </soapenv:Header>
  <soapenv:Body>
    <cwmp:InformResponse>
      <MaxEnvelopes>1</MaxEnvelopes>
    </cwmp:InformResponse>
  </soapenv:Body>
</soapenv:Envelope>
```

The cwmp:ID in the inform response message may be a unique session identifier for each of the SOAP transaction sessions. MaxEnvelopes in the inform response message may indicate to the CE-GW 4502 the maximum number of SOAP envelopes that may be included in an HTTP post message.

At 4516, CE-GW 4502 may send an empty HTTP post message to CES 4504. At 4518, CES 4504 may send DeleteObject request to CE-GW 4502. An example format for the DeleteObject request is provided below. The example format provided below is merely provided as an example, as various features may be included, excluded, or modified.

DeleteObject Request
<soapenv:Body>
<cwmp:DeleteObject>
<ObjectName> InternetGatewayDevice.DeviceInfo.StorageVolume.1</ObjectName>
<ParameterKey>1</ParameterKey>
</cwmp:DeleteObject>
</soapenv:Body>

An instance ID may be used to uniquely identify the virtual edge server instance at the CE-GW 4502. The instance ID may be the instance ID received as a part of AddObjectResopnse and may be used as part of InternetGatewayDevice.DeviceInfo.StorageVolume.1 in the DeleteObject request.

At 4520, CES 4504 may receive a DeleteObject response from CE-GW 4502. An example format for the DeleteObject response is provided below. The example format provided below is merely provided as an example, as various features may be included, excluded, or modified.

DeleteObiect Response
<SOAP-ENV:Body SOAP-ENV:encodingStyle=“http://schemas.xmlsoap.org/soap/encoding>
<cwmp:DeleteObjectResponse>
<Status>0</Status>
</cwmp:DeleteObjectResponse>
</SOAR-ENV:Body>

Status in the DeleteObject Response message may take values 0 (e.g., success), 1(e.g., failure—internal server error), 2(e.g., failure—invalid), etc. At 4522, CE-GW 4502 may receive an empty HTTP response. At 4524, CE-GW 4502 may close the connection between CE-GW 4502 and CES 4504.

Examples are described herein for updating a virtual edge server. The virtual edge serve may be updated using an API. The API may provide the ability for a CES or any other applications to update a virtual edge server in the femtozone.

Authentication may be performed. For example, HTTP basic authentication may be performed between a client (e.g., TR069 client) at a CE-GW and a server (e.g., TR069 server) at a CES.

The update virtual edge server may be accessed via the API (e.g., TR069 API) to update a virtual edge server in the femtozone. The connection request may be initiated from the H(e)MS/ACS toward the IP traffic GW to initiate the connection. The inform RPC function may be used to inform the global ID and/or the device state of the CE-GW. The CE-GW may send the inform request function toward the CES. The CES may respond with the inform response. The SetParameterValues RPC function may be used to update the virtual edge server configuration. The CES may send the SetParameterValues request function toward the CE-GW. The CE-GW may respond with the SetParameterValues response. The GetParameterValues RPC function may be used to retrieve a resource URL of the virtual edge server. The CES may send the GetParameterValues request function toward the CE-GW. The CE-GW may respond with the GetParameterValues response.

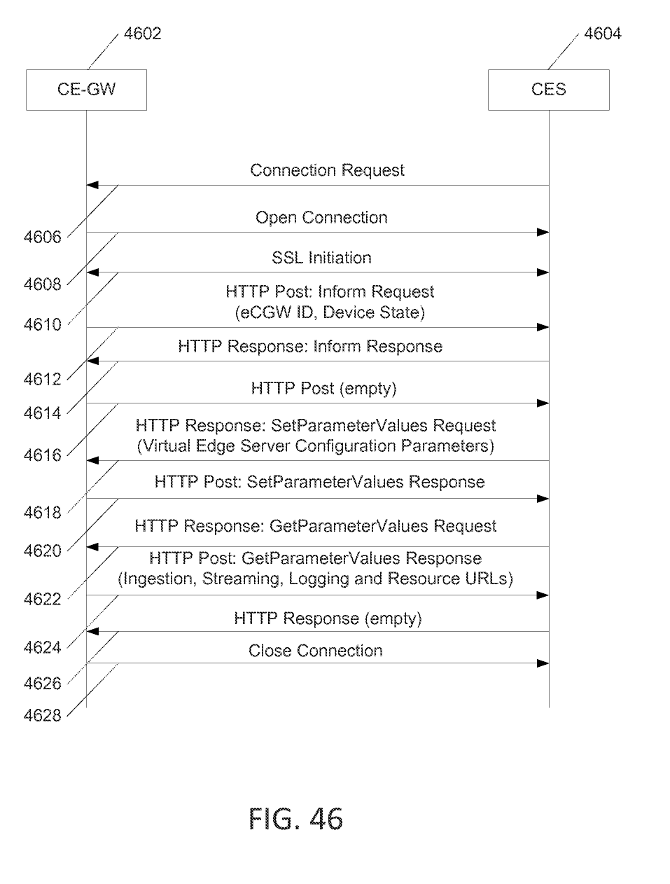

FIG. 46 is a diagram illustrating an example transaction procedure that may be performed to update the virtual edge server. An example format for the inform request is provided below. A connection (e.g., an SSL connection) may be initiated between CE-GW 4602 and CES 4604, e.g., as illustrated in FIG. 46 at 4606, 4608, and or 4610. At 4612, CE-GW 4602 may send an inform request to CES 4604. The example format provided below is merely provided as an example, as various features may be included, excluded, or modified.

```
Inform Request
<soap:Body>
<cwmp:Inform>
<MaxEnvelopes>1</MaxEnvelopes>
<ParameterList soap-enc:arrayType=“cwmp:ParameterValueStruct[6]”>
        <ParameterValueStruct>
          <Name> InternetGatewayDevice.DeviceInfo. GlobalID </Name>
          <Value xsi:type=“xsd:string”>VendorID_SerialNumber </Value>
        </ParameterValueStruct>
        <ParameterValueStruct>
          <Name> InternetGatewayDevice.DeviceInfo. DeviceState</Name>
          <Value xsi:type=“xsd: unsignedInt”>0</Value>
        </ParameterValueStruct>
      </ParameterList>
    </cwmp:Inform>
  </soap:Body>
```

MaxEnvelopes in the Inform Request message may indicate to the CES 4604 the maximum number of SOAP envelopes that may be included in an HTTP response message. The device state may take the values 0 (e.g., initialization), 1 (e.g., established), etc.

At 4614, CE-GW 4602 may receive an inform response message from CES 4604, An example format for the inform response is provided below. The example format provided below is merely provided as an example, as various features may be included, excluded, or modified.

```
Inform Response
<soapenv:Envelope xmlns: soap=“http://schemas.xmlsoap.org/soap/encoding/”
xmlns:xsd=“http://www.w3.org/2001/XMLSchema” xmlns:cwmp=“urn:dslforum-org:cwmp-1-
0” xmlns.soapenv=“http://schemas.xmlsoap.org/soap/envelope/”
xmlns:xsi=“http://www.w3.org/2001/XMLSchema-instance”>
  <soapenv:Header>
    <cwmp:ID soapenv:mustUnderstand=“1”>1</cwmp:ID>
  </soapenv:Header>
  <soapenv:Body>
    <cwmp:Inform.Response>
      <MaxEnvelopes>1</MaxEnvelopes>
    </cwmp:InformResponse>
  </soapenv:Body>
</soapenv:Envelope>
```

The cwmp:ID in the inform response message may be a unique session identifier for each of the SOAP transaction sessions. MaxEnvelopes in the inform response message may indicate to the CE-GW the maximum number of SOAP envelopes that may be included in an HTTP Post message.

At 4616, CE-GW 4602 may send an empty HTTP post message to CES 4604. At 4618 CES 4604 may send SetParameterValues request to CE-GW 4602. The SetParameterValues request may include virtual edge server configuration parameters. An example format for the SetParameterValues request is provided below. The example format provided below is merely provided as an example, as various features may be included, excluded, or modified.

```
SetParameterValues Request
<soap:Body>
    <cwmp:SetParameterValues>
        <ParameterList soap-enc:arrayType=“cwmp:ParameterValueStruct[1]“>
          <ParameterValueStruct>
              <Name> InternetGatewayDevice.DeviceInfo.StorageVolume.1.ResourceURL</Name>
              <Value xsi:type=“xsd:string”>“http://example.com/v1/CES/dataStore/yumscoffee/12345”
            </Value>
          </ParameterValueStruct>
        <ParameterValueStruct>
              <Name> InternetGatewayDevice.DeviceInfo.StorageVolume.1.requiredSpace </Name>
              <Value xsi:type=“xsd:string”>1 Gbyte </Value>
        </ParameterValueStruct>
              <Name> InternetGateway-Device.DeviceInfo.StorageVolume.1.StreamingCapabilites.
            RTSPStreamingEnable <Name>
              <Value xsi:type=“xsd:boolean”>0 </Value>
          </ParameterValueStruct>
    <ParameterValueStruct>
              <Name> InternetGatewayDevice.DeviceInfo.StorageVolume.1.StreamingCapabilites.
            RTPStreamingEnable </Name>
              <Value xsi:type=“xsd:boolean”>1 </Value>
          </ParameterValueStruct>
          <ParameterValueStruct>
            <Name> InternetGatewayDevice.DeviceInfo.StorageVolume.1.LoggingCapabilities
</Name>
              <Value xsi:type=“xsd:boolean”>1</Value>
          </ParameterValueStruct>
            </ParameterList>
    </cwmp:SetParameterValuesResponse>
  </soap:Body>
```

At 4620, CES 4604 may receive a SetParameterValues response from CE-GW 4602. An example format for the SetParameterValues response is provided below. The example format provided below is merely provided as an example, as various features may be included, excluded, or modified.

```
SetParameterValues Response
<soap:Body>
    <cwmp:SetParameterValuesResponse>
      <Status>0</Status>
</cwmp:SetParameterValuesResponse>
  </soap:Body>
```

Status in the SetParameterValues response message may take values 0 (e.g., success), 1 (e.g., failure—internal server error), 2 (e.g., failure—invalid), etc.

At 4622, CES 4604 may send a GetParameterValues request to CE-GW 4602. An example format for the GetParameterValues request is provided below. The example format provided below is merely provided as an example, as various features may be included, excluded, or modified.

```
GetParameterValues Request
<soap:Body>
    <cwmp:GetParameterValues>
        <ParameterNames> InternetGatewayDevice.DeviceInfo.StorageVolume.1.
      </ParameterNames>
    </cwmp:GetParameterValues>
  </soap:Body>
```

At 4624, CES 4604 may receive a GetParameterValues response from CE-GW 4602. The GetParameterValues response may include an ingestion URL, a streaming URL, a logging URL, a resource URL, etc. An example format for the GetParameterValues response is provided below. The example format provided below is merely provided as an example, as various features may be included, excluded, or modified.

```
GetParameterValues Response
<soap:Body>
    <cwmp:GetParameterValuesResponse>
      <ParameterList soap-enc:arrayType=“cwmp:ParameterValueStruct[1]”>
          <ParameterValueStruct>
            <Name> InternetGatewayDevice.DeviceInfo.StorageVolume.1.IngestionURL </Name>
            <Value xsi:type=“xsd:string”>
            ftp://yumscoffee.example.com/dataStore/12345/</Value>
          </ParameterValueStruct>
          <ParameterValueStruct>
              <Name> InternetGatewayDevice.DeviceInfo.StorageVolume.1.StreamingURLs[1]
            </Name>
          <Value xsi:type=“xsd:sting”>
              “rtp”:“http://yumscoffee.example.com/dataStore/12345/rtp”</Value>
      </ParameterValueStruct>
              <Name> InternetGatewayDevice.DeviceInfo.StorageVolume.1.StreamingURLs[2]
  </Name>
          <Value xsi:type=“xsd:string”>
              “dash”:“http://yumscoffee.example.com/dataStore/12345/dash”</Value>
      </ParameterValueStruct>
      <ParameterValueStruct>
              <Name> InternetGatewayDevice.DeviceInfo.StorageVolume.1.LoggingURLs[1]
</Name>
              <Value xsi:type=“xsd:string”>
          “https://yumscoffee.example.com/dataStore/12345/logging”</Value>
          </ParameterValueStruct>
              <Name> InternetGatewayDevice.DeviceInfo.StorageVolume.1.ResourceURL </Name>
              <Value xsi:type=“xsd:string”>
            “http://example.com/v1/CES/dataStore/yumscoffee/12345” </Value>
          </ParameterValueStruct>
        </ParameterList>
    </cwmp:GetParameterValuesResponse>
  </soap:Body>
```

At 4626, CE-GW 4602 may receive an empty HTTP response from CES 4604. At 4628, CE-GW 4602 may close the connection between CE-GW 4602 and CES 4604.

Examples are described herein for querying the status of an edge server. The edge server may be queried using an API. The API may provide the ability for CES or any other applications to query the status of a virtual edge server. The virtual edge server may be in the femtozone.

Authentication may be performed. For example, HTTP basic authentication may be performed between a client (e.g., TR069 client) at the CE-GW and a server (e.g., TR069 server) at the CES.

The query status of the edge server may be accessed via an API (e.g., TR069 API) to query status of an edge server in the femtozone. The connection request may be initiated from the H(e)MS/ACS towards the IP traffic GW to initiate the connection. An inform RPC function may be used to inform the global ID and/or the device state of the CE-GW. The CE-GW may send the inform request function toward the CES. The CES may respond with the inform response. A GetParameterValues RPC function may be used to retrieve the status of the edge server. The CES may send the GetParameterValues request function toward the CE-GW. The CE-GW may respond with the GetParameterValues response.

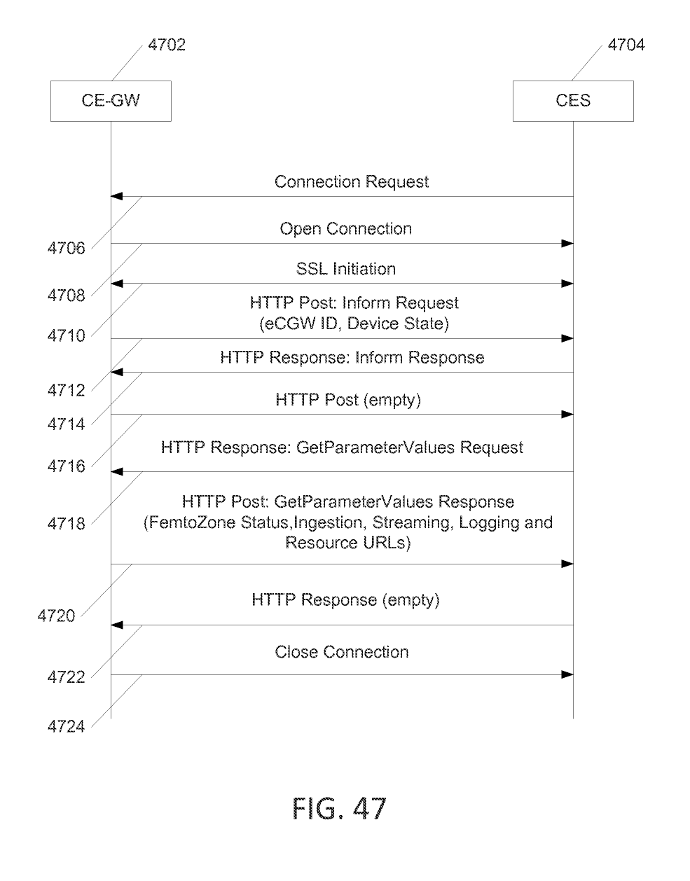

FIG. 47 is a diagram illustrating an example transaction procedure that may be performed to query the status of the virtual edge server. An example format for the inform request is provided below. A connection (e.g., an SSL connection) may be initiated between CE-GW 4702 and CES 4704, e.g., as illustrated in FIG. 47 at 4706, 4708, and/or 4710. At 4712, CE-GW 4702 may send an inform request to CES 4704. The example format provided below is merely provided as an example, as various features may be included, excluded, and/or modified.

```
Inform Request
<soap:Body>
  <cwmp:Inform>
<MaxEnvelopes>1</MaxEnvelopes>
<ParameterList soap-enc:arrayType=“cwmp:ParameterValueStruct[6]”>
          <ParameterValueStruct>
            <Name> InternetGatewayDevice.DeviceInfo. GlobalID </Name>
            <Value xsi:type=“xsd:string”>VendorID_SerialNumber </Value>
          </ParameterValueStruct>
          <ParameterValueStruct>
            <Name> InternetGatewayDevice.DeviceInfo. DeviceState</Name>
            <Value xsi:type=“xsd: unsignedInt”>0</Value>
          </ParameterValueStruct>
        </ParameterList>
      </cwmp:Inform>
    </soap:Body>
```

MaxEnvelopes in the inform request message may indicate to the CES 4704 the maximum number of SOAP envelopes that may be included in an HTTP response message. The device state may take the values 0 (e.g., initialization), 1 (e.g., established), etc.

At 4714, CE-GW 4702 may receive an inform response message from CES 4704. An example format for the inform response is provided below. The example format provided below is merely provided as an example, as various features may be included, excluded or modified.

```
Inform Response
<soapenv:Envelope xmlns:soap=“http://schemas.xmlsoap.org/soap/encoding/”
xmlns:xsd=“http://www.w3.org/2001/XMLSchema” xmlns:cwmp=“urn:dslforum-org:cwmp-1-
0” xmlns:soapenv=“http://schemas.xmlsoap.org/soap/envelope/”
xmlns.xsi=“http://www.w3.org/2001/XMLSchema-instance”>
  <soapenv:Header>
    <cwmp:ID soapenv:mustUnderstand=“1”>1</cwmp:ID>
  </soapenv:Header>
  <soapenv:Body>
    <cwmp:InformResponse>
      <MaxEnvelopes>1</MaxEnvelopes>
    </ewmp:InformResponse>
  </soapenv:Body>
</soapenv:Envelope>
```

The cwmp:ID in the inform response message may be a unique session identifier for each of the SOAP transaction sessions. MaxEnvelopes in the inform response message may indicate to the CE-GW 4702 the maximum number of SOAP envelopes that may be included in an HTTP Post message.

At 4716, CE-GW 4702 may send an empty HTTP post message to CES 4704. At 4718, CES 4704 may send GetParameterValues request to CE-GW 4702. An example format for the GetParameterValues request is provided below. The example format provided below is merely provided as an example, as various features may be included, excluded, or modified.

```
GetParameterValues Request
<soap:Body>
    <cwmp:GetParameterValues>
        <ParameterNames> InternetGatewayDevice.DeviceInfo.StorageVolume.1.
      </ParameterNames>
    </cwmp:GetParameterValues>
  </soap:Body>
```

The instance ID may be used to identify (e.g., uniquely identify) the instance of the virtual edge server at the CE-GW 4702. The instance ID may be the instance ID received as a part of AddObjectResopnse and may be used as part of InternetGatewayDevice.DeviceInfo.StorageVolume.1 in the GetParameterValues request. The Instance ID may be retrieved from a database.

At 4720, CES 4704 may receive a GetParameterValues response from CE-GW 4702. The GetParameterValues response may include parameters, for example, femtozone status, an ingestions URL, a streaming URL, a logging URL, a resource URL, etc. An example format for the GetParameterValues response is provided below. The example format provided below is merely provided as an example, as various features may be included, excluded, or modified.

GetParameter Values Response

```
<soap:Body>
  <cwmp:GetParameterValuesResponse>
    <ParameterList soap-enc:arrayType=“cwmp:ParameterValueStruct[1]”>
      <ParameterValueStruct>
        <Name> InternetGatewayDevice.DeviceInfo.FemtoZoneInfo.FemtoZoneID</Name>
        <Value xsi:type=“xsd:string”>zoneABC </Value>
      </ParameterValueStruct>
      <ParameterValueStruct>
        <Name> InternetGatewayDevice.DeviceInfo.StorageVolume.{i}.DataStoreStatus.
      timestampStart </Name>
      <Value xsi:type=“xsd:string”>
        “Thu 04, June 2012 02:51:59”</Value>
    </ParameterValueStruct>
  <ParameterValueStruct>
        <Name> InternetGatewayDevice.DeviceInfo.StorageVolume.{i}.DataStoreStatus,
      timestampEnd</Name>
      <Value xsi:type=“xsd:string”.>
        “Thu 04, June 2012 02:51:59”<Value>
    </ParameterValueStruct>
<ParameterValueStruct>
        <Name> InternetGatewayDevice.DeviceInfo.StorageVolume.{i}.DataStoreStatus
    .FailureRate</Name>
      <Value xsi:type=“xsd:string”>
        “3%”</Value>
  </ParameterValueStruct>
  <ParameterValueStruct>
        <Name> InternetGatewayDevice.DeviceInfo.StorageVolume.{i}.DataStoreStatus
  .Throughput</Name>
        <Value xsi:type=“xsd:string”>“100 Mbps”</Value>
      </ParameterValueStruct>
    <ParameterValueStruct>
        <Name> InternetGatewayDevice.DeviceInfo.FemtoZoneInfo.NetworkStatus.
        AvgeBandwidth </Name>
        <Value xsi:type=“xsd:string”> “0.95 Mbps”</Value>
      </ParameterValueStruct>
    <ParameterValueStruct>
        <Name> InternetGatewayDevice.DeviceInfo.FemtoZoneInfo.NetworkStatus.
      AvgeLatency</Name>
        <Value xsi:type=“xsd:string”> “150 msec”</Value>
      </ParameterValueStruct>
    <ParameterValueStruct>
        <Name> InternetGatewayDevice.DeviceInfo.FemtoZoneInfo.AreaLocation.
      ZipCode</Name>
        <Value xsi:type=“xsd:unsignedInt”> 10100</Value>
      </ParameterValueStruct>
    <ParameterValueStruct>
        <Name> InternetGateway.Device.DeviceInfo.FemtoZoneInfo.NetworkStatus,
      NumberOfUsers </Name>
        <Value xsi:type=“xsd:int”>54</Value>
      </ParameterValueStruct>
    <ParameterValueStruct>
        <Name> InternetGatewayDevice.DeviceInfo.FemtoZoneInfo.NetworkStatus.
    NumberOfActiveAccessPoints </Name>
        <Value xsi:type=“xsd:int”>12</Value>
      </ParameterValueStruct>
    <ParameterValueStruct>
        <Name> InternetGatewayDevice.DeviceInfo.FemtoZoneInfo.NetworkStatus.
      NumberOfUnserviceableAccessPoints </Name>
        <Value xsi:type=“xsd:string”> “zipcode:10100”</Value>
      </ParameterValueStruct>
    <ParameterValueStruct>
        <Name> InternetGatewayDevice.DeviceInfo.StorageVolume.1.IngestionURL </Name>
        <Value xsi:type=“xsd:string”>
        ftp ://yumscoffee.example.com/data Store/12345/</Value>
      </ParameterValueStruct>
      <ParameterValueStruct>
        <Name> InternetGatewayDevice.DeviceInfo.StorageVolume.l.StreamingURLs[1]
        </Name>
      <Value xsi:type=“xsd:string”>
        “rtp”:“http://yumscoffee.example.com/dataStore/12345/rtp”</Value>
    <ParameterValueStruct>
        <Name> InternetGatewayDevice.DeviceInfo.StorageVolume.1.StreamingURLs[2]
  </Name>
      <Value xsi:type=“xsd:string”>
        “dash”:“http://yumscoffee.example.com/dataStore/12345/dash” </Value>
    </ParameterValueStruct>
    <ParameterValueStruct>
        <Name> InternetGatewayDevice.DeviceInfo.StorageVolume.1.LoggingURLs[1]
</Name>
        <Value xsi:type=“xsd:string”>
      “https:yumscoffee.example.com/dataStore/12345/logging”</Value>
      </ParameterValueStruct>
        <Name> InternetGatewayDevice.DeviceInfo.Storage.Volume.l.ResourceURL</Name>
        <Value xsi:type=“xsd:string”>
      “http://example.com/v1/CES/dataStore/yumscoffee/12345”</Value>
      </ParameterValueStruct>
      <ParameterList>
    </cwmp:GetParameterValuesResponse>
  </soap:Body>
```

At 4722, CE-GW 4602 may receive an empty HTTP response from CES 4704. At 4724, CE-GW 4702 may close the connection between CE-GW 4702 and CES 4704.

Examples are described herein for subscribing to DataStore events. The subscription may be performed using an API. The API may provide the ability for CES to subscribe to events related to content enablement services within certain femtozones. Authentication may be performed. HTTP basic authentication may be performed between the client (e.g., TR069 client) at CE-GW and the server (e.g., TR069 server) at the CES.

Subscription to data store events may be accessed via the TR069. The TR069 may provide a CES with customized information related to a femtozone. The connection request may be initiated from the H(e)MS/ACS towards the IP traffic GW to initiate the connection. The inform RPC function may be used to inform the global ID and/or the device state of the CE-GW. The CE-GW may send the inform request function toward the CES. The CES may respond with the inform response. AddObject may be used to create a subscription. The CES may send the AddObject Request function toward the CE-GW. The CE-GW may respond with the AddObject response. The SetParameterValues RPC function may be used for populating the subscription details. The CES may send the SetParameterValues request function toward the CE-GW. The CE-GW may respond with the SetParameterValues response. The GetParameterValues RPC function may be used for retrieving the resourceURL from CE-GW. The CES may send the GctParameterValues request function toward the CE-GW. The CE-GW may respond with the GetParameterValues response.

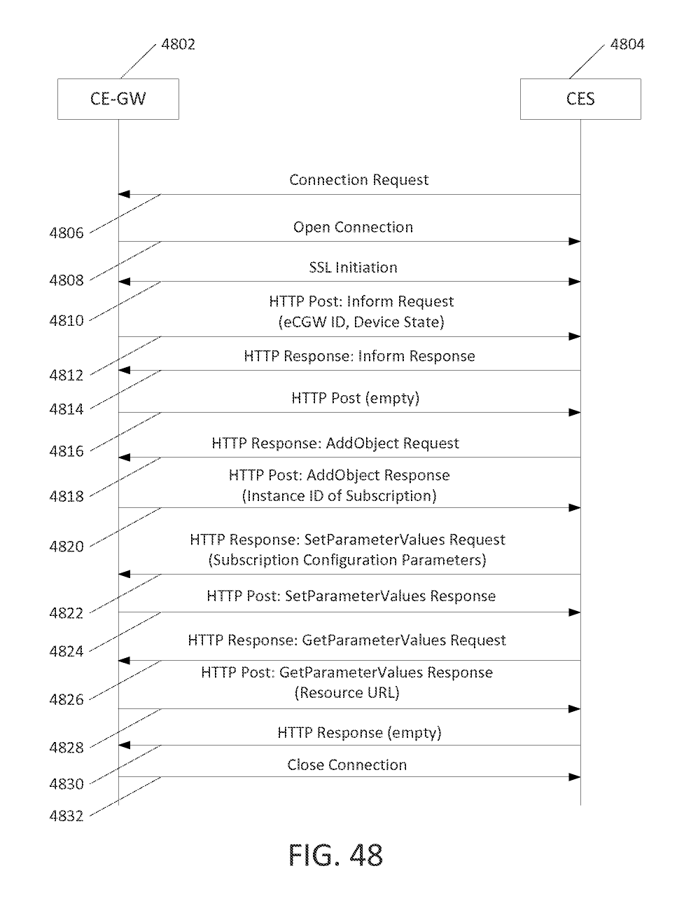

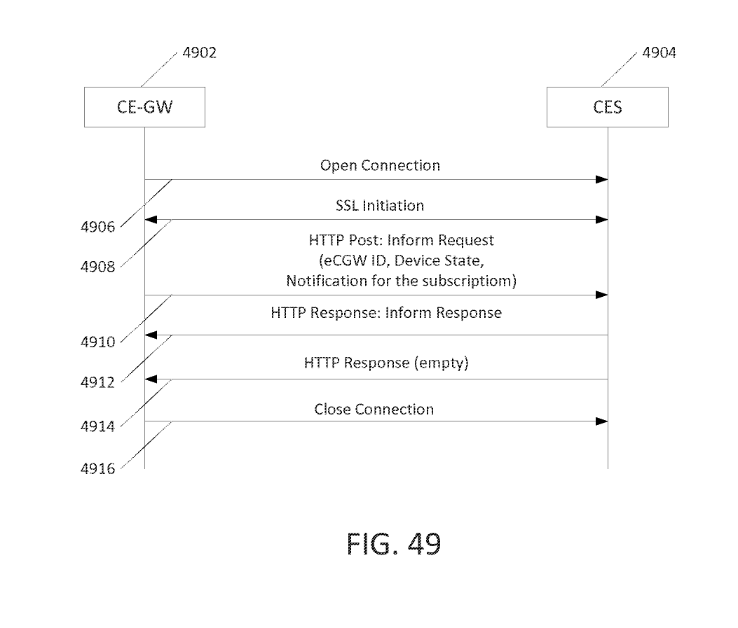

FIG. 48 is a diagram illustrating an example transaction procedure that may be performed to subscribe to DataStore events. FIG. 49 is a diagram of an example transaction procedure that may be performed as notification for the subscribed events. One or more inform RPC functions may be used for the notification of the DataStoreStatus, NetworkStatus, and/or femtozoneStatus. A CE-GW may send the inform request function to a CES. The CES may respond with an inform response.

As illustrated in FIG. 48, a connection (e.g., an SSL, connection) may be initiated between CE-GW 4802 and CES 4804, e.g., as illustrated in FIG. 48 at 4806, 4808, and/or 4810. At 4812, CE-GW 4802 may send an inform request to CES 4804. An example format for the inform request is provided below. The example format provided below is merely provided as an example, as various features may be included, excluded, or modified.

Inform Request

```
<soap:Body>
<cwmp:Inform>
<MaxEnvelopes>1</MaxEnvelopes>
<ParameterList soap-enc:arrayType=“cwmp:ParameterValueStruct[6]”>
      <ParameterValueStruct>
        <Name> InternetGatewayDevice.DeviceInfo. GlobalID </Name>
        <Value xsi:type=“xsd:string”>VendorID_SerialNumber </Value>
      </ParameterValueStruct>
      <ParameterValueStruct>
        <Name> InternetGatewayDevice.DeviceInfo. DeviceState
        </Name>
        <Value xsi:type=“xsd: unsignedInt”>0</Value>
        </ParameterValueStruct>
      </ParameterList>
    </cwmp:Inform>
  </soap:Body>
```

MaxEnvelopes in the inform resquest message may indicate to the CES 4804 the maximum number of SOAP envelopes that may be included in an HTTP response message. The device stale may take the values 0 (e.g., initialization), 1 (e.g., established), etc.

At 4814, CE-GW 4802 may receive an inform response message from CES 4804. An example format for the inform response is provided below. The example format provided below is merely provided as an example, as various features may be included, excluded, or modified.

Inform Response

```
<soapenv:Envelope xmlns:soap=“http://schemas.xmlsoap.org/soap/
encodine/”
xmlns:xsd=“http://www.w3.org/2001/XMLSchema” xmlns:cwmp=
“urn:dslforum-org:cwmp-1-0” xmlns:soapenv=“http://schemas.xmlsoap.org/
soap/envelope/”
xmlns:xsi=“http://www.3.org/2001/XMLSchema-instance”>
  <soapenv:Header>
    <cwmp:ID soapenv:mustUnderstand=“1”>1</cwmp:ID>
  </soapenv:Header>
  <soapenv:Body>
    <cwmp:InformResponse>
      <MaxEnvelopes>1</MaxEnvelopes>
    </cwmp:InformResponse>
  </soapenv:Body>
</soapenv:Envelope>
```

The cwmp:ID in the inform response message may be a unique session identifier for each of the SOAP transaction sessions. MaxEnvelopes in the inform response message may indicate to the CE-GW 4802 the maximum number of SOAP envelopes that may be included in an HTTP Post message.

At 4816, CE-GW 4802 may send an empty HTTP post message to CES 4804. At 4818, CES 4804 may send AddObject request to CE-GW 4802. An example format for the AddObject request is provided below. The example format provided below is merely provided as an example, as various features may be included, excluded, or modified.

AddObject Request

<soapenv:Body>
<cwmp:AddObject>
<ObjectName> InternetGatewayDevice.DeviceInfo .SubscriptionInfo
</ObjectName>
<ParameterKey>1<ParatneterKey>
</cwmp:AddObject>
</soapenv:Body>

At 4820, CES 4804 may receive an AddObject response from CE-GW 4802. An example format for the AddObject response is provided below. The example format provided below is merely provided as an example, as various features may be included, excluded, or modified.

AddObject Response

<SOAP-ENV:Body SOAP-ENV:encodingStyle=“http://schermas.xmlsoap.
org/soap/encoding/”>
<cwmp:AddObjectResponse>
<InstanceNumber>1</InstanceNumber>
<Status>0</Status>
</cwmp:AddObjectResponse>
</SOAP-ENV:Body>

The instance number the AddObject response message that may be returned as part of the AddObject response may be used to identify (e.g., uniquely identify) the subscription for an event for the later transactions (e.g., TR069 transactions)

At 4822, CES 4804 may send SetParameterValues request to CE-GW 4802. The SetParameterValues request may include a request to set subscription configuration parameters. An example format for the SetParameterValues request is provided below. The example format provided below is merely provided as an example, as various features may be included, excluded, or modified.

SetParameterValues Request

```
<soap:Body>
  <cwmp:SetParameterValues>
    <ParameterList soap-enc:arrayType=“cwmp:ParameterValueStruct[1]”>
      <ParameterValue Struct>
        <Name> InternetGatewayDevice.DeviceInfo .SubscriptionInfo.1.NotifyURL</Name>
        <Value xsi:type=“xsd:string”>“http://www.yoururl.here/notification/”</Value>
      </ParameterValueStruct>
    <ParameterValueStruct>
        <Name> InternetGatewayDevice.DeviceInfo .SubscriptionInfo.1.CallBackData</Name>
        <Value xsi:type=“xsd:string”>“Do Something” </Value>
      </ParameterValueStruct>
    <ParameterValueStruct>
        <Name> InternetGatewayDevice.DeviceInfo .SubscriptionInfo.1.NotificationFormat
</Name>
        <Value xsi:type=“xsd:string”>XML </Value>
      </ParameterValueStruct>
        </ParameterList>
  </cwmp:SetParameterValues>
</soap:Body>
```

At 4824, CES 4804 may receive a SetParameterValues response from CE-GW 4802. An example format for the SetParameterValues response is provided below. The example format provided below is merely provided as an example, as various features may be included, excluded, or modified.

SetParameterValues Response

```
<soap:Body>
    <cwmp:SetParameterValuesResponse>
      <Status>0</Status>
</cwmp:SetParameterValuesResponse>
  </soap:Body>
```

Status in the SetParameterValues response message may take values 0 (e.g., success), 1 (e.g., failure—internal server error), 2 (e.g., failure—invalid), etc.

At 4826, CES 4804 may send GetParameterValues request to CE-GW 4802. An example format for the GetParameterValues request is provided below. The example format provided below is merely provided as an example, as various features may be included, excluded, or modified.

GetParameterValues Request

```
<soap:Body>
  <cwmp:GetParameterValues>
    <ParameterNames> InternetGatewayDevice.DeviceInfo .Subscription
    Info.1.ResourceURL
    </ParameterNames>
  </cwmp:GetParameterValues>
</soap:Body>
```

At 4828, CES 4804 may receive a GetParameterValues response from CE-GW 4802. An example format for the GetParameterValues response is provided below. The GetParameterValues response may include a Resource URL. The example format provided below is merely provided as an example, as various features may be included, excluded, or modified.

GetParameterValues Response

```
<soap:Body>
  <cwmp:GetParameterValuesResponse>
    <ParameterList soap-enc:arrayType=“cwmp:ParameterValueStruct[1]”>
      <ParameterValueStruct>
        <Name> InternetGatewayDevice.DeviceInfo .SubscriptionInfo.1.
        ResourceURL </Name>
        <Value xsi:type=“xsd:string”>
      “http://example.com/v1/CES/subscriptions/yumscoffee/12345”
      </Value>
      </ParameterValueStruct>
```

At 4830, CE-GW 4802 may receive an empty HTTP response from CES 4804. At 4832, CE-GW 4802 may close the connection between CE-GW 4802 and CES 4804.

As illustrated in FIG. 49, a connection (e.g., an SSL connection) may be initiated between CE-GW 4902 and CES 4904, e.g., as illustrated in FIG. 49 at 4906, and/or 4908. At 4910, CE-GW 4902 may send an inform request to CES 4904. The inform request may include one or more parameters including, for example, Device State, Notification for the subscription, etc. An example format for the inform request is provided below. The example format provided below is merely provided as an example, as various features may be included, excluded, or modified.

Inform Request

```
<soap:Body>
  <cwmp:Inform>
    <ParameterList soap-enc:arrayType=“cwmp:ParameterValueStruct[6]”>
    <ParameterValueStruct>
      <Name> InternetGatewayDevice.DeviceInfo. GlobalID </Name>
      <Value xsi:type=“xsd:string”>VendorID_SerialNumber </Value>
    </ParameterValueStruct>
    <ParameterValueStruct>
      <Name> IntemetGatewayDevice.DeviceInfo. DeviceState</Name>
      <Value xsi:type=“xsd: unsignedInt”>0<Value>
    </ParameterValueStruct>
    <ParameterValueStruct>
      <Name> InternetGatewayDevice.DeviceInfo .SubscriptionInfo.1.CallbackData</Name>
      <Value xsi:Type=“xsd:string”/>“Do Something”<Vaule>
    </ParameterValueStruct>
    <ParameterValueStruct>
      <Name> InternetGatewayDevice.DeviceInfo .SubscriptionInfo.1.Timestamp</Name>
      <Value xsi:type=“xsd:string”>“2013-02-01T12:00:00”</Value>
    </ParameterValueStruct>
  <ParameterValueStruct>
      <Name> InternetGatewayDevice.DeviceInfo.FemtoZoneInfo.FemtoZoneID</Name>
      <Value xsi:type=“xsd:string”>zoneABC </Value>
    </ParameterValueStruct>
    <ParameterValueStruct>
      <Name> InternetGatewayDevice.DeviceInfo.StorageVolume.{i}.DataStoreStatus
.FailureRate</Name>
    <Value xsi:type=“xsd:string”>
      “3%”</Value>
    </ParameterValueStruct>
    <ParameterValueStruct>
      <Name> InternetGatewayDevice.DeviceInfo.StorageVolume.{i}.DataStoreStatus
.Throughput</Name>
      <Value xsi:type=“xsd:string”>“100 Mbps”</Value>
    </ParameterValueStruct>
  <ParameterValueStruct>
      <Name> InternetGatewayDevice.DeviceInfo.FemtoZoneInfo.NetworkStatus.
      AvgeBandwidth </Name>
      <Value xsi:type=“xsd:string”>“0.95 Mbps”</Value>
    </ParameterValueStruct>
  <ParameterValueStruct>
      <Name> InternetGatewayDevice.DeviceInfo.FemtoZoneInfo.NetworkStatus.
    AvgeLatency</Name>
      <Value xsi:type=“xsd:string”>“150 msec”</Value>
    </ParameterValueStruct>
  <ParameterValueStruct>
      <Name> InternetGatewayDevice.DeviceInfo.FemtoZoneInfo.AreaLocation.
  ZipCode</Name>
      <Value xsi:type=“xsd:unsignedInt”> 10100</Value>
    </ParameterValueStruct>
  <ParameterValueStruct>
      <Name> InternetGatewayDevice.DeviceInfo.FemtoZoneInfo.NetworkStatus,
  NumberOfUsers </Name>
      <Value xsi:type=”xsd:int”>54</Value>
    </ParameterValueStruct>
  <ParameterValueStruct>
      <Name> InternetGatewayDevice.DeviceInfo.FemtoZoneInfo.NetworkStatus.
  NumberOfActiveAccessPoints </Name>
      <Value xsi:type=“xsd:int”>12</Value>
    </ParameterValueStruct:>
  <ParameterValueStruct>
      <Name> InternetGatewayDevice.DeviceInfo.FemtoZoneInfo.NetworkStatus.
      NumberOfUnserviceableAccessPoints </Name>
        <Value xsi:type=“xsd:unsignedInt”>10100</Value>
      </ParameterValueStruct>
    </ParameterList>
  </cwmp:Inform>
</soap:Body>
```

At 4912, CE-GW 4802 may receive an inform response message from CES 4904. An example format for the inform response is provided below. The example format provided below is merely provided as an example, as various features may be included, excluded, or modified.

Inform Response

```
<soapenv:Envelope xmlns:soap=“http://schemas.xmlsoap.org/soap/
encoding/”
xmlns:xsd=“http://www.w3.org/2001/XMLSchema” xmlns:cwmp=“urn:
dslforum-org:cwmp-1-0”xmlns.soapenv=“http://schemas.xmlsoap.org/soap/
envelope/”
xmlns:xsi=“http://www.w3.org/2001/XMLSchema-instance”>
  <soapenv:Header>
    <cwmp:ID soapenv:mustUnderstand=“1”</cwmp:ID)>
  </soapenv:Header>
  <soapenv:Body>
    <cwmp:InformResponse>
      <MaxEnvelopes>1</MaxEnvelopes>
    </cwmp:InformResponse>
  </soapenv:Body>
</soapenv:Envelope>
```

The cwmp:ID in the inform message may be a unique session identifier for each of the SOAP transaction sessions. MaxEnvelopes in the inform response message may indicate to the CE-GW 4902 the maximum number of SOAP envelopes that may be included in an HTTP Post message. At 4914, CE-GW 4902 may receive an empty HTTP response. At 4916, CE-GW 4902 may close the connection between CE-GW 4902 and CES 4904.

Examples are described herein for unsubscribing to DataStore events. The DataStore events may be unsubscribed to using an APT. The API may provide the ability for CES to unsubscribe to events related to content enablement services within femtozones.

Authentication may be performed. HTTP basic authentication may be performed between the client (e.g., TR069 client) at the CE-GW and the server (e.g., TR069 server) at CES. The unsubscription to data store events may be accessed via the TR069 to remove a previously assigned notification request. The connection request may be initiated from the H(e)MS/ACS towards the IP traffic GW to initiate the connection. The inform RPC function may be used to inform the global ID and/or the device state of the CE-GW. The CE-GW may send the inform request function toward the CES. The CES may respond with the inform response. The DeleteObject RPC function may be used to delete the subscription for an event. The CES may send the DeleteObject request function toward the CE-GW. The CE-GW may respond with the DeleteObject response.

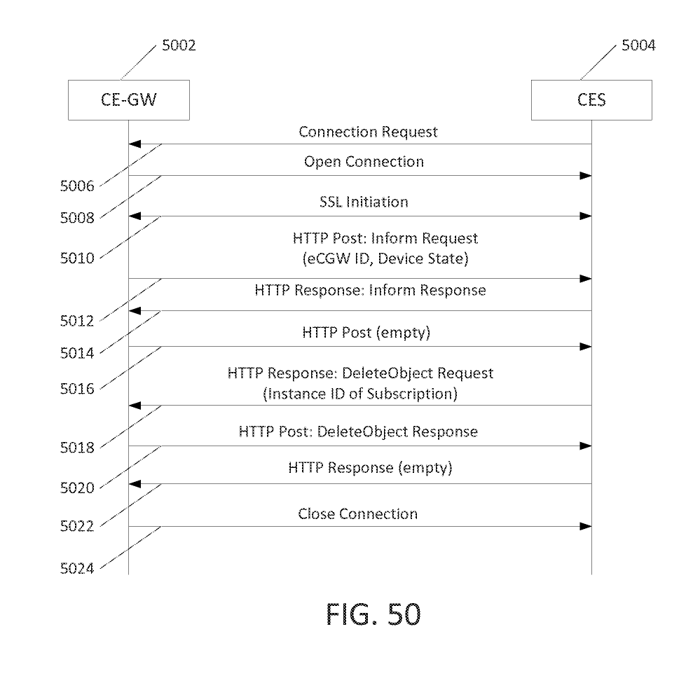

FIG. 50 is a diagram illustrating an example transaction procedure that may be performed to unsubscribe to DataStore events. As illustrated in FIG. 50, a connection (e.g., an SSL connection) may be initiated between CE-GW 5002 and CES 5004, e.g., as illustrated in FIG. 50 at 5006, 5008, and/or 5010. At 5012, CE-GW 5002 may send an inform request to CES 5004. An example format for the inform request is provided below. The example format provided below is merely provided as an example, as various features may be included, excluded, or modified.

Inform Request

```
<soap:Body>
<cwmp: Inform>
<MaxEnvelopes>1</MaxEnvelopes>
<ParameterList soap-enc:arrayType=“cwmp:ParameterValueStruct[6]”>
        <ParameterValueStruct>
          <Name> InternetGatewayDevice.DeviceInfo. GlobalID
          </Name>
          <Value xsi:type=“xsd:string”>VendorID_SerialNumber
          </Value>
        </ParameterValueStruct>
        <ParameterValueStruct>
          <Name> InternetGatewayDevice.DeviceInfo. DeviceState</
          Name>
          <Value xsi:type=“xsd: unsignedInt”>0</Value>
        </ParameterValueStruct>
      </ParameterList>
    </cwmp:Inform>
  </soap:Body>
```

MaxEnvelopes in the inform request message may indicate to the CES 5004 the maximum number of SOAP envelopes that may be included in an HTTP response message. The device state may take the values 0(e.g., initialization), 1(e.g., established).

At 5014, CE-GW 5002 may receive an inform response message from CES 5004. An example format for the inform response is provided below. The example format provided below is merely provided as an example, as various features may be included, excluded, or modified.

Inform Response

```
<soapenv:Envelope xmlns:soap=“http://schemas.xmlsoap.org/soap/
encoding/”
xmlns:xsd=“http://www.w3.org/2001/XMLSchema” xmlns:cwmp=
“urn: dslforum-org:cwmp-1-0” xmlns:soapenv=“http://schemas.xmlsoap.
org/soap/envelope/”
xmlns:xsi=“http://www.w3.org/2001/XMLSchema-instance”>
  <soapenv:Header>
    <cwmp:ID soapenv:mustUnderstand=“1”>1</cwmp:ID>
  </soapenv:Header>
  <soapenv:Body>
    <cwmp:Inform.Response>
      <MaxEnvelopes>1</MaxEnvelopes>
    </cwmp:InformResponse>
  </soapenv:Body>
</soapenv:Envelope>
```

The cwmp:ID in the inform response message may be a unique session identifier for each of the SOAP transaction sessions. MaxEnvelopes in the inform response message may indicate to the CE-GW 5002 the maximum number of SOAP envelopes that may be included in an HTTP post message.

At 5016, CE-GW 5002 may send an empty HTTP post message to CES 5004. At 5018 CES 5004 may send DeleteObject request to CE-GW 5002. An example format for the DeleteObject request is provided below. The example format provided below is merely provided as an example, as various features may be included, excluded, or modified.

DeleteObject Request

<soapenv:Body>
<cwmp:DeleteObject>
<ObjectName> IntemetGatewayDevice.DeviceInfo .SubscriptionInfo.1
</ObjectName>
<ParameterKey>1</ParameterKey>
</cwmp:DeleteObject>
</soapenv:Body>

The instance ID may be used to identify (e.g., uniquely identify) the instance of the virtual edge server at the CE-GW 5002. The instance ID may be the instance ID received as a part of AddObjectResopnse and may be used as part of InternetGatewayDevice.DeviceInfo.StorageVolume.1 in the DeleteObject request. The Instance ID may be retrieved from a database.

At 5020, CES 5004 may receive a DeleteObject response from CE-GW 5002. An example format for the DeleteObject response is provided below. The example format provided below is merely provided as an example, as various features may be included, excluded, or modified.

Delete Object Response

<SOAP-ENV:Body SOAP-ENV:encodingStyle=“http://schemas.xmlsoap.
org/soap/encoding/”>
<cwmp:DeleteObjectResponse>
<Status>0</Status>
</cwmp:DeleteObjectResponse>
</SOAP-ENV:Body>

Status in the DeleteObject Response message may take values 0(e.g., success), 1 (e.g., failure—internal server error), 2(e.g., failure—invalid).

At 5022, CE-GW 5002 may receive an empty HTTP response from CES 5004. At 5024, CE-GW 5002 may close the connection between CE-GW 5002 and CES 5004.

Examples of a data model are described herein. TABLE 3 includes an example of the data model for the Lb interface. The data model may import and/or extend the storage device related parameters (e.g., from TR140).

TABLE 3
TR069 Data Model for CE-GW

| Name | Type | Write | Description |
|---|---|---|---|
| InternetGatewayDevice.DeviceInfo. | object | — | May indicate the device |
| | | | object that may include |
| | | | the device parameters. |
| >GlobalID | string(32) | — | May indicate the global |
| | | | identifier for the eCGW. |
| | | | It may include a |
| | | | VendorID and/or a |
| | | | SerialNumber of the |
| | | | device. |
| >VendorID | string(64) | — | May indicate the vendor |
| | | | identifier of the physical |
| | | | storage medium. |
| >SerialNumber | string(64) | — | May indicate the serial |
| | | | number of the physical |
| | | | storage medium. |
| >StorageCapacity | string(64) | — | May indicate the storage |
| | | | capacity of the small cell |
| | | | network storage |
| | | | subsystem. |
| >UsableCapacity | unsignedInt | — | May indicate the usable |
| | | | capacity of the small cell |
| | | | network storage |
| | | | subsystem. |
| >ThresholdLimit | unsignedInt | — | This value may be |
| | | | described in MB and/or |
| | | | may control when the |
| | | | ThresholdReached |
| | | | parameter may have its |
| | | | value altered. If |
| | | | the value of the |
| | | | UsedSpace parameter |
| | | | plus the value of this |
| | | | parameter is |
| | | | greater than or equal to |
| | | | the value of the |
| | | | capacity parameter, the |
| | | | value of the |
| | | | ThresholdReached |
| | | | parameter may |
| | | | be true. Otherwise the |
| | | | value of the |
| | | | ThresholdReached |
| | | | parameter may be false. |
| | | | Setting the value of this |
| | | | parameter to 0 |
| | | | may disable the |
| | | | Thresholding |
| | | | mechanism. |
| >ThresholdReached | boolean | — | When ThresholdLimit >0 |
| | | | and |
| | | | UsedSpace + |
| | | | ThresholdLimit >= |
| | | | Capacity, the |
| | | | ThresholdReached |
| | | | parameter may be true. |
| | | | Otherwise, the |
| | | | ThresholdReached |
| | | | parameter may be false. |
| >FreeSpace | unsignedInt | — | May indicate the amount |
| | | | of free space on the |
| | | | small cell network |
| | | | storage subsystem. |
| >FQDN | string(32) | W | May indicate the self |
| | | | fully qualified domain |
| | | | name. |
| >DeviceState | unsignedInt | — | May indicate the device |
| | | | status (e.g., |
| | | | initialization/established). |
| >UpTime | unsignedInt | — | May indicate the number |
| | | | of hours the device may |
| | | | be up from the last |
| | | | reboot. |
| >SupportedFileSystemTypes | string(64) | — | May indicate a comma- |
| | | | separated list of |
| | | | supported |
| | | | FileSystemsTypes. The |
| | | | possible set of |
| | | | supported file system |
| | | | types may be an |
| | | | enumeration of one or |
| | | | more of the following |
| | | | strings: “FAT16,” |
| | | | “FAT32,” “NTFS,” |
| | | | “HFS,” “HFS+,” |
| | | | “HSFJ,” “ext2,” “ext3,” |
| | | | “XFS,” “REISER,” |
| | | | and/or the like. |
| >SupportedNetworkProtocols | string(64) | — | May indicate a comma- |
| | | | separated list of |
| | | | supported application- |
| | | | level network protocols. |
| | | | The possible set of |
| | | | supported network |
| | | | protocols may be an |
| | | | enumeration of one or |
| | | | more of the |
| | | | following strings: |
| | | | “SMB” |
| | | | “NES” |
| | | | “AFP”. |
| >SupportedStreamingCapabilities | string(64) | — | May indicate a comma- |
| | | | separated list of |
| | | | supported streaming |
| | | | capabilities. |
| >LoggingCapable | boolean | — | May indicate the logging |
| | | | capabilities. |
| >NotificationCapable | boolean | — | May indicate the |
| | | | subscribe/Notify |
| | | | capabilities. |
| > InternetGatewayDevice.DeviceInfo.- | object | — | May indicate the data |
| SubscriptionInfo. {i}; | | | object comprising the |
| | | | info of the subscriptions. |
| >>NotifyURL | string(64) | W | May indicate the URL |
| | | | that may be used for |
| | | | sending the |
| | | | notifications. |
| >>NotificationFormat | string(64) | W | May indicate the |
| | | | notification format. |
| >> ResourceURL | string(64) | — | May indicate the URL |
| | | | that may be used for |
| | | | identifying the |
| | | | subscriptions. |
| >> CallbackData | string(256) | W | May indicate the context |
| | | | information. |
| >>Timestamp | string(64) | — | May indicate the |
| | | | timestamp at which the |
| | | | notification may be sent. |
| >InternetGatewayDevice.DeviceInfo.- | object | — | May indicate the data |
| FemtoZoneInfo. | | | object that may include |
| | | | the femtozone |
| | | | information. |
| >FemtoZoneID | unsignedInt | — | May indicate the |
| | | | femtozone unique |
| | | | identifier. |
| >>InternetGatewayDevice.DeviceInfo.- | object | — | May indicate the data |
| FemtoZoneInfo.AreaLocation. | | | object describing the |
| | | | area location. |
| >>>ZipCode | unsignedInt | — | May indicate the zip |
| | | | code of the service |
| | | | location. |
| >>InternetGatewayDevice.DeviceInfo.- | object | — | May indicate the data |
| FemtoZoneInfo.NetworkStatus | | | object that may describe |
| | | | the network status. |
| >>>AvgeBandwidth | string(16) | — | May indicate the |
| | | | average bandwidth of |
| | | | the small cell network. |
| >>>AvgeLatency | string(16) | — | May indicate the |
| | | | average latency of the |
| | | | small cell network. |
| >>>NumberOfUsers | unsignedInt | — | May indicate the number |
| | | | of active users in the |
| | | | SCN. |
| >>>NumberOfActiveAccessPoints | unsignedInt | — | May indicate the number |
| | | | of currently active |
| | | | access points in the |
| | | | SCN. |
| >>>NumberOfUnserviceableAccessPoints | unsignedInt | — | May indicate the number |
| | | | of currently inactive |
| | | | access points in the |
| | | | SCN. |
| >IntemetGatewayDevice.DeviceInfo.- | object | — | May indicate the service |
| StorageVolume. {i} | | | object for a storage |
| | | | logical volume. |
| >>LogicalVolumeID | unsignedInt | W | May indicate the logical |
| | | | volume ID of the storage |
| | | | volume. |
| >>Enable | boolean | W | May enable and/or |
| | | | disable the storage |
| | | | mechanism. |
| >>RequiredSpace | unsignedInt | — | May indicate the |
| | | | required space in MB. |
| >>IngestionURL | string | W | May indicate the |
| | | | ingestion URL for |
| | | | content ingestion. |
| >>ResourceURL | string | — | May indicate the |
| | | | resource URL for logical |
| | | | volume access. |
| >>Health | string | — | May indicate the |
| | | | enumerated type that |
| | | | may indicate the |
| | | | general health of the |
| | | | physical storage |
| | | | medium. The health |
| | | | may be indicated using |
| | | | values such as: |
| | | | “OK”, “Failing”, |
| | | | “Error”, and/or the like. |
| >>HotSwappable | boolean | — | May indicate whether a |
| | | | physical medium is |
| | | | capable of being |
| | | | removed while the |
| | | | device is powered up. |
| | | | Hot-swappable storage |
| | | | may not imply or infer |
| | | | removable storage as |
| | | | hot-swappable is an |
| | | | operation taken when |
| | | | the disk has failed and |
| | | | may be replaced. The |
| | | | data on the hot-swapped |
| | | | storage may not remain |
| | | | intact. |
| >>RaidType | string(8) | — | May indicate one of the |
| | | | enumerated values that |
| | | | may be found in the |
| | | | capabilities parameter |
| | | | SupportedRaidTypes |
| | | | type. |
| >>PhysicalMediumNumberOfEntries | unsignedInt | — | May indicate the number |
| | | | of instances of |
| | | | PhysicalMedium. |
| >>StorageArrayNumberOfEntries | unsignedInt | — | May indicate the number |
| | | | of instances of |
| | | | StorageArray. |
| >>LogicalVolumeNumberOfEntries | unsignedInt | — | May indicate the number |
| | | | of instances of |
| | | | LogicalVolume |
| >>InternetGatewayDevice.DeviceInfo.- | object | — | May indicate the |
| StorageVolume. {i}.GeneralCapabilites | | | capabilities of a storage |
| | | | service device. This |
| | | | may be a constant read- |
| | | | only object, which may |
| | | | mean that a firmware |
| | | | upgrade may cause these |
| | | | values to he altered. |
| >>>Enable | boolean | W | May enable and/or |
| | | | disable the general |
| | | | capabilities. |
| >>>FTPCapable | boolean | — | May indicate whether a |
| | | | device includes an FTP |
| | | | server that may allow |
| | | | clients to access the data |
| | | | via an FTP client. |
| >>>SFTPCapable | boolean | — | May indicate whether a |
| | | | device includes an SSH |
| | | | FTP server that may |
| | | | allow clients to access |
| | | | the data via an SFTP |
| | | | client. |
| >>>HTTPCapable | boolean | — | May indicate whether a |
| | | | device includes an |
| | | | HTTP server that may |
| | | | allow clients to access |
| | | | the data via an HTTP |
| | | | client. |
| >>>HTTPCapable | boolean | — | May indicate whether a |
| | | | device includes an |
| | | | HTTPS server that may |
| | | | allow a client to access |
| | | | the data via an HTTPS |
| | | | client. |
| >>InternetGatewayDevice.DeviceInfo.- | object | — | May indicate the overall |
| StorageVolume. {i}.StreamingCapabilites | | | streaming capabilities of |
| | | | the streaming server. |
| >>>Enable | boolean | W | May enable and/or |
| | | | disable the streaming |
| | | | service. |
| >>>HTTPProgressiveStreamingEnable | boolean | W | May indicate whether a |
| | | | device includes an |
| | | | HTTP progressive |
| | | | streaming service that |
| | | | may allow a client to |
| | | | access the data via an |
| | | | HTTP client. |
| >>>HTTPDynamicStreamingEnable | boolean | W | May indicate whether a |
| | | | device includes an |
| | | | HTTP dynamic |
| | | | streaming (DASH) |
| | | | service that may allow a |
| | | | client to access the data |
| | | | via an HTTP client. |
| >>>RTPStrearaingEnable | boolean | W | May indicate whether a |
| | | | device includes an RTP |
| | | | streaming service that |
| | | | may allow a client to |
| | | | access data via the RTP |
| | | | client. |
| >>>RTSPStreamingEnable | boolean | W | May indicate whether a |
| | | | device includes an RTSP |
| | | | streaming service that |
| | | | may allow a client to |
| | | | access data via the |
| | | | RTSP client. |
| >>>RTMPStreamingEnable | boolean | W | May indicate whether a |
| | | | device includes an |
| | | | RTMP streaming service |
| | | | that may allow a client |
| | | | to access data via the |
| | | | RTMP client |
| >>>MBMSEnable | boolean | W | May indicate whether a |
| | | | device is capable of |
| | | | MBMS services. |
| >>>SIPStreamingEnable | boolean | W | May indicate whether a |
| | | | device includes an SIP |
| | | | streaming service that |
| | | | may allow a client to |
| | | | access data via the SIP |
| | | | client. |
| >>>SupportedCodecs | string(64) | — | May indicate a comma- |
| | | | separated list of |
| | | | supported codecs. The |
| | | | possible set of |
| | | | supported codecs types |
| | | | may include an |
| | | | enumeration of one or |
| | | | more of the following |
| | | | strings: |
| | | | “H.263,” “H.264,” |
| | | | “AAC,” “AAC Plus,” |
| | | | “AMR-NB,” |
| | | | “AMR-WB,” “FLV,” |
| | | | “VC1,” and/or the like. |
| >>>SupportedFormats | string(64) | — | May indicate a comma- |
| | | | separated list of |
| | | | supported |
| | | | formats. The possible |
| | | | set of supported format |
| | | | types may include one |
| | | | or more of the following |
| | | | strings: “3GPP,” |
| | | | “3GPP2,” “FLV,” |
| | | | “F4V,” “MPEG-4,” |
| | | | “Windows Media,” |
| | | | “QuickTime,” “MP3,” |
| | | | “SMIL,” and/or the like. |
| >>InternetGatewayDevice.DeviceInfo.- | string(64) | W | May indicate the list of |
| StorageVolume. {i}.StreamingURLs {i} | | | streaming URLs. |
| >>InternetGatewayDevice.DeviceInfo.- | object | — | May indicate the logging |
| StorageVolume. {i}.LoggingCapabilities | | | capabilities of the |
| | | | logging server. |
| >>>Enable | boolean | W | May enable and/or |
| | | | disables the overall |
| | | | logging service. |
| >>>FileLoggingEnable | boolean | W | May enable and/or |
| | | | disable the |
| | | | file based |
| | | | logging |
| | | | service. |
| >>>LogFileName | string(32) | W | May indicate the prefix |
| | | | used for LogFile |
| | | | naming. |
| >>>LogFileSize | unsignedInt | W | May indicate the |
| | | | LogFile size. The |
| | | | LogFile size may be in |
| | | | MBs. |
| >>>LogFilesLimit | unsignedInt | W | May indicate the total |
| | | | limit for the LogFiles. |
| >>>LogFileRotationEnable | boolean | W | May enable and/or |
| | | | disable the LogFiles |
| | | | rotation after the |
| | | | LogFilesLimit is met. |
| >>InternetGatewayDevice.DeviceInfo.- | string(64) | W | May indicate the list of |
| StorageVolume. {i}.LoggingURLs {i} | | | Logging URLs. |
| >>InternetGatewayDevice.DeviceInfo.- | object | W | May indicate the data |
| StorageVolume. {i}.DataStoreStatus | | | object that includes the |
| | | | data store status. |
| >>>timestampStart | string(32) | — | May indicate the start |
| | | | time of the observation |
| | | | period. |
| >>>timestampEnd | string(32) | — | May indicate the end |
| | | | time of the observation |
| | | | period. |
| >>>FailureRate | string(32) | — | May indicate the failure |
| | | | rate of the storage |
| | | | logical volume. |
| >>>Throughput | string(32) | — | May indicate the |
| | | | throughput of the |
| | | | storage logical volume. |

Examples are described herein for a CGW architecture that may support managed edge caching (MEC). The CGW may support managed edge caching in small cell networks that may have a storage subsystem. The CGW may be referred to as an evolved CGW (eCGW). The eCGW may include an IP traffic gateway, a content enablement gateway (CE-GW), a DHCP server, and/or a DNS Server. The eCGW may be connected to HeNB(s) and/or the Wi-Fi AP(s), The eCGW may be connected to the EPC and/or the CDN/content servers that may be in the public internet. The eCGW may be associated with the edge server farm for accomplishing managed edge caching.

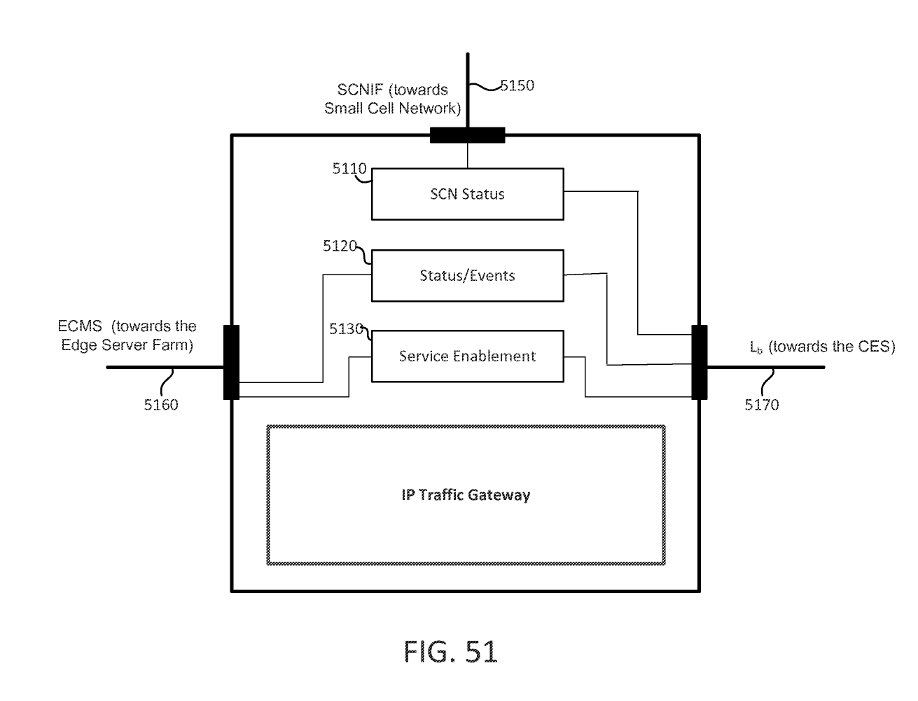

FIG. 51 is diagram illustrating an example of CE-GW functional architecture. The diagram in FIG. 51 illustrates one or more interfaces of the CE-GW within the eCGW, and the functional decomposition of the CE-GW. As illustrated in FIG. 51, the small cell network gateway (SCN-GW) may include a service enablement module 5130, a status/event module 5120, and/or an SCN status module 5110. The core network may request the enablement of certain services such as the logging, the fault tolerance, and/or the multimedia multicast service on behalf of a CDN application on the SCN storage subsystem. The service enablement module 5130 may be responsible of creation of virtual edge servers and/or enabling/disabling such internal SCN datastore services using the ECMS interface (EIF) interface towards the edge server farm 5160. The core network may send queries and/or subscribe to certain events, which may be used to feed the CES database. The status/event module may be responsible for receiving and/or responding to these requests through the L_{b} interface 5170. One or more requests may be forwarded to internal ESF storage using the EIF interface 5160. The SCN network status information, such as bandwidth, latency, and/or number of users for example, may be collected using the SCN interface (SCNIF) 5150. The SCN status module may be used for the SCN network status information, such as the bandwidth, latency, number of active access points, number of inactive access points, and/or number of users for example, that may be collected using the SCNIF 5150. The functionality of the SCN-GW may be similar to the local gateway, the converged gateway, or any other suitable access gateway that may be deployed in a small cell network.

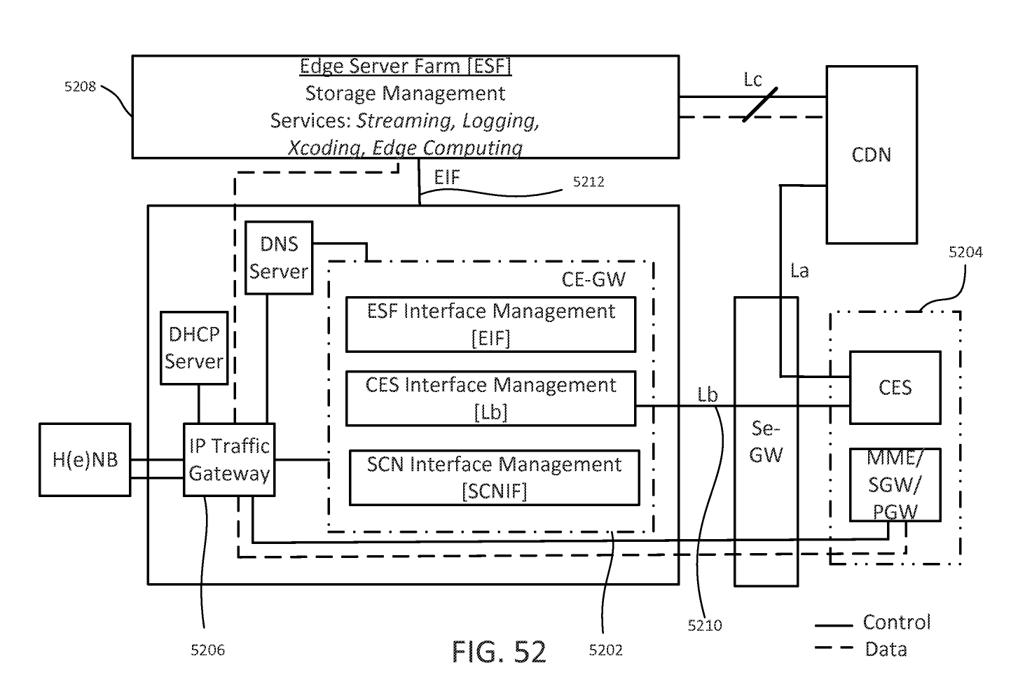

FIG. 52 is a diagram illustrating examples of CE-GW interfaces. As illustrated in FIG. 52, the CE-GW 5202 may have one or more control interfaces with the CES 5204, the IP traffic gateway 5206, and/or the edge server farm 5208. The CE-GW may have an Lb interface 5210, an EIF 5212, a commissioning and provisioning interface (CPIF) (not identified in FIG. 52), and/or an Small Cell Network interface (SCNIF) (not identified in FIG. 52) with one or more entities. The Lb interface 5210 may be used to communicate with the CES 5204. The EIF interface 5212 may be used to communicate with the edge server farm 5208. The CPIF interface may be used for configuration of the eCGW by the ACS in the core network. The SCNIF interface may be used to communicate with the SCN nodes.

The commissioning and provisioning interface (CPIF) may be used for configuration of the CE-GW and/or the edge server farm. The H(e)MS/ACS may be used for the configuration (e.g., initial configuration) of the CE-GW and/or the edge server farm. The CE-GW may receive its FQDN information from the H(e)MS/ACS. The edge server farm may receive its configuration information related to storage, streaming, and/or logging services from the H(e)MS/ACS.

The SCNIF interface may be used by the CE-GW to communicate with internal components within the small cell network. The CE-GW may learn about the current network status information, such as the network latency, the network bandwidth, the number of active access points, the number of inactive access points, the number of active users in the network, and/or the like. The CE-GW may use this information for sending the current SCN status information to the CES. The current SCN status information may be sent over the Lb interface.

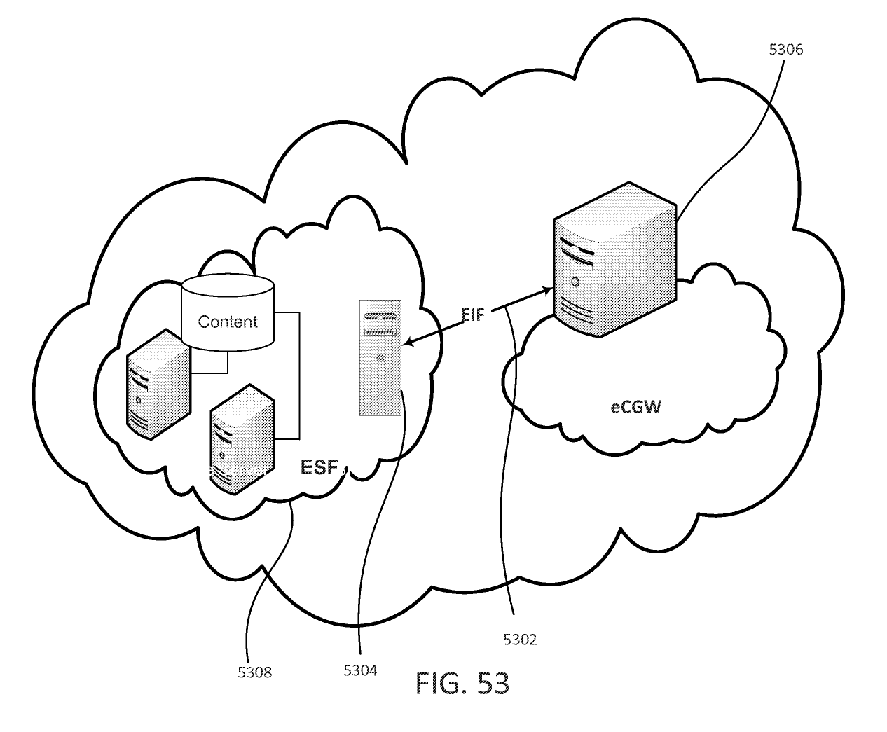

FIG. 53 is a diagram that depicts an example of an edge server farm interface (EIF) 5302. The EIF 5302 may provide communication interface between the ECMS 5304 in an edge server farm 5308 and CE-GW 5306. The CE-GW 5306 may use the EIF 5302 to enable CES service request handling and/or CES management query handling. The CES service request handling may include creation of a virtual edge server, deletion of a virtual edge server, modification of a virtual edge server, and/or retrieving of ESF capability information. The CES management query handling may include activation/deactivation of device failure notifications, activation/deactivation of device addition and/or deletion notifications, and/or blocking/unblocking of the virtual edge server access.

Examples are described herein for the EIF message transaction between the ECMS and the CE-GW. CES service request handling may be performed. Service requests may include the operations as published by the CES web service towards the CDN control application. The interactions involved in these operations between the CE-GW and the ECMS are described herein.

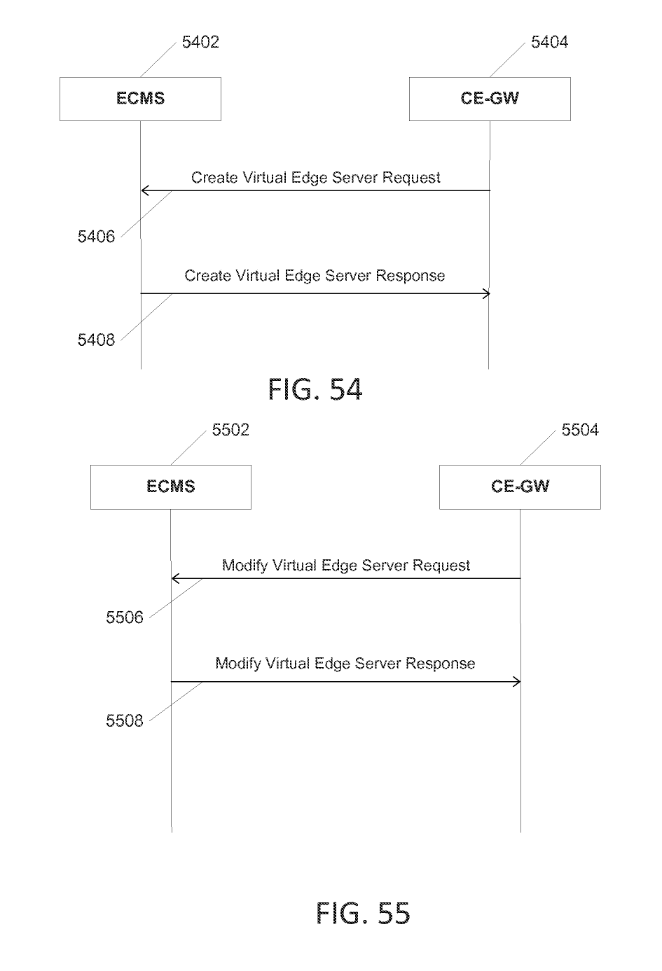

Examples are described herein for creation of a virtual edge server. FIG. 54 illustrates example of messages that may be communicated for creation of a virtual edge server. As illustrated in FIG. 54, at 5406, CE-GE 5404 may send create virtual edge server request to ECMS 5402. Create virtual edge server request may include information, for example, as illustrated in TABLE 4.

TABLE 4
Create Virtual Edge Server Request
Create Virtual Edge Server Request

| | | | | | |
|---|---|---|---|---|---|
| IE/Group | | | | Semantics | Criti- |
| Name | Presence | Range | IE Type | Description | cality |

| | | | | |
|---|---|---|---|---|
| CE-GW ID | Optional | String | | Ignore |
| Transaction ID | Optional | U32 | | Reject |
| Storage | Optional | U64 | Bytes | Reject |
| Capacity | | | | |
| Application | Optional | | | |
| Server Config. | | | | |
| >Streaming | Optional | Boolean | True/False | Ignore |
| Capability | | | | |
| >Logging | Optional | Boolean | True/False | Ignore |
| Capability | | | | |

As illustrated in FIG. 54, at 5408, CE-GE 5404 may receive a create virtual edge server response from ECMS 5402. Create virtual edge server response may include information, for example, as illustrated in TABLE 5.

TABLE 5
Create Virtual Edge Server Response
Create Virtual Edge Server Response

| | | | | | |
|---|---|---|---|---|---|
| IE/Group | | | | Semantics | Criti- |
| Name | Presence | Range | IE Type | Description | cality |

| | | | | |
|---|---|---|---|---|
| ESF ID | Optional | String | | Reject |
| Transaction ID | Optional | U32 | | Reject |
| Response Type | Optional | U8 | Successful | Reject |
| | | | Response = 0 | |
| | | | Failure | |
| | | | Response = 1 | |
| Virtual Edge | Optional | String | URI | Reject |
| Server ID | | | | |
| Failure Cause | Condi- | U8 | Internal | Ignore |
| | tional | | Error = 0 | |
| | | | Invalid | |
| | | | CE-GW = 1 | |

FIG. 55 illustrates example of messages that may be communicated for modification of a virtual edge server. As illustrated in FIG. 55, at 5506, CE-GE 5504 may send modify virtual edge server request to ECMS 5402. Modify virtual edge server request may include information, for example, as illustrated in TABLE 6.

TABLE 6
Modify Virtual Edge Server Request
Modify Virtual Edge Server Request

| | | | | | |
|---|---|---|---|---|---|
| IE/Group | | | | Semantics | Criti- |
| Name | Presence | Range | IE Type | Description | cality |

| | | | | |
|---|---|---|---|---|
| CE-GW ID | Optional | String | | Ignore |
| Virtual Edge | Optional | String | URI | Reject |
| Server ID | | | | |
| Transaction ID | Optional | U32 | | Reject |
| Storage Space | Optional | U64 | Bytes | Ignore |
| Application | Optional | | | |
| Server | | | | |
| >Streaming | Conditional | enum | enable = 0 | Ignore |
| capability | | | disable = 1 | |
| >Logging | Conditional | enum | enable = 0 | Ignore |
| capability | | | disable = 1 | |
| >Web server | Conditional | enum | enable = 0 | Ignore |
| Capability | | | disable = 1 | |
| >Multimedia | Conditional | enum | enable = 0 | Ignore |
| Multicast | | | disable = 1 | |
| >Fault | Conditional | enum | enable = 0 | Ignore |
| Tolerance | | | disable = 1 | |

As illustrated in FIG. 55, at 5508, CE-GE 5504 may receive a modify virtual edge server response from ECMS 5402. Modify virtual edge server response may include information, for example, as illustrated in TABLE 7.

TABLE 7
Modify Virtual Edge Server Response
Modify Virtual Edge Server Response

| | | | | | |
|---|---|---|---|---|---|
| IE/Group | | | | Semantics | Criti- |
| Name | Presence | Range | IE Type | Description | cality |

| | | | | |
|---|---|---|---|---|
| Virtual | Optional | String | URI | Reject |
| Edge | | | | |
| Server ID | | | | |
| Transac- | Optional | U32 | | Reject |
| tion ID | | | | |
| Response | Optional | U8 | Successful | Reject |
| Type | | | Response = 0 | |
| | | | Failure | |
| | | | Response = 1 | |
| Failure | Optional | U8 | Internal Error = 0 | Ignore |
| Cause | | | Invalid CE-GW = 1 | |
| | | | Invalid Virtual | |
| | | | Edge Server = 2 | |

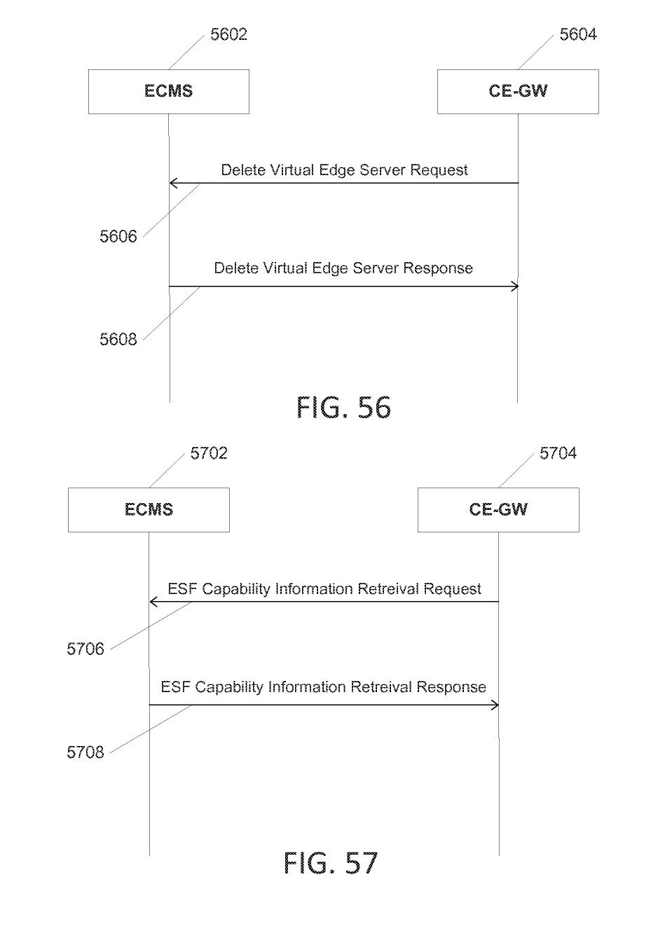

FIG. 56 illustrates example of messages that may be communicated for deletion of a virtual edge server. As illustrated in FIG. 56, at 5606, CE-GE 5604 may send a modify virtual edge server request to ECMS 5602. Delete virtual edge server request may include information, for example, as illustrated in TABLE 8.

TABLE 8
Delete Virtual Edge Server Request
Delete Virtual Edge Server Request

| | | | | | |
|---|---|---|---|---|---|
| IE/Group | | | | Semantics | Criti- |
| Name | Presence | Range | IE Type | Description | cality |

| | | | | |
|---|---|---|---|---|
| CE-GW ID | Optional | String | | Ignore |
| Transaction ID | Optional | U32 | | Reject |
| Virtual Edge | Optional | String | URI | Reject |
| Server ID | | | | |

As illustrated in FIG. 56, at 5608, CE-GE 5604 may receive modify virtual edge server response from ECMS 5602. Modify virtual edge server response may include information, for example, as illustrated in TABLE 9.

TABLE 9
Delete Virtual Edge Server Response
Delete Virtual Edge Server Response

| | | | | | |
|---|---|---|---|---|---|
| IE/Group | | | | Semantics | Criti- |
| Name | Presence | Range | IE Type | Description | cality |

| | | | | |
|---|---|---|---|---|
| Virtual | Optional | String | URI | Reject |
| Edge | | | | |
| Server ID | | | | |
| Transac- | Optional | U32 | | Reject |
| tion ID | | | | |
| Response | Optional | U8 | Successful | Reject |
| Type | | | Response = 0 | |
| | | | Failure | |
| | | | Response = 1 | |
| Failure | Optional | U8 | Internal Error = 0 | Ignore |
| Cause | | | Invalid CE-GW = 1 | |
| | | | Invalid Virtual | |
| | | | Edge Server = 2 | |

FIG. 57 illustrates example of messages that may be communicated for retrieval of ESF capability information. As illustrated in FIG. 57, at 5706, CE-GE 5704 may send a ESF capability information retrieval request to ECMS 5702. ESF capability information retrieval request may include information, for example, as illustrated in TABLE 10.

TABLE 10
ESF Capability Information Retrieval Request
ESF Capability Information Retrieval Request

| | | | | | |
|---|---|---|---|---|---|
| IE/Group | | | | Semantics | Criti- |
| Name | Presence | Range | IE Type | Description | cality |

| | | | |
|---|---|---|---|
| CE-GW ID | Optional | String | Optional |

As illustrated in FIG. 57, at 5708 CE-GE 5704 may receive a modify virtual edge server response from ECMS 5702. ESF capability information retrieval response may include information, for example, as illustrated in TABLE 11.

TABLE 11
ESF Capability Information Retrieval Response
ESF Capability Information Retrieval Response

| | | | | | |
|---|---|---|---|---|---|
| IE/Group | | | | Semantics | Criti- |
| Name | Presence | Range | IE Type | Description | cality |

| | | | | |
|---|---|---|---|---|
| ESF ID | Optional | String | | Ignore |
| Response | Optional | U8 | Successful | Reject |
| Type | | | Response = 0 | |
| | | | Failure | |
| | | | Response = 1 | |
| Aggregate | Optional | U64 | | Reject |
| Storage | | | | |
| Capacity | | | | |
| Application | Optional | | | |
| Server | | | | |
| Capability | | | | |
| >Streaming | Optional | Boolean | | |
| Server | | | | |
| Capability | | | | |
| >>number of | Condi- | U16 | | Reject |
| streaming | tional | | | |
| servers | | | | |
| >Log Server | Optional | Boolean | | |
| Capability | | | | |
| >>number of | Condi- | U16 | | Reject |
| log servers | tional | | | |
| >Web Server | Optional | Boolean | | Reject |
| Capability | | | | |
| >>number of | Optional | U16 | | Reject |
| web servers | | | | |
| Failure Cause | Optional | U8 | Internal | Ignore |
| | | | Error = 0 | |
| | | | Invalid | |
| | | | CE-GW = 1 | |

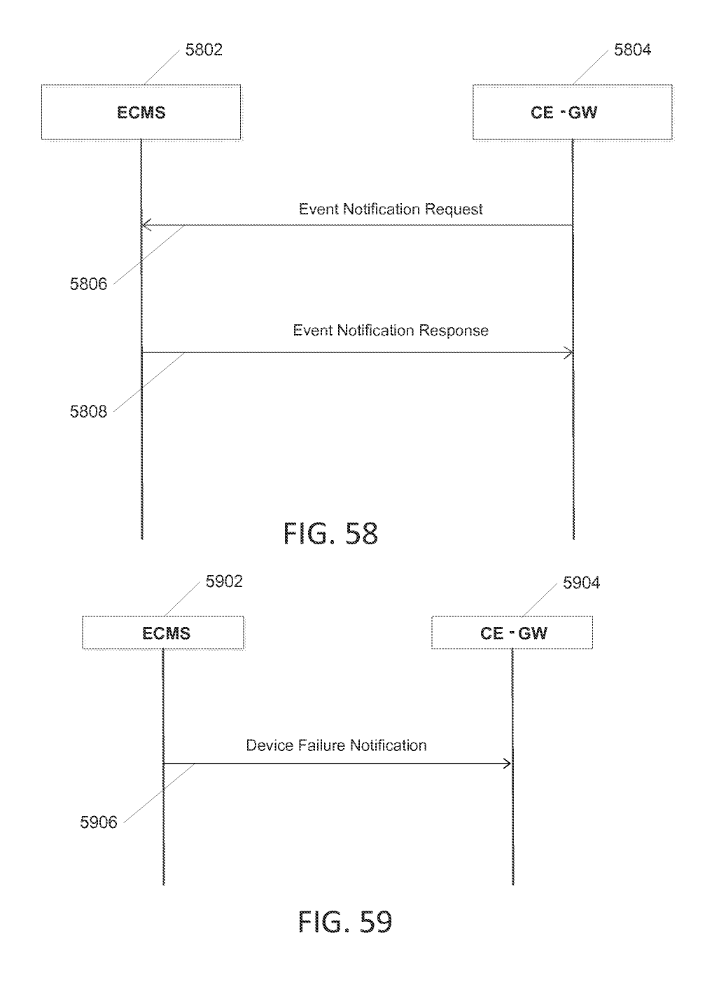

Examples are described herein for CES management query handling. FIG. 58 illustrates example of messages that may be communicated for an event notification procedure.

As illustrated in FIG. 58, at 5806, CE-GE 5804 may send an event notification request to ECMS 5802. The event notification request may include information, for example, as illustrated in TABLE 12.

TABLE 12
Event Notification Request
Event Notification Request

| | | | | | |
|---|---|---|---|---|---|
| IE/Group | | | | Semantics | Criti- |
| Name | Presence | Range | IE Type | Description | cality |

| | | | | |
|---|---|---|---|---|
| CE-GW ID | Optional | String | | Ignore |
| Virtual | Optional | String | URI | Reject |
| Edge Server | | | | |
| ID | | | | |
| Transaction | Optional | U32 | | Reject |
| ID | | | | |
| Event Type | Optional | enum | DeviceFailure = 0 | Reject |
| | | | DeviceEntries = 1 | |
| | | | PerformanceSta- | |
| | | | tistics = 2 | |
| Event | Optional | enum | Subscribe = 0 | Reject |
| Action | | | Unsubscribe = 1 | |
| Periodicity | Condi- | U32 | Number of | Reject |
| | tional | | second | |

As illustrated in FIG. 58, at 5808, CE-GE 5804 may receive an event notification response from ECMS 5802. The event notification response may include information, for example, as illustrated in TABLE 13.

TABLE 13
Event Notification Response
Event Notification Response

| | | | | | |
|---|---|---|---|---|---|
| IE/Group | | | | Semantics | Criti- |
| Name | Presence | Range | IE Type | Description | cality |

| | | | | |
|---|---|---|---|---|
| Virtual | Optional | String | URI | Reject |
| Edge | | | | |
| Server ID | | | | |
| Response | Optional | U8 | Successful | Reject |
| Type | | | Response = 0 | |
| | | | Failure | |
| | | | Response = 1 | |
| Transac- | Optional | U32 | | Reject |
| tion ID | | | | |
| Failure | Condi- | U8 | UnsupportedSub- | Ignore |
| Cause | tional | | scription = 0 | |
| | | | EventAlreadyTrig- | |
| | | | gered = 1 | |
| | | | InvalidCEGW = 2 | |
| | | | InvalidVirtu- | |
| | | | alEdgeServer = 3 | |
| | | | InternalError = 4 | |

Examples are described herein for device notification procedures. FIG. 59 illustrates example of a message that may be communicated for device failure notification. As illustrated in FIG. 59, at 5806, CE-GE 5904 may receive a device failure notification from ECMS 5902. The device failure notification may include information, for example, as illustrated in TABLE 14.

TABLE 14
Device Failure Notification
Device Failure Notification

| | | | | | |
|---|---|---|---|---|---|
| IE/Group | | | | Semantics | Criti- |
| Name | Presence | Range | IE Type | Description | cality |

| | | | | |
|---|---|---|---|---|
| Virtual Edge | Optional | String | URI | Reject |
| Server ID | | | | |
| Device ID | Optional | String | | Reject |
| Device Type | Optional | U8 | Storage | Reject |
| | | | Device = 0 | |
| | | | Media Server = 1 | |
| | | | Streaming | |
| | | | Server = 2 | |
| | | | Log Server = 3 | |
| Failure | Optional | U8 | RecentCon- | Ignore |
| Cause | | | tentUpdate = 0 | |
| | | | InternalError = 1 | |

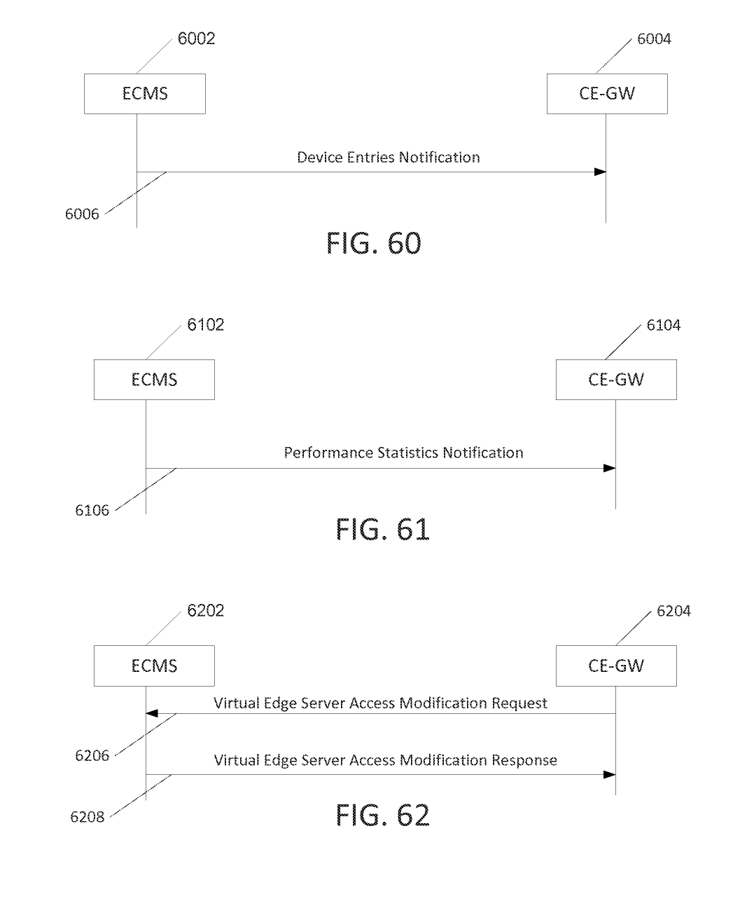

Examples are described herein for device entries notification procedures. FIG. 60 illustrates example of a message that may be communicated for device entries notification. As illustrated in FIG. 60, at 6006, CE-GE 6004 may receive a device entries notification from ECMS 6002. The device entries notification may include information, for example, as illustrated in TABLE 15.

TABLE 15
Device Entries Notification
Device Entries Notification

| | | | | | |
|---|---|---|---|---|---|
| IE/Group | | | | Semantics | Criti- |
| Name | Presence | Range | IE Type | Description | cality |

| | | | | |
|---|---|---|---|---|
| Edge Server | Optional | String | URI | Ignore |
| Farm ID | | | | |
| Event Type | Optional | enum | addition = 0 | Reject |
| | | | deletion = 1 | |
| Device ID | Optional | String | | Reject |
| Device Type | Optional | enum | Storage | Reject |
| | | | Device = 0 | |
| | | | Media | |
| | | | Server = 1 | |
| | | | Streaming | |
| | | | Server = 2 | |
| | | | Log Server = 3 | |
| Device | Optional | | | |
| Specifi- | | | | |
| cations | | | | |
| >Storage | Conditional | U32 | bytes | Reject |
| Capacity | | | | |
| >Streaming | Conditional | Boolean | TRUE/ | Reject |
| Capability | | | FALSE | |
| >Logging | Conditional | Boolean | TRUE/ | Reject |
| capability | | | FALSE | |

Examples are described herein for performance statistics notification procedures. FIG. 61 illustrates example of a message that may be communicated for performance statistics notification. As illustrated in FIG. 61, at 6106, CE-GE 6104 may receive a performance statistics notification from ECMS 6102. The performance statistics notification may include information, for example, as illustrated in TABLE 16.

TABLE 16
Performance Statistics Notification
Performance Statistics Notification

| | | | | | |
|---|---|---|---|---|---|
| IE/Group | | | | Semantics | Criti- |
| Name | Presence | Range | IE Type | Description | cality |

| | | | | |
|---|---|---|---|---|
| Virtual Edge | Optional | String | URI | Reject |
| Server ID | | | | |
| Average Number | Optional | U32 | | Ignore |
| of Sessions | | | | |
| Average | Optional | U32 | bytes | Ignore |
| Throughput | | | | |
| Average Failure | Optional | U32 | | Ignore |
| Rate | | | | |
| Average CPU | Optional | U8 | Percentage | Ignore |
| Utilization | | | | |

Examples are described herein for virtual edge server access control procedures. FIG. 62 illustrates example of messages that may be communicated for virtual edge server access control. As illustrated in FIG. 62, at 6206, CE-GE 6204 may receive a virtual edge server access modification request from ECMS 6202. The virtual edge server access modification request may include information, for example, as illustrated in TABLE 17.

TABLE 17
Virtual Edge Server Access Modification Request
Virtual Edge Server Access Modification Request

| | | | | | |
|---|---|---|---|---|---|
| IE/Group | | | | Semantics | Criti- |
| Name | Presence | Range | IE Type | Description | cality |

| | | | | |
|---|---|---|---|---|
| Virtual | Optional | String | URI | Reject |
| Edge | | | | |
| Server ID | | | | |
| Transac- | Optional | U16 | | Reject |
| tion ID | | | | |
| Access | Optional | U8 | block virtual | Reject |
| Modifica- | | | edge server = 0 | |
| tion Type | | | unblock virtual | |
| | | | edge server = 1 | |
| | | | block streaming | |
| | | | capability = 2 | |
| | | | unblock streaming | |
| | | | capability = 3 | |
| | | | block logging | |
| | | | capability = 4 | |
| | | | unblock logging | |
| | | | capability = 5 | |

As illustrated in FIG. 62, at 6208, CE-GE 6204 may receive a virtual edge server access modification response from ECMS 6202. The virtual edge server access modification response may include information, for example, as illustrated in TABLE 18.

TABLE 18
Virtual Edge Server Access Modification Response
Virtual Edge Server Access Modification Response

| | | | | | |
|---|---|---|---|---|---|
| IE/Group | | | | Semantics | Criti- |
| Name | Presence | Range | IEType | Description | cality |

| | | | | |
|---|---|---|---|---|
| Virtual | Optional | String | URI | Reject |
| Edge | | | | |
| Server ID | | | | |
| Response | Optional | U8 | Successful | Reject |
| Type | | | Response = 0 | |
| | | | Failure | |
| | | | Response = 1 | |
| Transac- | Optional | U16 | | Reject |
| tion ID | | | | |
| Failure | Optional | U8 | Invalid Virtual | Ignore |
| Cause | | | Edge Server = 0 | |
| | | | Invalid Access | |
| | | | Modification | |
| | | | Type = 1 | |
| | | | Unsupported Access | |
| | | | Modification | |
| | | | Type = 2 | |
| | | | Internal Error = 3 | |

Although features and elements are described above in particular combinations, one of ordinary skill in the art will appreciate that each feature or element may be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, optical media such as CD-ROM disks, and digital versatile disks (DVDs). A processor in association with software may be used to implement a radio frequency transceiver for use in a WTRU, WTRU, terminal, base station, RNC, or any host computer.

1. A content caching method comprising:
establishing, over a first interface, a connection between an external application (EA) and a centralized cloud controller (CCC) for the EA to access the CCC;
sending a query for a small cell network (SCN) storage to the CCC, wherein the query is sent over the established connection;
receiving, over the established connection, a response from the CCC that indicates whether the SCN storage is available, and, on a condition that the SCN storage is available, a link to an allocated SCN storage; and
ingesting, using the link, one or more contents from the EA into the allocated SCN storage, wherein the contents are ingested via a second interface.

2. The method of claim 1, wherein establishing the connection further comprises the EA sending login information and receiving access to the CCC.

3. The method of claim 1, further comprising the EA sending to the CCC, over the first interface, an instruction to perform one or more of an add operation, a delete operation, or an update operation on the allocated SCN storage.

4. The method of claim 1, further comprising the EA requesting a reporting service from the CCC, wherein the reporting service comprises one or more reports associated with one or more small cell networks, and wherein the reports are received periodically or on-demand.

5. The method of claim 4, further comprising the EA updating of the contents at the allocated SCN storage based on the received one or more reports.

6. The method of claim 1, further comprising the EA requesting access to a logging service from the CCC, wherein the logging service is accessed using a logging link.

7. The method of claim 1, wherein the CCC further comprises a centralized database of one or more SCNs, wherein the SCNs are located in one or more geographical areas.

8. The method of claim 1, wherein the established connection between the EA and the CES, over the first interface, is a secured connection.

9. The method of claim 1, wherein the allocated SCN storage is a reserved storage and is on an edge server.

10. The method of claim 1, wherein the link is an ingestion uniform resource indicator (URI).

11-14. (canceled)

15. An external application (EA) running on a device comprising:
the device comprising a processor configured to:
establish, over a first interface, a connection between the EA and a centralized cloud controller (CCC) for the EA to access the CCC;
send a query for a small cell network (SCN) storage to the CCC, wherein the query is sent over the established connection;
receive, over the established connection, a response from the CCC that indicates whether the SCN storage is available, and, on a condition that the SCN storage is available, receive a link to an allocated SCN storage; and
ingest, using the link, one or more contents from the EA into the allocated SCN storage, wherein the contents are ingested via a second interface.

16. The device of claim 15, wherein the processor is further configured to send login information and receive access to the CCC.

17. The device of claim 15, wherein the processor is further configured to send to the CCC, over the first interface, an instruction to perform one or more of an add operation, a delete operation, or an update operation on the allocated SCN storage.

18. The device of claim 15, wherein the processor is further configured to request a reporting service from the CCC, wherein the reporting service comprises one or more reports associated with one or more small cell networks, and wherein the reports are received periodically or on-demand.

19. The device of claim 18, wherein the processor is further configured to update the contents at the allocated SCN storage based on the received one or more reports.

20. The device of claim 15, wherein the processor is further configured to request access to a logging service from the CCC, wherein the logging service is accessed using a logging link provided by the CCC.

21. The device of claim 15, wherein the CCC further comprises a centralized database of one or more SCNs, wherein the SCNs are located in one or more geographical areas.

22. The device of claim 15, wherein the established connection between the EA and the CES, over the first interface, is a secured connection.

23. The device of claim 15, wherein the allocated SCN storage is a reserved storage and is on an edge server.

24. The device of claim 15, wherein the link is an ingestion uniform resource indicator (URI).
An external application (EA) running on a device comprising:
the device comprising a processor configured to:
establish, over a first interface, a connection between the EA and a centralized cloud controller (CCC) for the EA to access the CCC;
send a query for a small cell network (SCN) storage to the CCC, wherein the query is sent over the established connection;
receive, over the established connection, a response from the CCC that indicates whether the SCN storage is available, and, on a condition that the SCN storage is available, receive a link to an allocated SCN storage; and
ingest, using the link, one or more contents from the EA into the allocated SCN storage, wherein the contents are ingested via a second interface.

25-28. (canceled)
